(19) United States
(12) Patent Application Publication
(10) Pub. No.: US 2010/0190656 A1
(43) Pub. Date: Jul. 29, 2010

(54) Breast Cancer Specific Markers and Methods of Use

(75) Inventors: Xiaojun Li, Bellevue, WA (US); Patricia Beckmann, Hansville, WA (US); Heinrich Dreismann, Danville, CA (US)

Correspondence Address: FISH & RICHARDSON PC, P.O. BOX 1022, MINNEAPOLIS, MN, 55440-1022, US

(73) Assignee: INTEGRATED DIAGNOSTICS, INC., Seattle, WA (US)

(21) Appl. No.: 12/538,045

(22) Filed: Aug. 7, 2009

Related U.S. Application Data
(60) Provisional application No. 61/087,559, filed on Aug. 8, 2008.

(51) Int. Cl. C40B 30/04; C40B 40/06; C40B 40/10

(52) U.S. Cl. 506/9; 506/16; 506/18

(57) ABSTRACT

The present invention relates to breast cancer biomarkers useful for the detection, diagnosis and therapeutic treatment of breast cancer.

### CROSS-REFERENCE TO RELATED APPLICATIONS

This application claims priority from U.S. Provisional Application Ser. No. 61/087,559, filed on Aug. 8, 2008, which is incorporated herein by reference in its entirety.

### TECHNICAL FIELD

The present invention relates to breast cancer biomarkers useful for the detection, diagnosis and therapeutic treatment of breast cancer.

### BACKGROUND

Breast cancer is a significant health problem for women and men in the United States and throughout the world. Although advances have been made in the detection and treatment of the disease, breast cancer remains the second leading cause of cancer-related deaths in women, affecting more than 180,000 women in the United States each year. For women in North America, the life-time odds of getting breast cancer are now one in eight.

Despite considerable research into biomarkers for the diagnosis and prognosis of breast and other cancers, breast cancer is difficult to diagnose and treat effectively. Accordingly, there is a need in the art for improved methods for detecting and treating such cancers.

### SUMMARY

The present disclosure features, inter alia, compositions (e.g., pluralities of polynucleotides, polypeptides and/or antibodies, and diagnostic and prognostic panels comprising same) and methods employing these compositions for detecting breast cancer and/or an increased risk of developing breast cancer in a subject.

In one aspect, the invention provides various polynucleotides, polypeptides, and antibodies. For example, the invention provides a polynucleotide or plurality of polynucleotides selected from among those listed in Tables 2 and 3 (e.g., a polynucleotide as set forth in SEQ ID NOs: 1-3005), or a fragment thereof. As another example, the invention provides a polynucleotide or plurality of polynucleotides that binds to a polynucleotide selected from among those listed in Tables 2 and 3 (e.g., a polynucleotide as set forth in SEQ ID NOs: 1-3005). As another example, the invention provides an antibody or plurality of antibodies that binds specifically to a polypeptide selected from among those listed in Tables 2 and 3 (e.g., a polypeptide as set forth in SEQ ID NOs: 3006-5970), or an antigenic fragment thereof. As still another example, the invention provides a polypeptide or plurality of polypeptides selected from among those listed in Tables 2 and 3 (e.g., a polypeptide as set forth in SEQ ID NOs: 3006-5970), or an antigenic fragment thereof.

In one aspect, the invention provides a polynucleotide, e.g., a plurality of polynucleotides, that binds specifically to a nucleic acid(s) encoding at least one breast cancer marker selected from PTCD2, SLC25A20, NFKB2, RASGRP2, PTCD2, PDE7A, MLL, PTCD2, PRKCE, GPATC3, PRIC285 and GSTA4, or fragments thereof. For example, a plurality of polynucleotides may comprise or consist of polynucleotides that bind specifically to nucleic acids that encode no more than 1000, e.g., no more than 500, 400, 300, 200, 100, 50, 20, or 10, breast cancer markers, wherein the breast cancer markers comprise PTCD2, SLC25A20, NFKB2 and/or RASGRP2; PTCD2, PDE7A and/or MLL; or PTCD2, PRKCE, GPATC3, PRIC285 and/or GSTA4, or fragments thereof. A diagnostic panel comprising or consisting of a polynucleotide or plurality of polynucleotides described herein, and optionally at least one non-polynucleotide component (e.g., at least one reagent, buffer, and/or control) is also provided.

In another aspect, the invention provides an isolated antibody, e.g., a plurality of antibodies, or antigen-binding fragment(s) thereof, which binds specifically to a polypeptide selected from PTCD2, SLC25A20, NFKB2, RASGRP2, PTCD2, PDE7A, MLL, PTCD2, PRKCE, GPATC3, PRIC285 and GSTA4 polypeptides. For example, a plurality of isolated antibodies is provided wherein the plurality comprises antibodies that bind specifically to PTCD2, SLC25A20, NFKB2 and/or RASGRP2 polypeptides; PTCD2, PDE7A and/or MLL polypeptides; and/or PTCD2, PRKCE, GPATC3, PRIC285 and/or GSTA4 polypeptides. In some instances, the plurality may comprise or consist of antibodies that bind specifically to no more than 1000, e.g., no more than 500, 400, 300, 200, 100, 50, 20, or 10 breast cancer markers. In some instances, the plurality may comprise or consist of antibodies that bind specifically to at least 1000, e.g., at least 500, 400, 300, 200, 100, 50, 20, or 10 breast cancer markers. A diagnostic panel comprising or consisting of an antibody or plurality of antibodies described herein is also provided.

In still another aspect, the invention provides an isolated breast cancer marker polypeptide, e.g., a plurality of breast cancer marker polypeptides, selected from PTCD2, SLC25A20, NFKB2, RASGRP2, PTCD2, PDE7A, MLL, PTCD2, PRKCE, GPATC3, PRIC285 and GSTA4 polypeptides, or fragments (e.g., antigenic fragments) thereof. For example, a plurality of polypeptides can include PTCD2, SLC25A20, NFKB2 and/or RASGRP2 polypeptides, or antigenic fragments thereof; PTCD2, PDE7A and/or MLL polypeptides, or antigenic fragments thereof; or PTCD2, PRKCE, GPATC3, PRIC285 and/or GSTA4 polypeptides, or antigenic fragments thereof. In some instances, the plurality may comprise or consist of no more than 1000, e.g., no more than 500, 400, 300, 200, 100, 50, 20, or 10 breast cancer marker polypeptides. In some instances, the plurality may comprise or consist of at least 1000, e.g., at least 500, 400, 300, 200, 100, 50, 20, or 10 breast cancer marker polypeptides. A diagnostic panel comprising or consisting of a plurality of polypeptides, or fragments (e.g., antigenic fragments) described herein is also provided.

In yet another aspect, the invention provides a polynucleotide, e.g., a plurality of polynucleotides, that binds specifically to a nucleic acid encoding a breast cancer marker selected from SLC25A20, NFKB2, RASGRP2, PTCD2, AUP1, SYVN1, CALML4, REEP5, MGA, GSTA4, MIPEP, PLCB2, SLC25A19, DEF6, ZNF236, C18orf22, COX7A2, DDX11, TOP3A, C9orf6, UFC1, PFDN2, KLRD1, LOC643641, HSP90AB1, CLCN7, TNFAIP2, PRKCE, MRPL40, FBF1, ANKRD44, CCT5, USP40, UBXD4, LRCH1, MRPL4, SCCPDH, STX6, LOC284184, FLJ23235, GPATC3, CPSF4, CREM, HIST1H1D, HPS4, FN3KRP, ANKRD16, C8 orf16, ATF71P2, and PRIC285, or fragments thereof. For example, a plurality of polynucleotides may comprise or consist of polynucleotides that bind specifically to nucleic acids that encode no more than 1000, e.g., no more than 500, 400, 300, 200, 100, 50, 20, or 10, breast cancer markers, wherein the breast cancer markers include SLC25A20, NFKB2 and/or RASGRP2. The breast cancer markers may include PTCD2, AUP1, SYVN1, CALML4, REEP5, MGA, and/or GSTA4, and may include MIPEP, PLCB2, SLC25A19, DEF6, ZNF236, C18orf22, COX7A2, DDX11, TOP3A, C9orf6, UFC1, PFDN2, KLRD1, LOC643641, HSP90AB1, CLCN7, TNFAIP2, PRKCE, MRPL40, FBF1, ANKRD44, CCT5, USP40, UBXD4, LRCH1, MRPL4, SCCPDH, STX6, LOC284184, FLJ23235, GPATC3, CPSF4, CREM, HIST1H1D, HPS4, FN3KRP, ANKRD16, C8orf16, ATF71P2, and/or PRIC285. A diagnostic panel comprising or consisting of a polynucleotide or plurality of polynucleotides described herein, and optionally at least one non-polynucleotide component (e.g., at least one support, reagent, buffer, and/or control) is also provided.

In a further aspect, the invention provides an isolated antibody, e.g., a plurality of antibodies, or antigen-binding fragment(s) thereof, which binds specifically to a polypeptide selected from SLC25A20, NFKB2, RASGRP2, PTCD2, AUP1, SYVN1, CALML4, REEP5, MGA, GSTA4, MIPEP, PLCB2, SLC25A19, DEF6, ZNF236, C18orf22, COX7A2, DDX11, TOP3A, C9orf6, UFC1, PFDN2, KLRD1, LOC643641, HSP90AB1, CLCN7, TNFAIP2, PRKCE, MRPL40, FBF1, ANKRD44, CCT5, USP40, UBXD4, LRCH1, MRPL4, SCCPDH, STX6, LOC284184, FLJ23235, GPATC3, CPSF4, CREM, HIST1H1D, HPS4, FN3KRP, ANKRD16, C8orf16, ATF71P2, and PRIC285 polypeptides, or fragments (e.g., antigenic fragments) thereof. For example, a plurality of isolated antibodies, or antigen-binding fragments thereof, is provided wherein the plurality comprises antibodies that bind specifically to SLC25A20, NFKB2 and/or RASGRP2 polypeptides. The plurality may include antibodies that bind specifically to PTCD2, AUP1, SYVN1, CALML4, REEP5, MGA, and/or GSTA4, and may include antibodies that bind specifically to MIPEP, PLCB2, SLC25A19, DEF6, ZNF236, C18orf22, COX7A2, DDX11, TOP3A, C9orf6, UFC1, PFDN2, KLRD1, LOC643641, HSP90AB1, CLCN7, TNFAIP2, PRKCE, MRPL40, FBF1, ANKRD44, CCT5, USP40, UBXD4, LRCH1, MRPL4, SCCPDH, STX6, LOC284184, FLJ23235, GPATC3, CPSF4, CREM, HIST1H1D, HPS4, FN3KRP, ANKRD16, C8orf16, ATF71P2, and/or PRIC285 polypeptides. In some instances, the plurality may comprise or consist of antibodies that bind specifically to no more than 1000, e.g., no more than 500, 400, 300, 200, 100, 50, 20, or 10 breast cancer markers. In some instances, the plurality may comprise or consist of antibodies that bind specifically to at least 1000, e.g., at least 500, 400, 300, 200, 100, 50, 20, or 10 breast cancer markers. A diagnostic panel comprising or consisting of a plurality of antibodies or antigen-binding fragments thereof described herein is also provided.

In one aspect, the invention provides an isolated breast cancer marker polypeptide, e.g., a plurality of polypeptides, or antigenic fragment(s) thereof, selected from SLC25A20, NFKB2, RASGRP2, PTCD2, AUP1, SYVN1, CALML4, REEP5, MGA, GSTA4, MIPEP, PLCB2, SLC25A19, DEF6, ZNF236, C18orf22, COX7A2, DDX11, TOP3A, C9orf6, UFC1, PFDN2, KLRD1, LOC643641, HSP90AB1, CLCN7, TNFAIP2, PRKCE, MRPL40, FBF1, ANKRD44, CCT5, USP40, UBXD4, LRCH1, MRPL4, SCCPDH, STX6, LOC284184, FLJ23235, GPATC3, CPSF4, CREM, HIST1H1D, HPS4, FN3KRP, ANKRD16, C8orf16, ATF71P2, and PRIC285 polypeptides. For example, a plurality of isolated polypeptides is provided wherein the plurality comprises SLC25A20, NFKB2 and/or RASGRP2 polypeptides, or antigenic fragments thereof. The plurality may include PTCD2, AUP1, SYVN1, CALML4, REEP5, MGA, and/or GSTA4 polypeptides, and may include MIPEP, PLCB2, SLC25A19, DEF6, ZNF236, C18orf22, COX7A2, DDX11, TOP3A, C9orf6, UFC1, PFDN2, KLRD1, LOC643641, HSP90AB1, CLCN7, TNFAIP2, PRKCE, MRPL40, FBF1, ANKRD44, CCT5, USP40, UBXD4, LRCH1, MRPL4, SCCPDH, STX6, LOC284184, FLJ23235, GPATC3, CPSF4, CREM, HIST1H1D, HPS4, FN3KRP, ANKRD16, C8orf16, ATF71P2, and/or PRIC285 polypeptides, or antigenic fragments thereof. In some instances, the plurality may comprise or consist of no more than 1000, e.g., no more than 500, 400, 300, 200, 100, 50, 20, or 10 breast cancer marker polypeptides. In some instances, the plurality may comprise or consist of at least 1000, e.g., at least 500, 400, 300, 200, 100, 50, 20, or 10 breast cancer marker polypeptides. A diagnostic panel comprising or consisting of a plurality of polypeptides described herein is also provided.

In another aspect, the invention provides a polynucleotide, e.g., a plurality of polynucleotides, that binds specifically to a nucleic acid encoding a breast cancer marker selected from PDE7A, MLL, PTCD2, ZNF669, SNRP70, MGC35402, GSTA4, ATHL1, PRSS23, TMEM80, FLJ40432 STX5A, PRKCE, MTMR11, TNPO1, MGC3731, FKBP5, C3orf62, IRS2, GPATC3, SUSD1, CCM2, ZBTB7A, RAB11A, GSDML, MAPK9, DRG2, PDZD8, LOC339804, PPARD, DDIT3, FAM113A, RHBDD3, TIMM44, ATP6AP2, ME2, PRIC285, TNFSF14, ABCA2, EML2, Magmas, EVI2A, USP37, GATAD1, CHN2, PSCD4, CHTF18, SFRS8, DICER1, and PIAS1, or fragment thereof. For example, a plurality of polynucleotides may comprise or consist of polynucleotides that bind specifically to nucleic acids that encode no more than 1000, e.g., no more than 500, 400, 300, 200, 100, 50, 20, or 10, breast cancer markers, wherein the breast cancer markers include PDE7A, MLL, and/or PTCD2. The breast cancer markers may include ZNF669, SNRP70, MGC35402, GSTA4, ATHL1, PRSS23, and/or TMEM80, and may include FLJ40432 STX5A, PRKCE, MTMR11, TNPO1, MGC3731, FKBP5, C3orf62, IRS2, GPATC3, SUSD1, CCM2, ZBTB7A, RAB11A, GSDML, MAPK9, DRG2, PDZD8, LOC339804, PPARD, DDIT3, FAM113A, RHBDD3, TIMM44, ATP6AP2, ME2, PRIC285, TNFSF14, ABCA2, EML2, Magmas, EVI2A, USP37, GATAD1, CHN2, PSCD4, CHTF18, SFRS8, DICER1, and/or PIAS1. A diagnostic panel comprising or consisting of a polynucleotide or plurality of polynucleotides described herein, and optionally at least one non-polynucleotide component (e.g., at least one support, reagent, buffer, and/or control) is also provided.

In yet another aspect, the invention provides an isolated antibody, e.g., a plurality of antibodies, or antigen-binding fragment(s) thereof, which binds specifically to a polypeptide selected from PDE7A, MLL, PTCD2, ZNF669, SNRP70, MGC35402, GSTA4, ATHL1, PRSS23, TMEM80, FLJ40432 STX5A, PRKCE, MTMR11, TNPO1, MGC3731, FKBP5, C3orf62, IRS2, GPATC3, SUSD1, CCM2, ZBTB7A, RAB11A, GSDML, MAPK9, DRG2, PDZD8, LOC339804, PPARD, DDIT3, FAM113A, RHBDD3, TIMM44, ATP6AP2, ME2, PRIC285, TNFSF14, ABCA2, EML2, Magmas, EVI2A, USP37, GATAD1, CHN2, PSCD4, CHTF18, SFRS8, DICER1, and PIAS1 polypeptides, or fragment (e.g., antigenic fragment) thereof. For example, a plurality of isolated antibodies is provided wherein the plurality comprises antibodies that bind specifically to PDE7A, MLL, and/or PTCD2 polypeptides. The plurality may include antibodies that bind specifically to ZNF669, SNRP70, MGC35402, GSTA4, ATHL1, PRSS23, and/or TMEM80, and may include FLJ40432 STX5A, PRKCE, MTMR11, TNPO1, MGC3731, FKBP5, C3orf62, IRS2, GPATC3, SUSD1, CCM2, ZBTB7A, RAB11A, GSDML, MAPK9, DRG2, PDZD8, LOC339804, PPARD, DDIT3, FAM113A, RHBDD3, TIMM44, ATP6AP2, ME2, PRIC285, TNFSF14, ABCA2, EML2, Magmas, EVI2A, USP37, GATAD1, CHN2, PSCD4, CHTF18, SFRS8, DICER1, and/or PIAS1polypeptides. In some instances, the plurality may comprise or consist of antibodies that bind specifically to no more than 1000, e.g., no more than 500, 400, 300, 200, 100, 50, 20, or 10 breast cancer markers. In some instances, the plurality may comprise or consist of antibodies that bind specifically to at least 1000, e.g., at least 500, 400, 300, 200, 100, 50, 20, or 10 breast cancer markers. A diagnostic panel comprising or consisting of a plurality of antibodies, or antigen-binding fragments thereof, described herein is also provided.

In still a further aspect, the invention provides an isolated breast cancer marker polypeptide, e.g., a plurality of polypeptides, or antigenic fragment(s) thereof, selected from PDE7A, MLL, PTCD2, ZNF669, SNRP70, MGC35402, GSTA4, ATHL1, PRSS23, TMEM80, FLJ40432 STX5A, PRKCE, MTMR11, TNPO1, MGC3731, FKBP5, C3orf62, IRS2, GPATC3, SUSD1, CCM2, ZBTB7A, RAB11A, GSDML, MAPK9, DRG2, PDZD8, LOC339804, PPARD, DDIT3, FAM113A, RHBDD3, TIMM44, ATP6AP2, ME2, PRIC285, TNFSF14, ABCA2, EML2, Magmas, EVI2A, USP37, GATAD1, CHN2, PSCD4, CHTF18, SFRS8, DICER1, and PIAS1 polypeptides. For example, a plurality of isolated polypeptides is provided wherein the plurality comprises PDE7A, MLL, and/or PTCD2 polypeptides, or antigenic fragments thereof. The plurality may include ZNF669, SNRP70, MGC35402, GSTA4, ATHL1, PRSS23, and/or TMEM80 polypeptides, and may include FLJ40432 STX5A, PRKCE, MTMR11, TNPO1, MGC3731, FKBP5, C3orf62, IRS2, GPATC3, SUSD1, CCM2, ZBTB7A, RAB11A, GSDML, MAPK9, DRG2, PDZD8, LOC339804, PPARD, DDIT3, FAM113A, RHBDD3, TIMM44, ATP6AP2, ME2, PRIC285, TNFSF14, ABCA2, EML2, Magmas, EVI2A, USP37, GATAD1, CHN2, PSCD4, CHTF18, SFRS8, DICER1, and/or PIAS1 polypeptides, or antigenic fragments thereof. In some instances, the plurality may comprise or consist of no more than 1000, e.g., no more than 500, 400, 300, 200, 100, 50, 20, or 10 breast cancer marker polypeptides. In some instances, the plurality may comprise or consist of at least 1000, e.g., at least 500, 400, 300, 200, 100, 50, 20, or 10 breast cancer marker polypeptides. A diagnostic panel comprising or consisting of a plurality of polypeptides, or fragments (e.g., antigenic fragments) thereof described herein is also provided.

In a further aspect, the invention provides a polynucleotide, e.g., a plurality of polynucleotides, that binds specifically to a nucleic acid encoding a breast cancer marker selected from ACAA2, SLC25A20, SREBF1, TMEM63A, ARL16, PRO1580, RASGRP2, C19orf6, STX16, MLLT6, Clorf71, ENTPD4, DGKA, PPP6C, PDE7A, RUTBC1, PRPF3, MBTD1, SPG7, TNFRSF25, PDK4, MS4A4A, TBC1D10C, MGC10471, FAM73B, SF1, MTA1, NFKB2, FLAD1, COPS7B, CSTA, MGC42174, ARRDC2, VAMP1, C16orf58, TMEM55B, NAT9, LIMD1, TNFRSF10A, PTCD2, ZDHHC8, STX12, RXRB, MLL, WDR39, ZC3H12A, FLJ21106, KLHDC3, NOL9, and WDR73, or fragment thereof. For example, a plurality of polynucleotides may comprise or consist of polynucleotides that bind specifically to nucleic acids that encode no more than 1000, e.g., no more than 500, 400, 300, 200, 100, 50, 20, or 10, breast cancer markers, wherein the breast cancer markers include ACAA2, SLC25A20, and/or SREBF1. The breast cancer markers may include TMEM63A, ARL16, PRO1580, RASGRP2, C19orf6, STX16 and/or MLLT6, and may include Clorf71, ENTPD4, DGKA, PPP6C, PDE7A, RUTBC1, PRPF3, MBTD1, SPG7, TNFRSF25, PDK4, MS4A4A, TBC1D10C, MGC10471, FAM73B, SF1, MTA1, NFKB2, FLAD1, COPS7B, CSTA, MGC42174, ARRDC2, VAMP1, C16orf58, TMEM55B, NAT9, LIMD1, TNFRSF10A, PTCD2, ZDHHC8, STX12, RXRB, MLL, WDR39, ZC3H12A, FLJ21106, KLHDC3, NOL9, and/or WDR73. A diagnostic panel comprising or consisting of a polynucleotide or plurality of polynucleotides described herein, and optionally at least one non-polynucleotide component (e.g., at least one support, reagent, buffer, and/or control) is also provided.

In another aspect, the invention provides an isolated antibody, e.g., a plurality of antibodies, or antigen-binding fragment(s) thereof, which binds specifically to a polypeptide selected from ACAA2, SLC25A20, SREBF1, TMEM63A, ARL16, PRO1580, RASGRP2, C19orf6, STX16, MLLT6, Clorf71, ENTPD4, DGKA, PPP6C, PDE7A, RUTBC1, PRPF3, MBTD1, SPG7, TNFRSF25, PDK4, MS4A4A, TBC1D10C, MGC10471, FAM73B, SF1, MTA1, NFKB2, FLAD1, COPS7B, CSTA, MGC42174, ARRDC2, VAMP1, C16orf58, TMEM55B, NAT9, LIMD1, TNFRSF10A, PTCD2, ZDHHC8, STX12, RXRB, MLL, WDR39, ZC3H12A, FLJ21106, KLHDC3, NOL9, and WDR73 polypeptides, or fragment (e.g., antigenic fragment) thereof. For example, a plurality of isolated antibodies is provided wherein the plurality comprises antibodies that bind specifically to ACAA2, SLC25A20, and/or SREBF1 polypeptides. The plurality may include antibodies that bind specifically to TMEM63A, ARL16, PRO1580, RASGRP2, C19orf6, STX16 and/or MLLT6, and may include Clorf71, ENTPD4, DGKA, PPP6C, PDE7A, RUTBC1, PRPF3, MBTD1, SPG7, TNFRSF25, PDK4, MS4A4A, TBC1D10C, MGC10471, FAM73B, SF1, MTA1, NFKB2, FLAD1, COPS7B, CSTA, MGC42174, ARRDC2, VAMP1, C16orf58, TMEM55B, NAT9, LIMD1, TNFRSF10A, PTCD2, ZDHHC8, STX12, RXRB, MLL, WDR39, ZC3H12A, FLJ21106, KLHDC3, NOL9, and/or WDR73 polypeptides. In some instances, the plurality may comprise or consist of antibodies that bind specifically to no more than 1000, e.g., no more than 500, 400, 300, 200, 100, 50, 20, or 10 breast cancer markers. In some instances, the plurality may comprise or consist of antibodies that bind specifically to at least 1000, e.g., at least 500, 400, 300, 200, 100, 50, 20, or 10 breast cancer markers. A diagnostic panel comprising or consisting of a plurality of antibodies, or antigen-binding fragments thereof described herein is also provided.

In yet another aspect, the invention provides an isolated breast cancer marker polypeptide, e.g., a plurality of polypeptides, or antigenic fragment(s) thereof, selected from ACAA2, SLC25A20, SREBF1, TMEM63A, ARL16, PRO1580, RASGRP2, C19orf6, STX16, MLLT6, Clorf71, ENTPD4, DGKA, PPP6C, PDE7A, RUTBC1, PRPF3, MBTD1, SPG7, TNFRSF25, PDK4, MS4A4A, TBC1D10C, MGC10471, FAM73B, SF1, MTA1, NFKB2, FLAD1, COPS7B, CSTA, MGC42174, ARRDC2, VAMP1, C16orf58, TMEM55B, NAT9, LIMD1, TNFRSF10A, PTCD2, ZDHHC8, STX12, RXRB, MLL, WDR39, ZC3H12A, FLJ21106, KLHDC3, NOL9, and WDR73 polypeptides. For example, a plurality of isolated polypeptides is provided wherein the plurality comprises ACAA2, SLC25A20, and/or SREBF1 polypeptides, or antigenic fragments thereof. The plurality may include TMEM63A, ARL16, PRO1580, RASGRP2, C19orf6, STX16 and/or MLLT6 polypeptides, and may include Clorf71, ENTPD4, DGKA, PPP6C, PDE7A, RUTBC1, PRPF3, MBTD1, SPG7, TNFRSF25, PDK4, MS4A4A, TBC1D10C, MGC10471, FAM73B, SF1, MTA1, NFKB2, FLAD1, COPS7B, CSTA, MGC42174, ARRDC2, VAMP1, C16orf58, TMEM55B, NAT9, LIMD1, TNFRSF10A, PTCD2, ZDHHC8, STX12, RXRB, MLL, WDR39, ZC3H12A, FLJ21106, KLHDC3, NOL9, and/or WDR73 polypeptides, or antigenic fragments thereof. In some instances, the plurality may comprise or consist of no more than 1000, e.g., no more than 500, 400, 300, 200, 100, 50, 20, or 10 breast cancer marker polypeptides. In some instances, the plurality may comprise or consist of at least 1000, e.g., at least 500, 400, 300, 200, 100, 50, 20, or 10 breast cancer marker polypeptides. A diagnostic panel comprising or consisting of a plurality of polypeptides, or fragments (e.g., antigenic fragments) described herein is also provided.

In yet another aspect, the invention provides a polynucleotide, e.g., a plurality of polynucleotides, wherein the polynucleotide(s) binds specifically to a nucleic acid encoding a breast cancer marker selected from ACAA2, SLC25A20, SREBF1, and MRPL40, or fragment thereof. The specification includes a diagnostic panel consisting of one or more polynucleotides and optionally at least one non-polynucleotide component (e.g., at least one support, buffer, reagent and/or control), wherein the polynucleotides bind specifically to a nucleic acid encoding at least one breast cancer marker selected from the group consisting of ACAA2, SLC25A20, SREBF1, and MRPL40, or fragment thereof and to no more than 1000, e.g., no more than 500, 400, 300, 200, 100, 50, 20, or breast cancer markers.

In a further aspect, the invention provides an antibody, e.g., a plurality of antibodies, or antigen-binding fragment thereof, that binds specifically to at least one breast cancer marker selected from ACAA2, SLC25A20, SREBF1, and MRPL40. The specification includes a diagnostic panel that includes at least one antibody, or antigen-binding fragment thereof, wherein the antibody binds specifically to a breast cancer marker selected from ACAA2, SLC25A20, SREBF1, and MRPL40, or a combination thereof. In some instances, the diagnostic panel or plurality may comprise or consist of antibodies that bind specifically to no more than 1000, e.g., no more than 500, 400, 300, 200, 100, 50, 20, or 10 breast cancer markers. In some instances, the diagnostic panel or plurality may comprise or consist of antibodies that bind specifically to at least 1000, e.g., at least 500, 400, 300, 200, 100, 50, 20, or 10 breast cancer markers.

In another aspect, the invention provides at least one breast cancer marker polypeptide, e.g., a plurality of breast cancer marker polypeptides, selected from ACAA2, SLC25A20, SREBF1, and MRPL40, or fragment (e.g., antigenic fragment) thereof. The specification further provides a diagnostic panel comprising at least one breast cancer marker polypeptide selected from ACAA2, SLC25A20, SREBF1, and MRPL40, or fragment thereof. In some instances, the plurality or diagnostic panel may comprise or consist of no more than 1000, e.g., no more than 500, 400, 300, 200, 100, 50, 20, or 10 breast cancer marker polypeptides. In some instances, the plurality or diagnostic panel may comprise or consist of at least 1000, e.g., at least 500, 400, 300, 200, 100, 50, 20, or breast cancer marker polypeptides.

In still another aspect, the invention provides a method for detecting the presence of breast cancer in a patient. The method generally includes: (a) obtaining a biological sample from the patient; and (b) detecting the level of expression of a breast cancer marker(s) (e.g., multiple markers) described herein in the biological sample using a polynucleotide or plurality of polynucleotides described herein, or a diagnostic/prognostic panel described herein, wherein a modulated (e.g., increased or decreased) level of expression as compared to a predetermined cut-off value for a breast cancer marker (e.g., multiple markers) indicates the presence of breast cancer in the patient. In some instances, (b) can include detecting the level of mRNA expression. In other instances, (b) can include detecting the level of mRNA expression using a nucleic acid hybridization technique. In still other instances, (b) can include detecting the level of mRNA expression using a nucleic acid amplification method. In still other instances, (b) can include detecting the level of mRNA expression using a nucleic acid amplification method such as transcription-mediated amplification, polymerase chain reaction amplification (PCR), reverse-transcription polymerase chain reaction amplification (RT-PCR), ligase chain reaction amplification (LCR), strand displacement amplification (SDA), and/or nucleic acid sequence based amplification (NASBA).

In a further aspect, the invention provides a method for detecting the presence of breast cancer in a patient that includes (a) obtaining a biological sample from the patient; and (b) detecting the level of protein expression of a breast cancer marker(s) (e.g., multiple markers) described herein in the biological sample using an antibody or plurality of antibodies or fragments thereof described herein, or a diagnostic/prognostic panel described herein, wherein a modulated level of protein expression as compared to a predetermined cut-off value for a breast cancer marker (e.g., multiple markers) indicates the presence of breast cancer in the patient. In some instances, (b) can include detecting the level of protein expression using an immunoassay. In other instances, (b) can include detecting the level of protein expression using an immunoassay such as ELISA, an immunohistochemical assay, and/or an immunocytochemical assay.

In yet another aspect, the invention provides a method for detecting the presence of breast cancer in a patient that includes (a) obtaining a biological sample from the patient; and (b) detecting the level of antibodies directed against a breast cancer marker(s) (e.g., multiple markers) in the biological sample using a polypeptide or plurality of polypeptides or fragments (e.g., antigenic fragments) thereof described herein, or a diagnostic/prognostic panel described herein, wherein a modulated (e.g., increased or decreased) level of antibodies as compared to a predetermined cut-off value for a breast cancer marker (e.g., multiple markers) indicates the presence of breast cancer in the patient.

In any method described herein, the biological sample may be, but is not limited to, blood, biopsy tissue (e.g., a breast biopsy tissue), lavage, sputum, serum, lymph node tissue, bone marrow, urine, or pleural effusion.

One aspect of the present invention provides a diagnostic panel comprising one or more binding agents, wherein each binding agent specifically binds one breast cancer marker selected from the breast cancer markers provided herein, such as those listed in Table 2 and/or Table 3. In one embodiment, the binding agents comprise a polynucleotide, a polypeptide, or an antibody. In certain embodiments, the diagnostic panel may comprise two or more binding agents. In this regard, the diagnostic panel may comprise, 2, 3, 4, 5, 6, 7, 8, 9, 10, 11, 12, 13, 14, 15, 16, 17, 18, 19, 20 or more binding agents. In one embodiment, the diagnostic panels described herein may comprise at least four binding agents. In a further embodiment, the diagnostic panel comprises at least one binding agent specifically binds any one of the markers listed in Table 2.

Another aspect of the invention provides a method for detecting the presence of breast cancer cells in a biological sample comprising the steps of:
(a) detecting the level of expression in the biological sample of any one or more of the breast cancer markers provided herein, such as those provided in Table 2 and Table 3; and
(b) comparing the level of expression detected in the biological sample for each marker to a predetermined cut-off value for each marker;

wherein a detected level of expression above or below the predetermined cut-off value for one or more markers is indicative of the presence of cancer cells in the biological sample. In one embodiment, detecting the level of expression in the biological sample of any one or more of the breast cancer markers provided herein comprises detecting the level of mRNA expression. In this regard, mRNA expression may be detected using a nucleic acid hybridization technique or other methods for detecting mRNA expression such as, but not limited to, transcription-mediated amplification (TMA), polymerase chain reaction amplification (PCR), reverse-transcription polymerase chain reaction amplification (RT-PCR), ligase chain reaction amplification (LCR), strand displacement amplification (SDA), and nucleic acid sequence based amplification (NASBA). In a further embodiment, the breast cancer markers of the panels and methods describe herein comprises a nucleic acid sequence set forth in any one of SEQ ID NOs:1-3005 or a nucleic acid sequence encoding an amino acid sequence set forth in any one of SEQ ID NOs:3006-5970. In yet a further embodiment of the method, detecting the level of expression in the biological sample of any one or more of the breast cancer markers provided herein comprises detecting the level of protein expression. Protein expression can be measured using any of a number of assays, including but not limited to an immunoassay (e.g., an ELISA, an immunohistochemical assay, an immunocytochemical assay, or a flow cytometry assay of antibody-labeled cells. In certain embodiments, the breast cancer marker comprises an amino acid sequence set forth in any one of SEQ ID NOs:3006-5970.

In certain embodiments, the biological sample is a sample suspected of containing breast cancer markers, antibodies to such breast cancer markers or cancer cells expressing such markers or antibodies. In this regard, the biological sample may be, but is not limited to, a peripheral blood sample, biopsy sample, lavage sample, sputum sample, serum sample, lymph node sample, bone marrow sample, urine sample, or pleural effusion sample.

Another aspect of the invention provides a diagnostic panel comprising one or more binding agents, wherein each binding agent specifically binds one breast cancer marker selected from the breast cancer markers provided in Table 3. In one embodiment, one or more binding agents in a panel specifically binds to a breast cancer marker selected from the group consisting of ACAA2, SLC25A20, SREBF1, TMEM63A, ARL16, PRO1580, RASGRP2, C19orf6, STX16, and MLLT6. In a further embodiment, the one or more binding agents specifically binds to a breast cancer marker selected from the group consisting of SLC25A20, STX16, MLLT6, DEF6, GOS2, ZNF160, FKBP5, FLJ40432, ZFP36L1 and DALRD3. In another embodiment, the one or more binding agents specifically binds to a breast cancer marker selected from the group consisting of ACAA2, SLC25A20, SREBF1, TMEM63A, ARL16, PRO1580, RASGRP2, C19orf6, STX16, MLLT6, DEF6, GOS2, NSUN5B, C9orf114, FAM98C, PCGF1, LIPA, CPNE5, LOC221955, and FLJ22709. In yet another embodiment, the one or more binding agents specifically binds to a breast cancer marker selected from the group consisting of ACAA2, SLC25A20, SREBF1, TMEM63A, ARL16, PRO1580, RASGRP2, C19orf6, STX16, MLLT6, FKBP5, CPNE5, PHF22, MRPL47, CREM, FLJ40432, ZNF160, ZFP36L1, DDX10, and IL8. In a further embodiment, the one or more binding agents specifically binds to a breast cancer marker selected from the group consisting of ACAA2, SLC25A20, SREBF1, TMEM63A, ARL16, PRO1580, RASGRP2, C19orf6, STX16, MLLT6, FKBP5, FLJ23235, MIPEP, ZCRB1, RAP1GDS1, DALRD3, DEXI, FLJ40432, GGA2, and C20orf14.

In certain embodiments, the diagnostic panel of the invention comprises a combination of 2, 3, 4, 5, 6, 7 or more binding agents, wherein each binding agent specifically binds one breast cancer marker selected from the group consisting of ACAA2, SLC25A20, SREBF1, TMEM63A, ARL16, PRO1580, RASGRP2, C19orf6, STX16, and MLLT6. In another embodiment the diagnostic panel of the invention comprises a combination of 2, 3, 4, 5, 6, 7 or more binding agents, wherein each binding agent specifically binds one breast cancer marker selected from the group consisting of SLC25A20, STX16, MLLT6, DEF6, GOS2, ZNF160, FKBP5, FLJ40432, ZFP36L1 and DALRD3. In yet a further embodiment, the diagnostic panel of the invention comprises a combination of 2, 3, 4, 5, 6, 7 or more binding agents, wherein each binding agent specifically binds one breast cancer marker selected from the group consisting of ACAA2, SLC25A20, SREBF1, TMEM63A, ARL16, PRO1580, RASGRP2, C19orf6, STX16, MLLT6, DEF6, GOS2, NSUN5B, C9orf114, FAM98C, PCGF1, LIPA, CPNE5, LOC221955, and FLJ22709. In another embodiment, the diagnostic panel may comprise a combination of 2, 3, 4, 5, 6, 7 or more binding agents, wherein each binding agent specifically binds one breast cancer marker selected from the group consisting of ACAA2, SLC25A20, SREBF1, TMEM63A, ARL16, PRO1580, RASGRP2, C19orf6, STX16, MLLT6, FKBP5, CPNE5, PHF22, MRPL47, CREM, FLJ40432, ZNF160, ZFP36L1, DDX10, and IL8. In a further embodiment, the diagnostic panel may comprise a combination of 2, 3, 4, 5, 6, 7 or more binding agents, wherein each binding agent specifically binds one breast cancer marker selected from the group consisting of ACAA2, SLC25A20, SREBF1, TMEM63A, ARL16, PRO1580, RASGRP2, C19orf6, STX16, MLLT6, FKBP5, FLJ23235, MIPEP, ZCRB1, RAP1GDS1, DALRD3, DEXI, FLJ40432, GGA2, and C20orf14.

Another aspect of the present invention provides a diagnostic panel comprising 10 binding agents, wherein each binding agent specifically binds one breast cancer marker selected from the group consisting of ACAA2, SLC25A20, SREBF1, TMEM63A, ARL16, PRO1580, RASGRP2, C19orf6, STX16, and MLLT6. In one embodiment, each binding agent specifically binds one breast cancer marker selected from the group consisting of SLC25A20, STX16, MLLT6, DEF6, GOS2, ZNF160, FKBP5, FLJ40432, ZFP36L1 and DALRD3.

A further aspect of the invention provides a diagnostic panel comprising 20 binding agents, wherein each binding agent specifically binds one breast cancer marker selected from the group consisting of ACAA2, SLC25A20, SREBF1, TMEM63A, ARL16, PRO1580, RASGRP2, C19orf6, STX16, MLLT6, DEF6, GOS2, NSUN5B, C9 orf114, FAM98C, PCGF1, LIPA, CPNE5, LOC221955, and FLJ22709. In one embodiment, each binding agent specifically binds one breast cancer marker selected from the group consisting of ACAA2, SLC25A20, SREBF1, TMEM63A, ARL16, PRO1580, RASGRP2, C19orf6, STX16, MLLT6, FKBP5, CPNE5, PHF22, MRPL47, CREM, FLJ40432, ZNF160, ZFP36L1, DDX10, and IL8. In another embodiment, each binding agent specifically binds one breast cancer marker selected from the group consisting of ACAA2, SLC25A20, SREBF1, TMEM63A, ARL16, PRO1580, RASGRP2, C19orf6, STX16, MLLT6, FKBP5, FLJ23235, MIPEP, ZCRB1, RAP1GDS1, DALRD3, DEXI, FLJ40432, GGA2, and C20orf14. In certain embodiments, the binding agents my comprise polynucleotides or antibodies.

Unless otherwise defined, all technical and scientific terms used herein have the same meaning as commonly understood by one of ordinary skill in the art to which this invention belongs. Methods and materials are described herein for use in the present invention; other, suitable methods and materials known in the art can also be used. The materials, methods, and examples are illustrative only and not intended to be limiting. All publications, patent applications, patents, sequences, database entries, and other references mentioned herein are incorporated by reference in their entirety. In case of conflict, the present specification, including definitions, will control.

Other features and advantages of the invention will be apparent from the following detailed description and figures, and from the claims.

### DESCRIPTION OF DRAWINGS

FIG. 1 is a line graph showing the accuracy, the sensitivity and the specificity of the biomarker panel as a function of the number of breast cancer markers in the panel using breast cancer markers selected by the LIMMA approach.

FIG. 2 is a line graph showing the accuracy, the sensitivity and the specificity of the biomarker panel as a function of the number of breast cancer markers in the panel using breast cancer markers selected by the LDA approach.

FIG. 3 is a line graph showing the accuracy, the sensitivity and the specificity of the biomarker panel as a function of the number of breast cancer markers in the panel using breast cancer markers selected by the SVM approach.

FIG. 4 shows the nucleic acid sequence of PTCD2 (SEQ ID NO:64).

FIG. 5 shows the amino acid sequence of PTCD2 (SEQ ID NO3069).

FIG. 6 shows the nucleic acid sequence of SLC25A20 (SEQ ID N0:2).

FIG. 7 shows the amino acid sequence of SLC25A20 (SEQ ID NO:3007).

FIGS. 8A-8B show the nucleic acid sequence of NFKB2 (SEQ ID N0:48).

FIGS. 9A-9D show the amino acid sequence of NFKB2 (SEQ ID NO:3053).

FIGS. 10A-10B show the nucleic acid sequences of RASGRP2 (SEQ ID NOs:9 (10A) and 10 (10B)).

FIGS. 11A-11D show the amino acid sequences of RASGRP2 (SEQ ID N0:3014 (11A-11B) and 3015 (11C-11D)).

FIGS. 12A-12C show the nucleic acid sequences of PDE7A (SEQ ID NOs:24 (12A) and 25 (12B-12C)).

FIGS. 13A-13D show the amino acid sequences of PDE7A (SEQ ID NOs:3029 (13A-13B) and 3030 (13C-13D)).

FIGS. 14A-14F show the nucleic acid sequence of MLL (SEQ ID N0:68).

FIGS. 15A-15L show the amino acid sequence of MLL (SEQ ID NO:3073).

FIGS. 16A-16C show the nucleic acid sequence of PRKCE (SEQ ID NO:1545).

FIGS. 17A-17C show the amino acid sequence of PRKCE (SEQ ID NO4544).

FIG. 18 shows the nucleic acid sequence of GPATC3 (SEQ ID NO:2757).

FIGS. 19A-19B show the amino acid sequence of GPATC3 (SEQ ID NO:5724).

FIGS. 20A-20H show the nucleic acid sequences of PRIC285 (SEQ ID NOs:2059 (20A-20D) and 2060 (20E-20H)).

FIGS. 21A-21O show the amino acid sequences of PRIC285 (SEQ ID NOs:5055 (21A-21H) and 5056 (21I-21O)).

FIG. 22 shows the nucleic acid sequence of GSTA4 (SEQ ID NO:482).

FIG. 23 shows the amino acid sequence of GSTA4 (SEQ ID NO:3483).

### DETAILED DESCRIPTION

The present disclosure is based, at least in part, on the discovery that the expression of certain polynucleotides and polypeptides, referred to herein as breast cancer biomarkers, is altered in subjects that have breast cancer. In general, the methods described herein are based on the identification of the biomarkers, which can be used as predictors of disease and to monitor therapy. The biomarkers show either increased or decreased protein levels in subjects diagnosed with breast cancer when compared to control individuals, e.g., as determined by microarray data and computational analysis. The breast cancer biomarkers are described throughout the present specification and are listed, for example, in Tables 2 and 3.

Accordingly, the present disclosure provides, inter alia, breast cancer biomarker polynucleotide and polypeptides, binding agents (e.g., for the detection of one or more breast cancer biomarkers or antibodies directed against biomarkers (e.g., pluralities of binding agents, such as polynucleotides, polypeptides, and/or antibodies)) and panels (e.g., diagnostic and/or prognostic panels) that comprise one or more binding agents. The disclosure also provides methods that allow the detection (e.g., the evaluation) of altered levels of one or more breast cancer biomarkers ((e.g., markers provided in SEQ ID NOs:1-5970), e.g., in soluble form and/or on the surface of a cancer cell) in a biological sample derived from a subject. The breast cancer biomarkers, binding agents, and panels described herein can be used, e.g., to determine whether a subject has or is at increased risk for developing breast cancer and/or to monitor a subject's breast cancer while the subject is undergoing breast cancer treatment.

As used herein, the terms “breast cancer marker”, “breast cancer-associated marker”, or “breast cancer biomarker” means a polynucleotide or polypeptide sequence described herein whose expression is either lower or higher, e.g., to a statistically significant degree, e.g., in a statistically significant proportion of biological samples, derived from breast cancer patients, for example greater than about 20%, about 30%, and in certain embodiments, greater than about 50% or more, of biological samples from breast cancer patients tested, than the level of expression in a normal control biological sample, as determined using a representative assay provided herein (see e.g., Table 2). In some embodiments, a sequence shown to have an increased or decreased level of expression in samples derived from breast cancer patients as compared to a predetermined cut-off value (methods for determining which are provided below) has particular utility as a cancer diagnostic/prognostic marker and can, individually or in a group with other markers (e.g., as part of a panel), be used to detect breast cancer or an increased risk of breast cancer in a subject. Further, in certain embodiments, such biomarkers can be used as a therapeutic targets.

### A. Panels, Breast Cancer Markers, and Binding Agents

The present disclosure provides panels (e.g., diagnostic and/or prognostic panels) for detecting and/or measuring the levels of expression of one or more of breast cancer markers (see e.g., Tables 2 and 3 and/or in SEQ ID NOs: 1-5970). As used herein, the term panel (e.g., “diagnostic panel” or “prognostic panel”) includes, but is not limited to panels, arrays, mixtures, and kits that comprise binding agents or probes specific for detecting the breast cancer markers disclosed herein or a control and any of a variety of associated buffers, solutions, appropriate negative and positive controls, instruction sets, detection reagents, reporter groups.

As used herein, a “binding agent” means any agent that specifically associates or specifically binds directly or indirectly to a breast cancer marker in the test sample and that can be detected using one or more detection methods, as described below (see, e.g., sections titled detection methods). A binding agent may be, for example, a polynucleotide, polypeptide, or an antibody binding agent. The term “specifically” is a term of art that would be readily understood by the skilled artisan to mean, in this context, that the breast cancer marker of interest (e.g., protein, nucleic acid, etc) is bound by the particular binding agent but other markers, e.g., control markers, are not significantly bound. Specificity can be determined using appropriate positive and negative controls and by routinely optimizing conditions. In some instances, binding agents can be bispecific such that the panel is comprised of one or more bispecific binding agents that may specifically detect more than one breast cancer marker. Panels can also comprise a binding agent that does not detect a breast cancer biomarker disclosed herein, for example, a control binding agent that is not specific for a breast cancer biomarker.

Panels may also include detection reagents and reporter groups. Reporter groups may include radioactive groups, dyes, fluorophores, biotin, colorimetric substrates, enzymes, or colloidal compounds. Illustrative reporter groups include but are not limited to, fluorescein, tetramethyl rhodamine, Texas Red, coumarins, carbonic anhydrase, urease, horseradish peroxidase, dehydrogenases and/or colloidal gold or silver. For radioactive groups, scintillation counting or autoradiographic methods are generally appropriate for detection. Spectroscopic methods may be used to detect dyes, luminescent groups and fluorescent groups. Biotin may be detected using avidin, coupled to a different reporter group (commonly a radioactive or fluorescent group or an enzyme). Enzyme reporter groups may generally be detected by the addition of substrate (generally for a specific period of time), followed by spectroscopic or other analysis of the reaction products.

Panels can comprise binding agents for binding and detecting any combination of one or more of the breast cancer markers as described herein to detect breast cancer. Thus, in one embodiment, the panels can comprise binding agents for specifically detecting 2, 3, 4, 5, 6, 7, 8, 9, 10, 11, 12, 13, 14, 15, 16, 17, 18, 19, or 20 (e.g., up to 100) of the cancer-associated markers described herein simultaneously. In a further embodiment, the panels can comprise binding agents for specifically detecting 21, 22, 23, 24, 25, 26, 27, 28, 29, 30, 31, 32, 33, 34, 35, 36, 37, 38, 39, or 40 (e.g., up to 100) of the cancer-associated markers described herein simultaneously. In another embodiment, the panels can comprise binding agents for specifically detecting 45, 50, 55, 60, 65, 70, 75, 80, 85, 90, 95, 100 or more of the cancer-associated markers described herein simultaneously. In certain embodiments, panels can comprise binding agents for specifically detecting all of the breast cancer markers described herein simultaneously.

In general, a panel can include a solid support. By “solid support” is meant a material that is essentially insoluble under the solvent and temperature conditions of the method comprising free chemical groups available for joining an oligonucleotide or nucleic acid. The solid support can be covalently coupled to an oligonucleotide designed to bind, either directly or indirectly, a target nucleic acid. When the target nucleic acid is an mRNA, the oligonucleotide attached to the solid support is preferably a poly-T sequence.

Skilled practitioners will appreciate that the solid support may be any material known to those of ordinary skill in the art to which a binding agent may be attached. For example, the solid support may be a test well in a microtiter plate or a nitrocellulose or other suitable membrane. Alternatively, the support may be a bead or disc, such as glass, fiberglass, latex, or a plastic material such as polystyrene or polyvinylchloride. The support may also be a magnetic particle or a fiber optic sensor, such as those disclosed, for example, in U.S. Pat. No. 5,359,681. Other exemplary solid support materials include, but are not limited to silica, polyacrylate, polyacrylamide, metal, polystyrene, latex, nitrocellulose, polypropylene, nylon or combinations thereof. In some embodiments, the solid support is capable of being attracted to a location by means of a magnetic field, such as a solid support having a magnetite core. An exemplary solid support is a particle, such as a micron- or submicron-sized bead or sphere. In some embodiments, the supports are monodisperse magnetic spheres.

Methods for immobilizing the binding agents disclosed herein in or on the surface of a solid support are known in the art. In the context of the present invention, the term “immobilization” refers to both noncovalent association, such as adsorption, and covalent attachment, which may be a direct linkage between the agent and functional groups on the support or may be a linkage by way of a cross-linking agent. Immobilization by adsorption to a well in a microtiter plate or to a membrane is preferred. In such cases, adsorption may be achieved by contacting the binding agent, in a suitable buffer, with the solid support for a suitable amount of time. The contact time varies with temperature, but is typically between about 1 hour and about 1 day. In general, contacting a well of a plastic microtiter plate (such as polystyrene or polyvinylchloride) with an amount of binding agent ranging from about 10 ng to about 10 μg, and preferably about 100 ng to about 1 μg, is sufficient to immobilize an adequate amount of binding agent.

Covalent attachment of a binding agent to a solid support may generally be achieved by first reacting the support with a bifunctional reagent that will react with both the support and a functional group, such as a hydroxyl or amino group, on the binding agent. For example, the binding agent may be covalently attached to supports having an appropriate polymer coating using benzoquinone or by condensation of an aldehyde group on the support with an amine and an active hydrogen on the binding partner (see, e.g., Pierce Immunotechnology Catalog and Handbook, A12 A13 (1991)).

In some embodiments, the present disclosure provides kits comprising one or more of the panels disclosed herein and instructions for use. For example, provided herein is an article of manufacture comprising a container and a composition of matter contained within the container, wherein the composition of matter may comprise a breast cancer polypeptide, an anti breast cancer polypeptide antibody, an oligopeptide, or a binding organic molecule, each as described herein. The article may further optionally comprise a label affixed to the container, or a package insert included with the container, that refers to the use of the composition of matter for the therapeutic treatment or diagnostic detection of breast cancer.

(1) Polynucleotides and Polynucleotide Panels

The present disclosure provides isolated breast cancer biomarker polynucleotides (e.g., one or more of the nucleic acids disclosed in Tables 2 and 3 and/or one or more of SEQ ID NOs:1-3005), polynucleotide binding agents that bind to the breast cancer biomarker polynucleotides, and panels that include the polynucleotide binding agents.

“Isolated,” as used herein, means that a polynucleotide is substantially away from other coding sequences, and that a DNA molecule does not contain large portions of unrelated coding DNA, such as large chromosomal fragments or other functional genes or polypeptide coding regions. Of course, this refers to the DNA molecule as originally isolated, and does not exclude genes or coding regions later added to the segment by the hand of man.

By “nucleotide sequence”, “nucleic acid sequence” or “polynucleotide” is meant the sequence of nitrogenous bases along a linear information-containing molecule (e.g., DNA or RNA; including cDNA and various forms of RNA such as mRNA, tRNA, hnRNA, and the like) that is capable of hydrogen-bonding with another linear information-containing molecule having a complementary base sequence. The terms are not meant to limit such information-containing molecules to polymers of nucleotides per se but are also meant to include molecular structures containing one or more nucleotide analogs or abasic subunits in the polymer. The polymers may include base subunits containing a sugar moiety or a substitute for the ribose or deoxyribose sugar moiety (e.g., 2′ halide- or methoxy-substituted pentose sugars), and may be linked by linkages other than phosphodiester bonds (e.g., phosphorothioate, methylphosphonate or peptide linkages). As will be understood by those skilled in the art, polynucleotides can include genomic sequences, extra-genomic and plasmid-encoded sequences and smaller engineered gene segments that express, or may be adapted to express, proteins, polypeptides, peptides and the like. Such segments may be naturally isolated, or modified synthetically by the hand of man.

As will also be recognized by the skilled artisan, polynucleotides may be single-stranded (coding or antisense) or double-stranded, and may be DNA (genomic, cDNA or synthetic) or RNA molecules. RNA molecules may include hnRNA molecules, which contain introns and correspond to a DNA molecule in a one-to-one manner, and mRNA molecules, which do not contain introns. Additional coding or non-coding sequences may, but need not, be present within a polynucleotide of the present invention, and a polynucleotide may, but need not, be linked to other molecules and/or support materials.

Polynucleotides can comprise some or all of a polynucleotide sequence set forth in any one of SEQ ID NOs:1-3005, the complement of some or all of a polynucleotide sequence set forth in any one of SEQ ID NOs:1-3005, and degenerate variants of a polynucleotide sequence set forth in any one of SEQ ID NOs:1-3005.

Polynucleotide variants having substantial identity to the sequences disclosed in SEQ ID NOs:1-3005 are also included, for example those comprising at least 70% sequence identity, preferably at least 75%, 80%, 85%, 90%, 95%, 96%, 97%, 98%, or 99% or higher, sequence identity compared to a polynucleotide sequence of this invention using the methods described herein, (e.g., BLAST analysis using standard parameters, as described below). One skilled in this art will recognize that these values can be appropriately adjusted to determine corresponding identity of proteins encoded by two nucleotide sequences by taking into account codon degeneracy, amino acid similarity, reading frame positioning and the like.

Polynucleotide fragments provided herein can comprise or consist of various lengths of contiguous stretches of sequence identical to or complementary to one or more of the cancer-associated polynucleotides disclosed herein, e.g., immobilized in or on the surface of a support. For example, polynucleotides can comprise or consist of at least about 10, 15, 20, 30, 40, 50, 75, 100, 150, 200, 300, 400, 500 or 1000 or more contiguous nucleotides of one or more of the sequences disclosed herein, or of the complement of the sequences, as well as all intermediate lengths there between. It will be readily understood that “intermediate lengths”, in this context, means any length between the quoted values, such as 16, 17, 18, 19, etc.; 21, 22, 23, etc.; 30, 31, 32, etc.; 50, 51, 52, 53, etc.; 100, 101, 102, 103, etc.; 150, 151, 152, 153, etc.; including all integers through 200-500; 500-1,000, and the like. A polynucleotide sequence as described herein may be extended at one or both ends by additional nucleotides not found in the native sequence. This additional sequence may consist of 1, 2, 3, 4, 5, 6, 7, 8, 9, 10, 11, 12, 13, 14, 15, 16, 17, 18, 19, or 20 nucleotides at either end of the disclosed sequence or at both ends of the disclosed sequence.

The present invention further provides oligonucleotides and compositions comprising oligonucleotides, e.g., immobilized in or on the surface of a support. By “oligonucleotide” is meant a polymeric chain of two or more chemical subunits, each subunit comprising a nucleotide base moiety, a sugar moiety, and a linking moiety that joins the subunits in a linear spacial configuration. An oligonucleotide may contain up to thousands of such subunits, but generally contains subunits in a range having a lower limit of between about 5 to about 10 subunits, and an upper limit of between about 20 to about 1,000 subunits.

In some embodiments, the oligonucleotides comprise no more than 10, 15, 20, 25, 30, 35, 40, 45, 50, 55, 60, 65, 70, 75, 80, 85, 90, 95 or 100 contiguous nucleotides of any one of the polynucleotides recited in SEQ ID NOs: 1-3005, or their complements, and may also comprise additional nucleotides unrelated to the polynucleotides recited in SEQ ID NOs: 1-3005. For example, as would be readily recognized by the skilled artisan, oligonucleotide primers and probes can also comprise additional sequence unrelated to the target nucleic acid, such as restriction endonuclease cleavage sites, linkers, and the like. This additional sequence may consist of 1, 2, 3, 4, 5, 6, 7, 8, 9, 10, 11, 12, 13, 14, 15, 16, 17, 18, 19, or 20, or more nucleotides at either end of the disclosed sequence or at both ends of the disclosed sequence. Skilled practitioners will appreciate that primers are useful in the present methods and are included in the present invention. By “primer” or “amplification primer” is meant an oligonucleotide capable of binding to a region of a target nucleic acid or its complement and promoting, either directly or indirectly, nucleic acid amplification of the target nucleic acid. Such primers can be binding agents and used to identify and/or amplify one or more of the breast cancer marker polynucleotides disclosed herein.

(2) Polypeptides and Polypeptide Panels

In some embodiments, the panels can comprise one or more of the breast cancer associated polypeptides (e.g., one or more isolated polypeptides) disclosed herein (e.g., one or more of the polypeptides encoded by the nucleic acid sequences disclosed in Tables 2 and 3 and/or SEQ ID NOs: 1-3005, and/or one or more of the polypeptides shown in SEQ ID NOs:3006-5970, or fragments thereof). Accordingly, various polypeptides are also included within the invention.

As used herein, the term “polypeptide” is used in its conventional meaning, i.e., as a sequence of amino acids. The polypeptides are not limited to a specific length of the product; thus, peptides, oligopeptides, and proteins are included within the definition of polypeptide, and such terms may be used interchangeably herein unless specifically indicated otherwise. This term also does not refer to or exclude post-expression modifications of the polypeptide, for example, glycosylations, acetylations, phosphorylations and the like, as well as other modifications known in the art, both naturally occurring and non-naturally occurring. A polypeptide may be an entire protein, or a subsequence thereof. In certain embodiments, polypeptides of interest in the context of this invention are amino acid subsequences comprising epitopes, e.g., antigenic determinants recognized by antibodies.

Particularly illustrative polypeptides of the present invention comprise those encoded by a polynucleotide sequence set forth in any one of SEQ ID NOs:1-3005. Certain other illustrative polypeptides of the invention comprise amino acid sequences as set forth in any one of SEQ ID NOs:3006-5970.

The polypeptides disclosed herein are sometimes referred to herein as “breast cancer-associated proteins”, “breast cancer-specific proteins”, “breast cancer-associated markers”, “breast cancer markers”, or “breast cancer biomarkers”, as an indication that their identification has been based at least in part upon their differential expression levels in samples from breast cancer patients as compared to samples from normal controls. Thus, these terms refer generally to a polypeptide sequence of the present invention whose expression is either lower or higher to a statistically significant degree than the level of expression in a normal control biological sample (e.g., blood sample) in a statistically significant proportion of biological samples derived from breast cancer patients, for example greater than about 20%, more preferably greater than about 30%, and most preferably greater than about 50% or more of breast cancer samples tested, as compared to normal controls, as determined using a representative assay provided herein. A breast cancer-associated polypeptide sequence of the invention, based upon its increased or decreased level of expression in samples from breast cancer patients, has particular utility both as a diagnostic marker as well as a therapeutic target, as further described herein.

In some embodiments, the polypeptides disclosed herein are immunogenic in that they react detectably within an immunoassay (such as an ELISA) with antisera from a patient with breast cancer. As would be recognized by the skilled artisan, immunogenic portions of the polypeptides disclosed herein are also encompassed by the present invention and can be included in a diagnostic/prognostic panel. An “immunogenic portion,” or polypeptide “fragment” as used herein, is a fragment of a polypeptide of the invention that itself is immunologically reactive (i.e., specifically binds) with antibodies that recognize the full-length polypeptide. Such polypeptide fragments may generally be identified using well known techniques, such as those summarized in Paul, Fundamental Immunology, pp. 243 47 (3rd ed., 1993) and references cited therein. Such techniques include screening polypeptides for the ability to react with antigen-specific antibodies or antisera.

As used herein, antisera and antibodies are “antigen-specific” if they specifically bind to an antigen (i.e., they react with the protein in an ELISA or other immunoassay, and do not react in a statistically significant manner under similar conditions with suitable control proteins). Such antisera and antibodies may be prepared using well-known techniques.

An immunogenic portion of a polypeptide of the present invention can be a fragment that reacts with antisera and/or monoclonal antibodies at a level that is not statistically significantly less than the reactivity of the full-length polypeptide (e.g., in an ELISA or similar immunoassay). In this manner, fragments of a breast cancer marker polypeptide as disclosed herein can be used in lieu of, or in addition to, a full-length polypeptide in any number of methods for detecting breast cancer. The level of immunogenic activity of the immunogenic portion may be, e.g., at least about 50%, e.g., preferably at least about 70% and most preferably greater than about 90% of the immunogenicity for the full-length polypeptide. In some instances, polypeptide fragments useful in the present invention will be identified that have a level of reactivity greater than that of the corresponding full-length polypeptide, e.g., having greater than about 100% or 150% or more immunogenic activity.

Polypeptide fragments can include at least about 5, 10, 15, 20, 25, 30, 35, 40, 45, 50, 55, 60, 65, 70, 75, 80, 85, 90, 95 or 100 contiguous amino acids, or more, including all intermediate lengths, of a cancer-associated polypeptide set forth herein, such as those set forth in SEQ ID NOs:3006-5970, or those encoded by a polynucleotide sequence set forth in a sequence of SEQ ID NOs: 1-3005. In certain embodiments, the present invention provides polypeptide fragments that consist of no more than about 5, 10, 15, 20, 25, 30, 35, 40, 45, 50, 55, 60, 65, 70, 75, 80, 85, 90, 95 or 100 contiguous amino acids, including all intermediate lengths, of a cancer-associated polypeptide set forth herein, such as those set forth in SEQ ID NOs:3006-5970, or those encoded by a polynucleotide sequence set forth in a sequence of SEQ ID NOs: 1-3005 and may also comprise additional amino acids unrelated to the polypeptides recited in SEQ ID NOs:3006-5970. For example, as would be readily recognized by the skilled artisan, polypeptide fragments such as antibody epitopes can also comprise additional sequence for use in purification or attachment to solid surfaces as described herein (e.g., His tags or other similar tags). This additional sequence may consist of 1, 2, 3, 4, 5, 6, 7, 8, 9, 10, 11, 12, 13, 14, 15, 16, 17, 18, 19, or 20, or more amino acids at either end of the fragment of interest or at both ends of the fragment of interest.

Any of the polypeptides can be recombinant and, e.g., comprise one or more fragments that are specifically recognized by antibodies that are immunologically reactive with one or more cancer-associated polypeptides described herein.

In another embodiment, the present invention provides variants of the polypeptide compositions described herein, e.g., in or on the surface of a support. Polypeptide variants will typically exhibit at least about 70%, 75%, 80%, 85%, 90%, 91%, 92%, 93%, 94%, 95%, 96%, 97%, 98%, or 99% or more identity (determined as described below), along its length, to a polypeptide sequences set forth herein. The polypeptide variants are immunologically reactive with an antibody that reacts with the corresponding non-variant full-length cancer-associated polypeptide as set forth in SEQ ID NOs:3006-5970. In certain embodiments, the polypeptide variants exhibit a level of immunogenic activity of at least about 50%, e.g., at least about 70%, and most preferably at least about 90% or more of that exhibited by a non-variant polypeptide sequence specifically set forth herein.

A polypeptide “variant,” as the term is used herein, is a polypeptide that typically differs from a polypeptide specifically disclosed herein in one or more substitutions, deletions, additions and/or insertions. Such variants may be naturally occurring or may be synthetically generated, for example, by modifying one or more of the polypeptide sequences described herein and evaluating their immunogenic activity using any of a number of techniques well known in the art.

For example, certain illustrative variants of the polypeptides of the invention include those in which one or more portions, such as an N terminal leader sequence or transmembrane domain, have been removed. Other illustrative variants include variants in which a small portion (e.g., 1-30 amino acids, e.g., 5-15 amino acids) has been removed from the N and/or C terminal of the mature protein.

In some instances, a variant will contain conservative substitutions. A “conservative substitution” is one in which an amino acid is substituted for another amino acid that has similar properties, such that one skilled in the art of peptide chemistry would expect the secondary structure and hydropathic nature of the polypeptide to be substantially unchanged. Amino acid substitutions are generally based on the relative similarity of the amino acid side-chain substituents, for example, their hydrophobicity, hydrophilicity, charge, size, and the like. Exemplary substitutions that take various characteristics into consideration are well known to those of skill in the art and include: arginine and lysine; glutamate and aspartate; serine and threonine; glutamine and asparagine; and valine, leucine and isoleucine.

Polypeptides may comprise a signal (or leader) sequence at the N terminal end of the protein, which co translationally or post-translationally directs transfer of the protein. The polypeptide may also be conjugated to a linker or other sequence for ease of synthesis, purification or identification of the polypeptide (e.g., poly-His), or to enhance binding of the polypeptide to a solid support. For example, a polypeptide may be conjugated to an immunoglobulin Fc region.

Polypeptides of the invention are prepared using any of a variety of well known synthetic and/or recombinant techniques. Polypeptides, portions and other variants generally less than about 150 amino acids can be generated by synthetic means. Techniques for preparing polypeptides are well known to those of ordinary skill in the art (see, e.g., J. Am. Chem. Soc. 85:2149-46 (1963)).

In general, polypeptide compositions (including fusion polypeptides) of the invention are isolated. An “isolated” polypeptide is one that is removed from its original environment. For example, a naturally-occurring protein or polypeptide is isolated if it is separated from some or all of the coexisting materials in the natural system. Preferably, such polypeptides are also purified, e.g., are at least about 90% pure, more preferably at least about 95% pure and most preferably at least about 99% pure.

When comparing polypeptide or polynucleotide sequences, two sequences are said to be “identical” if the nucleotide or amino acid sequence in the two sequences is the same when aligned for maximum correspondence, as described below. Comparisons between two sequences are typically performed by comparing the sequences over a comparison window to identify and compare local regions of sequence similarity. A “comparison window” as used herein, refers to a segment of at least about 20 contiguous positions, usually 30 to about 75, 40 to about 50, in which a sequence may be compared to a reference sequence of the same number of contiguous positions after the two sequences are optimally aligned.

Optimal alignment of sequences for comparison may be conducted using the BLAST and BLAST 2.0 algorithms, which are described in Altschul et al., Nucl. Acids Res. 25:3389-3402 (1977), and Altschul et al., J. Mol. Biol. 215:403-10 (1990), respectively. BLAST and BLAST 2.0 can be used, for example, with the parameters described herein, to determine percent sequence identity for the polynucleotides and polypeptides of the invention. Software for performing BLAST analyses is publicly available through the National Center for Biotechnology Information. For amino acid sequences, a scoring matrix can be used to calculate the cumulative score. Extension of the word hits in each direction are halted when: the cumulative alignment score falls off by the quantity X from its maximum achieved value; the cumulative score goes to zero or below, due to the accumulation of one or more negative-scoring residue alignments; or the end of either sequence is reached. The BLAST algorithm parameters W, T and X determine the sensitivity and speed of the alignment.

In one approach, the “percentage of sequence identity” is determined by comparing two optimally aligned sequences over a window of comparison of at least 20 positions, wherein the portion of the polypeptide or polynucleotide sequence in the comparison window may comprise additions or deletions (i.e., gaps) of 20 percent or less, usually 5 to 15 percent, or 10 to 12 percent, as compared to the reference sequences (which does not comprise additions or deletions) for optimal alignment of the two sequences. The percentage is calculated by determining the number of positions at which the identical amino acid or nucleic acid residue occurs in both sequences to yield the number of matched positions, dividing the number of matched positions by the total number of positions in the reference sequence (i.e., the window size) and multiplying the results by 100 to yield the percentage of sequence identity.

(3) Antibodies and Antibody Panels

In some embodiments, a panel can comprise one or more antibodies (e.g., isolated antibodies) or antigen binding fragments thereof, e.g., that bind specifically to one or more of the breast cancer associated polypeptides disclosed herein (e.g., one or more of the polypeptides encoded by the nucleic acid sequences disclosed in Tables 2 and 3 and/or SEQ ID NOs: 1-3005, and/or one or more of SEQ ID NOs:3006-5970).

An antibody or antigen-binding fragment thereof specifically binds to a polypeptide (e.g., a polypeptide disclosed herein) if it reacts or interacts at a detectable level (e.g., detectable via any art recognized method (e.g., an enzyme-linked immunosorbent assay (ELISA)) with the polypeptide but does not react with a biologically unrelated polypeptide in any statistically significant fashion under the same or similar conditions. Specific binding, as used in this context, generally refers to the non-covalent interactions of the type that occur between an immunoglobulin molecule and an antigen for which the immunoglobulin is specific. The strength or affinity of immunological binding interactions can be expressed in terms of the dissociation constant (Kd) of the interaction, wherein a smaller Kd represents a greater affinity. Immunological binding properties of selected polypeptides can be quantified using methods well known in the art, see, e.g., Davies et al., Annual Rev. Biochem. 59:439-73 (1990).

Fragments of antibodies may be used and are included within the present invention. An “antigen-binding site” or “binding portion” or “antigen binding fragment” of an antibody refers to the part of the immunoglobulin molecule that participates in antigen binding. Such regions are known in the art and can include, for example, a fragment antigen binding (Fab) region or the paratope thereof, single chain Fv fragments, and one or more complementarity determining regions (CRRs (e.g., one or more of CDR1, CDR2, and/or CDR3) of an antibody that binds specifically to one or more of the polypeptides disclosed herein,

In some embodiments, antibodies or other binding agents that bind to a cancer-associated marker described herein will generate a signal indicating the presence of a cancer in at least about 20%, 30% or 50% of samples and/or patients with the disease. As noted elsewhere herein, the signal indicating the presence of a cancer may be lower or higher than a predetermined cutoff value (as determined using appropriate controls), depending on the breast cancer marker as some breast cancer genes are overexpressed in breast cancer samples as compared to controls while others are underexpressed as compared to controls.

Antibodies and antigen binding fragments can be prepared by any of a variety of techniques known to those of ordinary skill in the art (see, e.g., Harlow et al., Antibodies: A Laboratory Manual (1988); Ausubel et al., Current Protocols in Molecular Biology (2001 and later updates thereto)). Monoclonal antibodies specific for a polypeptide of interest may be prepared, for example, using the technique of Kohler et al., Eur. J. Immunol. 6:511-19 (1976). Humanized antibodies can also be prepared using art known methods, see, e.g., Winter et al., Nature 349:293-99 (1991); Lobuglio et al., Proc. Nat. Acad. Sci. USA 86:4220-24 (1989); Shaw et al., J. Immunol. 138:4534-38 (1987); and Brown et al., Cancer Res. 47:3577-83 (1987)), Riechmann et al., Nature 332:323-27 (1988); Verhoeyen et al., Science 239:1534-36 (1988); Jones et al., Nature 321:522-25 (1986), and European Patent No. 0 519 596).

Methods for producing antibodies can include the use of polypeptides (e.g., breast cancer marker polypeptide), produced by either recombinant or synthetic approaches, as immunogens, see, e.g., Sambrook et al., Molecular Cloning, A Laboratory Manual (1989); and, Current Protocols in Molecular Biology (Ausubel et al., eds., 2001 and later updates thereto) and Caruthers et al., Nucl. Acids Res. Symp. Ser. 215-223 (1980); Horn et al., Nucl. Acids Res. Symp. Ser. 225-232 (1980); Roberge et al., Science 269:202-04 (1995). In some instances, newly synthesized polypeptides (e.g., breast cancer marker polypeptide) can be purified (e.g., substantially purified), e.g., by preparative HPLC (e.g., Creighton, T., Proteins, Structures and Molecular Principles (1983)) or other comparable techniques available in the art, e.g., prior to raising an antibody against it. The composition of the synthetic peptides can also be confirmed by amino acid analysis or sequencing (e.g., the Edman degradation procedure). Additionally, the amino acid sequence of a polypeptide, or any part thereof, may be altered during direct synthesis and/or combined using chemical methods with sequences from other proteins, or any part thereof, to produce a variant polypeptide. Such peptides can then be used to generate and antibody or antigen binding fragment that binds specifically to the polypeptide.

Skilled practitioners will appreciate that any antibody format may be useful in the invention. For example, a number of “humanized” antibody molecules comprising an antigen-binding site derived from a non-human immunoglobulin have been described, including chimeric antibodies having rodent V regions and their associated CDRs fused to human constant domains (Winter et al., Nature 349:293-99 (1991); Lobuglio et al., Proc. Nat. Acad. Sci. USA 86:4220-24 (1989); Shaw et al., J Immunol. 138:4534-38 (1987); and Brown et al., Cancer Res. 47:3577-83 (1987)), rodent CDRs grafted into a human supporting FR prior to fusion with an appropriate human antibody constant domain (Riechmann et al., Nature 332:323-27 (1988); Verhoeyen et al., Science 239:1534-36 (1988); and Jones et al., Nature 321:522-25 (1986)), and rodent CDRs supported by recombinantly veneered rodent FRs (European Patent No. 0 519 596). These “humanized” molecules are designed to minimize unwanted immunological response toward rodent anti-human antibody molecules and are useful in the present invention.

In some instances, pluralities of binding agents, and panels including same, can include any combination of polynucleotides, polypeptides, antibodies, and/or other binding agents disclosed herein.

### (B) Methods of Use

The present disclosure provides methods for detecting breast cancer (e.g., the presence of one or more breast cancer cells) in a subject. For example, the present disclosure provides methods for detecting an increased risk for developing breast cancer in a subject (e.g., wherein the subject does not have breast cancer but has increased odds for developing breast cancer due, e.g., to environmental, physiological, and/or pharmacological factors known to be associated with the development of breast cancer and/or due to genetics). Also provided are methods of monitoring progression of, or monitoring therapeutic regimens for the treatment of, breast cancer.

In some embodiments, the methods provided herein include (1) contacting a biological sample (e.g., a biological sample obtained from a subject in need of testing for breast cancer) with one or more panels provided herein; (2) detecting (e.g., detecting and evaluating) the level of one or more of the breast cancer markers detected by the panel; and (3) comparing the level of the breast cancer marker to the level of the same breast cancer marker measured at the same time or previously (e.g., a previously recorded level) in a sample obtained from a subject that does not have breast cancer (e.g., a control).

In other embodiments, the presence or absence of a cancer in a patient may be determined by (a) contacting a biological sample, e.g., obtained from a patient, with one or more (e.g., a plurality of) binding agents (e.g., binding agents that are polynucleotides, polypeptides, or antibodies) specific for one or more of the breast cancer markers selected from the group consisting of the markers provided in the Tables herein (e.g., Table 2) and set forth in SEQ ID NOs:1-5970; (b) detecting in the sample a level of breast cancer biomarker polynucleotide or polypeptide that binds to each binding agent (generally via the amount of binding agent that binds to the breast cancer marker present in the sample); and, (c) comparing the level of polynucleotide or polypeptide with a predetermined cut-off value, wherein a level of polynucleotide or polypeptide present in a biological sample that is above or below the predetermined cut-off value (depending on the particular marker) for one or more marker is indicative of the presence of cancer cells in the biological sample.

In some embodiments, multiple breast cancer sequences described herein can be used in combination in a “complementary” fashion. For example, two or more of the breast cancer markers disclosed herein (e.g., two or more of the breast cancer markers set forth Tables 2 and 3 and/or one of SEQ ID NOs: 1-5970) can be detected and their levels evaluated (e.g., compared to a control), e.g., simultaneously.

The present disclosure provides a variety of methods for the detection of the breast cancer markers disclosed herein. Furthermore, the breast cancer sequences of the invention may be used in the detection of essentially any breast cancer type where differential expression of one or more of the breast cancer markers disclosed herein are observed or suspected.

The present invention also provides, within other aspects, methods for monitoring the progression of breast cancer in a patient. Such methods comprise detecting the level of expression of any one or more of the breast cancer markers provided herein in a biological sample obtained from a patient at a first point in time; and then detecting the level of expression of any one or more of the breast cancer markers provided herein using a biological sample obtained from the patient at a subsequent point in time; and comparing the level of expression from the two time points and therefrom monitoring the progression of the cancer in the patient. Similar methods can be used to monitor progression of cancer in response to a variety of treatments. Any of a variety of methods for detecting the level of expression of any one or more of the breast cancer markers described herein can be used, such as described further herein and known in the art.

In an exemplary embodiment, the methods can include the use of one or more binding agents (e.g., one or more polynucleotides, one or more polypeptides, and/or one or more antibodies) immobilized on a solid support to bind to and remove a polynucleotide and/or a polypeptide from a sample. The bound polynucleotide and/or polypeptide may then be detected using a detection reagent that contains a reporter group and specifically binds to the binding agent/polypeptide complex. Exemplary methods for the detection of polynucleotides and polypeptides are provided below. In the case of the polypeptide, such reagents may comprise, for example, a binding agent that specifically binds to the polypeptide or an antibody or other agent that specifically binds to the binding agent, such as an anti-immunoglobulin, protein G, protein A or a lectin. Alternatively, a competitive assay may be utilized in which a polypeptide is labeled with a reporter group and allowed to bind to the immobilized binding agent after incubation of the binding agent with the sample. The extent to which components of the sample inhibit the binding of the labeled polypeptide to the binding agent is indicative of the reactivity of the sample with the immobilized binding agent. Suitable polypeptides for use within such assays include full length proteins and polypeptide portions thereof to which the binding agent binds.

As noted above, in some embodiments, multiple breast cancer sequences described herein can be used in combination in a “complementary” fashion to detect breast cancer. Thus, in certain embodiments, any combination of one or more of the breast cancer markers as described herein can be used in any of a variety of diagnostic assays as described herein to detect breast cancer. Thus, in one embodiment 2, 3, 4, 5, 6, 7, 8, 9, 10, 11, 12, 13, 14, 15, 16, 17, 18, 19, or 20 of the cancer-associated markers described herein can be detected simultaneously using the panels and methods to detect breast cancer. In a further embodiment 21, 22, 23, 24, 25, 26, 27, 28, 29, 30, 31, 32, 33, 34, 35, 36, 37, 38, 39, or 40 of the cancer-associated markers described herein can be detected simultaneously using the panels and methods to detect breast cancer. In a further embodiment 45, 50, 55, 60, 65, 70, 75, 80, 85, 90, 95, 100 or more of the cancer-associated markers described herein can be detected simultaneously using the panels and methods to detect breast cancer. In certain embodiments all of the cancer-associated markers described herein can be detected simultaneously using the panels and methods to detect breast cancer. Using such an approach, the breast cancer markers described herein can be detected in combination with any known cancer markers in a complementary fashion to detect breast cancer. In certain embodiments, use of multiple markers may increase the sensitivity and/or specificity of cancers detected. Illustrative cancer markers that can be used in combination with the cancer markers disclosed herein include, but are not limited to Her2/Neu, BRCA1, BRCA2, MUC1, and mammaglobin.

Other methods of using the present compositions and panels includes the use for evaluation of test compounds in a biological system to monitor changes in the system. As one of skill in the art could readily appreciate, when observing a breast cancer related expression profile, a test compound that changes the profile to be more similar to a normal profile is of significant interest as a drug lead. Accordingly, the present invention also provides a method for optimizing drug/test compound leads by treating an animal, cell, or tissue with a compound and observing whether the breast cancer marker expression profile changes to deviate from the diseased profile toward a more normal profile.

(1) Subjects and Samples

Methods of detecting breast cancer in a subject can include obtaining a biological sample from the subject. Examples of subjects include humans and non-humans, e.g., monkeys, apes, dogs, cats, mice, rats, fish, zebra fish, birds, horses, pigs, cows, sheep, goats, chickens, ducks, donkeys, turkeys, peacocks, chinchillas, ferrets, gerbils, rabbits, guinea pigs, hamsters and transgenic species thereof. Further subjects contemplated herein include, but are not limited to, reptiles and amphibians, e.g., lizards, snakes, turtles, frogs, toads, salamanders, and newts and transgenic species thereof.

A biological sample can be obtained from a subject immediately prior (e.g., within 12 hours) to testing or optionally stored (e.g., frozen). Essentially any biological sample suspected of containing breast cancer markers, antibodies to such cancer-associated markers and/or cancer cells expressing such markers or antibodies may be used in the methods. For example, the biological sample can be a tissue sample, such as a tissue biopsy sample, known or suspected of containing cancer cells. The biological sample may be derived from a tissue suspected of being the site of origin of a primary tumor. Alternatively, the biological sample may be derived from a tissue or other biological sample distinct from the suspected site of origin of a primary tumor in order to detect the presence of metastatic cancer cells in the tissue or sample that have escaped the site of origin of the primary tumor. In certain embodiments, the biological sample is a tissue biopsy sample derived from breast tissue. In other embodiments, the biological sample tested is selected from the group consisting of a peripheral blood sample, biopsy sample, lavage sample, sputum sample, serum sample, lymph node sample, bone marrow sample, urine sample, and pleural effusion sample.

(2) Use of Nucleic Acid Panels

The present disclosure provides methods for detecting breast cancer using nucleic acid panels. For example, a biological sample can be contacted with a panel comprising one or more polynucleotide binding agents disclosed herein. The levels of one or more of the breast cancer markers detected can then be evaluated according to the methods disclosed below, e.g., with or without the use of nucleic acid amplification methods.

Skilled practitioners will appreciate that in the methods described herein, a measurement of gene expression can be automated, e.g., using a device or system capable of doing so. For example, a system that can carry out multiplexed measurement of gene expression can be used, e.g., providing digital readouts of the relative abundance of hundreds of mRNA species simultaneously.

(i) Amplification Methods

In some embodiments, nucleic acid amplification methods can be used to detect a breast cancer marker, e.g., wherein the breast cancer marker is a polynucleotide. For example, the oligonucleotide primers and probes of the present invention may be used in amplification and detection methods that use nucleic acid substrates isolated by any of a variety of well-known and established methodologies (e.g., Sambrook et al., Molecular Cloning, A laboratory Manual, pp. 7.37-7.57 (2nd ed., 1989); Lin et al., in Diagnostic Molecular Microbiology, Principles and Applications, pp. 605-16 (Persing et al., eds. (1993); Ausubel et al., Current Protocols in Molecular Biology (2001 and later updates thereto)). In one illustrative example, the target mRNA may be prepared by the following procedure to yield mRNA suitable for use in amplification. Briefly, cells in a biological sample (e.g., peripheral blood or bone marrow cells) are lysed by contacting the cell suspension with a lysing solution containing at least about 150 mM of a soluble salt, such as lithium halide, a chelating agent and a non-ionic detergent in an effective amount to lyse the cellular cytoplasmic membrane without causing substantial release of nuclear DNA or RNA. The cell suspension and lysing solution are mixed at a ratio of about 1:1 to 1:3. The detergent concentration in the lysing solution is between about 0.5-1.5% (v/v). Any of a variety of known non-ionic detergents are effective in the lysing solution (e.g., TRITON™-type, TWEEN™-type and NP-type); typically, the lysing solution contains an octylphenoxy polyethoxyethanol detergent, preferably 1% TRITON™ X-102. This procedure may work advantageously with biological samples that contain cell suspensions (e.g., blood and bone marrow), but it works equally well on other tissues if the cells are separated using standard mincing, screening and/or proteolysis methods to separate cells individually or into small clumps. After cell lysis, the released total RNA is stable and may be stored at room temperature for at least 2 hours without significant RNA degradation without additional RNase inhibitors. Total RNA may be used in amplification without further purification or mRNA may be isolated using standard methods generally dependent on affinity binding to the poly-A portion of mRNA.

mRNA isolation can employ capture particles consisting essentially of poly-dT oligonucleotides attached to insoluble particles. The capture particles are added to the above-described lysis mixture, the poly-dT moieties annealed to the poly-A mRNA, and the particles separated physically from the mixture. Generally, superparamagnetic particles may be used and separated by applying a magnetic field to the outside of the container. Preferably, a suspension of about 300 μg of particles (in a standard phosphate buffered saline (PBS), pH 7.4, of 140 mM NaCl) having either dT14 or dT30 linked at a density of about 1 to 100 pmoles per mg (preferably 10-100 pmols/mg, more preferably 10-50 pmols/mg) are added to about 1 mL of lysis mixture. Any superparamagnetic particles may be used, although typically the particles are a magnetite core coated with latex or silica (e.g., commercially available from Serodyn or Dynal) to which poly-dT oligonucleotides are attached using standard procedures (Lund et al., Nucl. Acids Res. 16:10861-80 (1988)). The lysis mixture containing the particles is gently mixed and incubated at about 22-42° C. for about 30 minutes, when a magnetic field is applied to the outside of the tube to separate the particles with attached mRNA from the mixture and the supernatant is removed. The particles are washed one or more times, generally three, using standard resuspension methods and magnetic separation as described above. Then, the particles are suspended in a buffer solution and can be used immediately in amplification or stored frozen.

A number of parameters may be varied without substantially affecting the sample preparation. For example, the number of particle washing steps may be varied or the particles may be separated from the supernatant by other means (e.g., filtration, precipitation, centrifugation). The solid support may have nucleic acid capture probes affixed thereto that are complementary to the specific target sequence or any particle or solid support that non-specifically binds the target nucleic acid may be used (e.g., polycationic supports as described, for example, in U.S. Pat. No. 5,599,667). For amplification, the isolated RNA is released from the capture particles using a standard low salt elution process or amplified while retained on the particles by using primers that bind to regions of the RNA not involved in base pairing with the poly-dT or in other interactions with the solid-phase matrix. The exact volumes and proportions described above are not critical and may be varied so long as significant release of nuclear material does not occur. Vortex mixing is preferred for small-scale preparations but other mixing procedures may be substituted. It is important, however, that samples derived from biological tissue be treated to prevent coagulation and that the ionic strength of the lysing solution be at least about 150 mM, preferably 150 mM to 1 M, because lower ionic strengths lead to nuclear material contamination (e.g., DNA) that increases viscosity and may interfere with amplification and/or detection steps to produce false positives. Lithium salts are preferred in the lysing solution to prevent RNA degradation, although other soluble salts (e.g., NaCl) combined with one or more known RNase inhibitors would be equally effective.

By “nucleic acid amplification conditions” is meant environmental conditions, including salt concentration, temperature, the presence or absence of temperature cycling, the presence of a nucleic acid polymerase, nucleoside triphosphates, and cofactors, that are sufficient to permit the production of multiple copies of a target nucleic acid or its complementary strand using a nucleic acid amplification method.

By “amplification” or “nucleic acid amplification” is meant production of multiple copies of a target nucleic acid that contains at least a portion of the intended specific target nucleic acid sequence (e.g., those provided in SEQ ID NOs:1-3005). The multiple copies may be referred to as amplicons or amplification products. In certain embodiments, the amplified target contains less than the complete target gene sequence (introns and exons) or an expressed target gene sequence (spliced transcript of exons and flanking untranslated sequences). For example, specific amplicons may be produced by amplifying a portion of the target polynucleotide by using amplification primers that hybridize to, and initiate polymerization from, internal positions of the target polynucleotide. The amplified portion may contain a detectable target sequence that may be detected using any of a variety of well-known methods. Detection may take place during amplification of a target sequence.

As discussed above, the present invention also provides oligonucleotide primers. Skilled practitioners will appreciate that appropriate primers can be designed using the sequences provided herein. In most cases, a primer will have a free 3′ end that can be extended by a nucleic acid polymerase. In certain embodiments, the 3′ end of a promoter-primer, or a subpopulation of such promoter-primers, may be modified to block or reduce primer extension. All amplification primers include a base sequence capable of hybridizing via complementary base interactions to at least one strand of the target nucleic acid or a strand that is complementary to the target sequence. For example, in PCR, amplification primers anneal to opposite strands of a double-stranded target DNA that has been denatured. The primers are extended by a thermostable DNA polymerase to produce double-stranded DNA products, which are then denatured with heat, cooled and annealed to amplification primers. Multiple cycles of the foregoing steps (e.g., about 20 to about 50 thermic cycles) exponentially amplifies the double-stranded target DNA.

A “target-binding sequence” of an amplification primer is the portion that determines target specificity because that portion is capable of annealing to the target nucleic acid strand or its complementary strand but does not detectably anneal to non-target nucleic acid strands under the same conditions. The complementary target sequence to which the target-binding sequence hybridizes is referred to as a primer-binding sequence. For primers or amplification methods that do not require additional functional sequences in the primer (e.g., PCR amplification), the primer sequence consists essentially of a target-binding sequence, whereas other methods (e.g., TMA or SDA) include additional specialized sequences adjacent to the target-binding sequence (e.g., an RNA polymerase promoter sequence adjacent to a target-binding sequence in a promoter-primer or a restriction endonuclease recognition sequence for an SDA primer). It will be appreciated by those skilled in the art that all of the primer and probe sequences of the present invention may be synthesized using standard in vitro synthetic methods. Also, it will be appreciated that those skilled in the art could modify primer sequences disclosed herein using routine methods to add additional specialized sequences (e.g., promoter or restriction endonuclease recognition sequences, linker sequences, and the like) to make primers suitable for use in a variety of amplification methods. Similarly, promoter-primer sequences described herein can be modified by removing the promoter sequences to produce amplification primers that are essentially target-binding sequences suitable for amplification procedures that do not use these additional functional sequences.

By “target sequence” is meant the nucleotide base sequence of a nucleic acid strand, at least a portion of which is capable of being detected using primers and/or probes in the methods as described herein, such as a labeled oligonucleotide probe. Primers and probes bind to a portion of a target sequence, which includes either complementary strand when the target sequence is a double-stranded nucleic acid.

By “equivalent RNA” is meant a ribonucleic acid (RNA) having the same nucleotide base sequence as a deoxyribonucleic acid (DNA) with the appropriate U for T substitution(s). Similarly, an “equivalent DNA” is a DNA having the same nucleotide base sequence as an RNA with the appropriate T for U substitution(s). It will be appreciated by those skilled in the art that the terms “nucleic acid” and “oligonucleotide” refer to molecular structures having either a DNA or RNA base sequence or a synthetic combination of DNA and RNA base sequences, including analogs thereof, which include “abasic” residues.

The term “specific for” in the context of oligonucleotide primers and probes, is a term of art well understood by the skilled artisan to refer to a particular primer or probe capable of annealing/hybridizing/binding to a target nucleic acid or its complement but which primer or probe does not anneal/hybridize/bind to non-target nucleic acid sequences under the same conditions in a statistically significant or detectable manner. Thus, for example, in the setting of an amplification technique, a primer, primer set (e.g., a primer pair), or probe that is specific for a target nucleic acid of interest would amplify the target nucleic acid of interest but would not detectably amplify sequences that are not of interest. Note that a primer pair generally for the purposes of amplification comprises a first primer and a second primer wherein the first and second primers specifically hybridize to opposite strands (e.g., sense/antisense, polynucleotide/complement thereof) of a target polynucleotide. Note that in certain embodiments, a primer or probe can be “specific for” a group of related sequences in that the primer or probe will anneal/hybridize/bind to several related sequences under the same conditions but will not anneal/hybridize/bind to non-target nucleic acid sequences that are not related to the sequences of interest. In this regard, the primer or probe is usually designed to anneal/hybridize/bind to a region of the nucleic acid sequence that is conserved among the related sequences but differs from other sequences not of interest. As would be recognized by the skilled artisan, primers and probes that are specific for a particular target nucleic acid sequence or sequences of interest can be designed using any of a variety of computer programs available in the art (see, e.g., Methods Mol Biol. 192:19-29 (2002)) or can be designed by eye by comparing the nucleic acid sequence of interest to other relevant known sequences, e.g., those described herein. In certain embodiments, the conditions under which a primer or probe is specific for a target nucleic acid of interest can be routinely optimized by changing parameters of the reaction conditions. For example, in PCR, a variety of parameters can be changed, such as annealing or extension temperature, concentration of primer and/or probe, magnesium concentration, the use of “hot start” conditions such as wax beads or specifically modified polymerase enzymes, addition of formamide, DMSO or other similar compounds. In other hybridization methods, conditions can similarly be routinely optimized by the skilled artisan using techniques known in the art.

Methods for amplifying nucleic acids include, but are not limited to, for example the polymerase chain reaction (PCR) and reverse transcription PCR (RT-PCR) (see e.g., U.S. Pat. Nos. 4,683,195; 4,683,202; 4,800,159; 4,965,188), ligase chain reaction (LCR) (see, e.g., Weiss, Science 254:1292-93 (1991)), strand displacement amplification (SDA) (see e.g., Walker et al., Proc. Natl. Acad. Sci. USA 89:392-396 (1992); U.S. Pat. Nos. 5,270,184 and 5,455,166), Thermophilic SDA (tSDA) (see e.g., European Pat. No. 0 684 315) and methods described in U.S. Pat. No. 5,130,238; Lizardi et al., BioTechnol. 6:1197-1202 (1988); Kwoh et al., Proc. Natl. Acad. Sci. USA 86:1173-77 (1989); Guatelli et al., Proc. Natl. Acad. Sci. USA 87:1874-78 (1990); U.S. Pat. Nos. 5,480,784; 5,399,491; US Publication No. 2006/46265.

In some embodiments, the methods include the use of TMA, which employs an RNA polymerase to produce multiple RNA transcripts of a target region (see, e.g., U.S. Pat. Nos. 5,480,784; 5,399,491 and US Publication No. 2006/46265).

The one or more polynucleotide breast cancer markers detected by the methods described above can then be observed (e.g., qualitatively, semi-quantitatively, or quantitatively), and optionally compared to a control or reference value, using methods that are known in the art (e.g., electrophoresis and/or RT-PCR).

By “detecting” an amplification product is meant any of a variety of methods for determining the presence of an amplified nucleic acid, such as, for example, hybridizing a labeled probe to a portion of the amplified product. A labeled probe is an oligonucleotide that specifically binds to another sequence and contains a detectable group that may be, for example, a fluorescent moiety, chemiluminescent moiety, radioisotope, biotin, avidin, enzyme, enzyme substrate, or other reactive group. In certain embodiments, a labeled probe includes an acridinium ester (AE) moiety that can be detected chemiluminescently under appropriate conditions (as described, e.g., in U.S. Pat. No. 5,283,174). Other well-known detection techniques include, for example, gel filtration, gel electrophoresis and visualization of the amplicons, and High Performance Liquid Chromatography (HPLC). In certain embodiments, for example using real-time TMA or real-time PCR, the level of amplified product is detected as the product accumulates. The detecting step may either be qualitative and/or quantitative, although in some embodiments quantitative detection of amplicons may be preferred, as the level of gene expression may be indicative of the degree of metastasis, recurrence of cancer and/or responsiveness to therapy.

In certain embodiments, the methods of the invention detect the expression of mRNA of any one or more of the breast cancer markers in biological samples. Expression of the breast cancer sequences of the invention may be detected at the mRNA level using methodologies well-known and established in the art, including, for example, in situ and in vitro hybridization, and/or any of a variety of nucleic acid amplification methods, as further described herein.

In some embodiments, methods for detecting (e.g., and optionally purifying) a target breast cancer marker polynucleotide can include capturing a target polynucleotide on a solid support. The solid support retains the target polynucleotide during one or more washing steps of a target polynucleotide purification procedure. One technique involves capture of the target polynucleotide by a polynucleotide fixed to a solid support and hybridization of a detection probe to the captured target polynucleotide (e.g., U.S. Pat. No. 4,486,539). Detection probes not hybridized to the target polynucleotide are readily washed away from the solid support. Thus, remaining label is associated with the target polynucleotide initially present in the sample. Another technique uses a mediator polynucleotide that hybridizes to both a target polynucleotide and a polynucleotide fixed to a solid support such that the mediator polynucleotide joins the target polynucleotide to the solid support to produce a bound target (e.g., U.S. Pat. No. 4,751,177). A labeled probe can be hybridized to the bound target and unbound labeled probe can be washed away from the solid support.

(3) Use of Polypeptide and Antibody Panels

The present disclosure provides methods for detecting breast cancer using polypeptide panels and antibody panels. For example, a biological sample can be contacted with a panel comprising one or more polypeptide binding agents disclosed herein. In some embodiments, the polypeptide binding agents can be used to detect polypeptide breast cancer markers in the biological sample. Alternatively or in addition, the polypeptide binding agents can be used to detect antibodies directed against breast cancer markers in the biological sample. The detection of such antibodies specific for breast cancer polypeptides may be indicative of the presence of cancer in the patient from which the biological sample was derived. In other embodiments, a biological sample can be contacted with a panel comprising one or more antibody binding agents disclosed herein.

In one illustrative example, a biological sample is contacted with a solid phase to which one or more breast cancer polypeptides, such as recombinant or synthetic polypeptides comprising an amino acid sequence provided in any one of SEQ ID NOs:3006-5970, or portions thereof, have been attached. In another embodiment, the cancer-associated polypeptides used in this aspect of the invention comprise two or more polypeptides, or portions thereof, selected from the group consisting of SEQ ID NOs:3006-5970 or polypeptides encoded by the polynucleotides set forth in SEQ ID NOs:1-3005. In one illustrative embodiment, the biological sample tested according to this aspect of the invention is a peripheral blood sample. A biological sample is generally contacted with the polypeptides for a time and under conditions sufficient to form detectable antigen/antibody complexes. Indicator reagents may be used to facilitate detection, depending upon the assay system chosen. In another embodiment, a biological sample is contacted with a solid phase to which a recombinant or synthetic polypeptide is attached and is also contacted with a monoclonal or polyclonal antibody specific for the polypeptide, which preferably has been labeled with an indicator reagent. After incubation for a time and under conditions sufficient for antibody/antigen complexes to form, the solid phase is separated from the free phase and the label is detected in either the solid or free phase as an indication of the presence of antibodies. Other assay formats utilizing recombinant and/or synthetic polypeptides for the detection of antibodies are available in the art and may be employed in the practice of the present invention.

The levels of one or more of the breast cancer markers detected can then be evaluated according to the methods disclosed below. For example, binding agents bound to breast cancer marker polypeptides and/or antibodies directed against breast cancer markers can be detected via detection reagent that may comprise a detectable reporter group. A variety of protocols for detecting and/or measuring the level of expression of polypeptides, using either polyclonal or monoclonal antibodies specific for the product, are known in the art. Examples include, but are not limited to, enzyme-linked immunosorbent assay (ELISA), immunohistochemistry (IHC), radioimmunoassay (RIA), fluorescence activated cell sorting (FACS), immunocytochemistry, flow cytometry and/or other known immunoassays and the like. A two-site, monoclonal-based immunoassay utilizing monoclonal antibodies reactive to two non-interfering epitopes on a given polypeptide may be preferred for some applications, but a competitive binding assay may also be employed. These and other assays are described, among other places, in Hampton et al., Serological Methods, a Laboratory Manual (1990); Maddox et al., J. Exp. Med. 158:1211-16 (1983); Harlow et al., Antibodies: A Laboratory Manual (1988); and Ausubel et al., Current Protocols in Molecular Biology (2001 and later updates thereto).

(i) Sandwich Assay

In certain embodiments, detecting breast cancer using a panel involves a two-antibody sandwich assay. This assay may be performed by first contacting an antibody that has been immobilized on a solid support, commonly the well of a microtiter plate, with the sample, such that polypeptides within the sample are allowed to bind to the immobilized antibody. Unbound sample is then removed from the immobilized polypeptide-antibody complexes and a detection reagent (preferably a second antibody capable of binding to a different site on the polypeptide) containing a reporter group is added. The amount of detection reagent that remains bound to the solid support is then determined using a method appropriate for the specific reporter group.

More specifically, once the antibody is immobilized on the support as described above, the remaining protein binding sites on the support are typically blocked. Any suitable blocking agent known to those of ordinary skill in the art, such as bovine serum albumin or Tween 20™ (Sigma Chemical Co., St. Louis, Mo.). The immobilized antibody is then incubated with the sample and polypeptide is allowed to bind to the antibody. The sample may be diluted with a suitable diluent, such as phosphate-buffered saline (PBS), prior to incubation. In general, an appropriate contact time (i.e., incubation time) is a period of time that is sufficient to detect the presence of polypeptide within a sample obtained from an individual with cancer. Those of ordinary skill in the art will recognize that the time necessary to achieve equilibrium may be readily determined by assaying the level of binding that occurs over a period of time. At room temperature, an incubation time of about 30 minutes is generally sufficient.

Unbound sample may then be removed by washing the solid support with an appropriate buffer, such as PBS containing 0.1% Tween 20™. The second antibody, which contains a reporter group, may then be added to the solid support. Preferred reporter groups include those groups recited above as well as other known in the art.

The detection reagent is then incubated with the immobilized antibody-polypeptide complex for an amount of time sufficient to detect the bound polypeptide. An appropriate amount of time may generally be determined by assaying the level of binding that occurs over a period of time. Unbound detection reagent is then removed and bound detection reagent is detected using the reporter group. The method employed for detecting the reporter group depends upon the nature of the reporter group. For radioactive groups, scintillation counting or autoradiographic methods are generally appropriate. Spectroscopic methods may be used to detect dyes, luminescent groups and fluorescent groups. Biotin may be detected using avidin, coupled to a different reporter group (commonly a radioactive or fluorescent group or an enzyme). Enzyme reporter groups may generally be detected by the addition of substrate (generally for a specific period of time), followed by spectroscopic or other analysis of the reaction products.

To determine the presence or absence of a breast cancer, the signal detected from the reporter group that remains bound to the solid support is generally compared to a signal that corresponds to a predetermined cut-off value. In one embodiment, the cut-off value for the detection of a cancer is the average mean signal obtained when the immobilized antibody is incubated with samples from patients without the cancer. In another embodiment, a sample generating a signal that is three standard deviations above the predetermined cut-off value is considered positive for the cancer. In another embodiment, the cut-off value is determined using a Receiver Operator Curve, according to the method of Sackett et al., Clinical Epidemiology: A Basic Science for Clinical Medicine, pp. 106 07 (1985). Briefly, in this embodiment, the cut-off value may be determined from a plot of pairs of true positive rates (i.e., sensitivity) and false positive rates (100%-specificity) that correspond to each possible cut-off value for the diagnostic test result. The cut-off value on the plot that is the closest to the upper left-hand corner (i.e., the value that encloses the largest area) is the most accurate cut-off value, and a sample generating a signal that is higher than the cut-off value determined by this method may be considered positive. Alternatively, the cut-off value may be shifted to the left along the plot, to minimize the false positive rate, or to the right, to minimize the false negative rate.

(ii) Flow Through Assay

In some embodiments, detecting breast cancer using a panel involves a flow-through or strip test format, wherein the binding agent is immobilized on a membrane, such as nitrocellulose. In the flow-through test, polypeptides within the sample bind to the immobilized binding agent as the sample passes through the membrane. A second, labeled binding agent then binds to the binding agent-polypeptide complex as a solution containing the second binding agent flows through the membrane. The detection of bound second binding agent may then be performed as described above. In the strip test format, one end of the membrane to which binding agent is bound is immersed in a solution containing the sample. The sample migrates along the membrane through a region containing second binding agent and to the area of immobilized binding agent. Concentration of second binding agent at the area of immobilized antibody indicates the presence of a cancer. Typically, the concentration of second binding agent at that site generates a pattern, such as a line, that can be read visually. The absence of such a pattern indicates a negative result. In general, the amount of binding agent immobilized on the membrane is selected to generate a visually discernible pattern when the biological sample contains a level of polypeptide that would be sufficient to generate a positive signal in the two-antibody sandwich assay, in the format discussed above. Preferred binding agents for use in such assays are antibodies and antigen-binding fragments thereof. In certain embodiments, the amount of antibody immobilized on the membrane ranges from about 25 ng to about 1 μg, and in other embodiments is from about 50 ng to about 500 ng. Such tests can typically be performed with a very small amount of biological sample.

Any of the methods described herein can be performed, e.g., in a high-throughput format.

(4) Assay Interpretation

The methods provided herein can include comparing the level of one or more breast cancer makers detected in a biological sample to a reference value or control sample that represents the level of the same breast cancer marker in a subject or sample that does not have breast cancer. Accordingly, methods are provided for detecting the presence of cancer cells in a biological sample comprising the steps of: detecting the level of expression in the biological sample of at least one breast cancer marker, wherein the cancer-associated marker comprises a polynucleotide set forth in any one of SEQ ID NOs: 1-3005; or a polypeptide set forth in any one of SEQ ID NOs: 3006-5970 and comparing the level of expression detected in the biological sample for the breast cancer marker to a predetermined cut-off value for the breast cancer marker; wherein a detected level of expression above or below (depending on the marker) the predetermined cut-off value for the breast cancer marker is indicative of the presence of cancer cells in the individual from which the biological sample was derived.

A predetermined cut-off value used in the methods described herein for determining the presence or absence of cancer can be readily identified using well-known techniques. For example, in one illustrative embodiment, the predetermined cut-off value for the detection of cancer is the average mean signal obtained when the relevant method of the invention is performed on suitable negative control samples, e.g., samples from patients without cancer. In another illustrative embodiment, a sample generating a signal that is at least two or three standard deviations above or below the predetermined cut-off value is considered positive.

In another embodiment, the cut-off value is determined using a Receiver Operator Curve, according to the method of Sackett et al., Clinical Epidemiology: A Basic Science for Clinical Medicine, pp. 106 07 (1985). Briefly, in this embodiment, the cut-off value may be determined from a plot of pairs of true positive rates (i.e., sensitivity) and false positive rates (100%-specificity) that correspond to each possible cut-off value for the diagnostic test result. The cut-off value on the plot that is the closest to the upper left-hand corner (i.e., the value that encloses the largest area) is the most accurate cut-off value, and a sample generating a signal that is higher or lower than the cut-off value determined by this method may be considered positive. Alternatively, the cut-off value may be shifted to the left along the plot, to minimize the false positive rate, or to the right, to minimize the false negative rate. In general, a sample generating a signal that is higher or lower than the cut-off value determined by this method is considered positive for a cancer.

In some embodiments, some genes are overexpressed in cancer as compared to normals and some genes are underexpressed in cancer as compared to normals (see for example Table 2, LogFC where some identified breast cancer markers showed an increase in expression (positive values) while some breast cancer markers showed a decrease in expression (negative values) as compared to normal samples. Thus, those markers in Table 2 with negative LogFC numbers are positive for cancer below their corresponding Threshold number while those markers in Table 2 with positive LogFC numbers are positive for cancer above their corresponding Threshold number). Thus, whether a sample is positive for cancer by being either above or below the cut-off (threshold) value depends on whether the fold change in expression in cancer versus normal is positive or negative.

It should be noted that in certain embodiments, the breast cancer markers of the present invention may be expressed in normal breast tissue as well as breast cancer/tumor tissue. Expression levels of a particular cancer marker sequence in tissue types other than breast are irrelevant in certain diagnostic embodiments since the presence of tumor cells can be confirmed by observation of predetermined differential expression levels.

Other differential expression patterns can be utilized advantageously for diagnostic purposes. For example, overexpression or underexpression of a cancer-associated sequence of the invention in tumor tissue and normal tissue of the same type, but not in other normal tissue types, e.g., PBMCs, can be exploited diagnostically. In such a scenario, the presence of metastatic tumor cells, for example in a sample taken from the blood (or from some other tissue site different from that in which the tumor arose), can be identified and/or confirmed by detecting over- or under-expression of the cancer-associated sequence in the sample, for example using any of a variety of amplification methods as described herein. In this setting, expression of the cancer-associated sequence in normal tissue of the same type in which the tumor arose, does not affect its diagnostic utility.

Skilled practitioners will appreciate that various statistical analyses and software can be used in the methods of the present invention, and such methods and software are well known to those of ordinary skill in the art (e.g., Linear Models for Microarray Data, linear discriminant analysis and support vector machines analysis, and the like).

### (C) Screening Methods and Small Molecules

In some embodiments, the present disclosure provides methods for identifying small molecules that bind (e.g., bind specifically) to the breast cancer markers disclosed herein. Accordingly, the disclosure also provides small organic molecules (“breast cancer marker binding organic molecules”) which bind, e.g., specifically, to any of the breast cancer marker polypeptides as described herein. Optionally, the breast cancer marker binding organic molecules of the present invention may be conjugated to a growth inhibitory agent or cytotoxic agent such as a toxin, including, for example, a maytansinoid or calicheamicin, an antibiotic, a radioactive isotope, a nucleolytic enzyme, or the like. The binding organic molecules of the present invention preferably induce death of a cell to which they bind. For diagnostic purposes, the organic molecules of the present invention may be detectably labeled, attached to a solid support, or the like.

Breast cancer marker binding organic molecules are organic molecules other than oligopeptides or antibodies as defined herein that bind, preferably specifically, to a breast cancer polypeptide as described herein. Binding organic molecules may be identified and chemically synthesized using known methodology (see, e.g., PCT Publication Nos. WO00/00823 and WO00/39585). Binding organic molecules are usually less than about 2000 daltons in size, alternatively less than about 1500, 750, 500, 250, or 200 daltons in size, wherein such organic molecules that are capable of binding, preferably specifically, to a breast cancer polypeptide as described herein may be identified without undue experimentation using well known techniques. In this regard, it is noted that techniques for screening organic molecule libraries for molecules that are capable of binding to a polypeptide target are well known in the art (see, e.g., PCT Publication Nos. WO00/00823 and WO00/39585).

### (D) Methods of Treatment

As will be recognized by the skilled artisan, in certain embodiments, the breast cancer markers of the present invention can be used as therapeutic targets for the treatment of breast cancer. Thus, the present disclosure provides for the use of one or more breast cancer polynucleotides or polypeptides (e.g., an anti-breast cancer polypeptide antibody, a breast cancer polypeptide binding oligopeptide, or a breast cancer polypeptide binding organic molecule as described herein), for the preparation of a medicament useful in the treatment of a breast cancer.

Another embodiment of the present invention is directed to a method for inhibiting the growth of a cell that expresses a breast cancer polypeptide, wherein the method comprises contacting the cell with an antibody, an oligopeptide or a small organic molecule that binds to the breast cancer polypeptide, and wherein the binding of the antibody, oligopeptide or organic molecule to the breast cancer polypeptide causes inhibition of the growth of the cell expressing the breast cancer polypeptide. The cell can be a cancer cell and binding of the antibody, oligopeptide or organic molecule to the breast cancer polypeptide can cause death of the cell expressing the breast cancer polypeptide. Optionally, the antibody is a monoclonal antibody, antibody fragment, chimeric antibody, humanized antibody, or single-chain antibody. Antibodies, breast cancer polypeptide binding oligopeptides and breast cancer polypeptide binding organic molecules employed in the methods of the present invention may optionally be conjugated to a growth inhibitory agent or cytotoxic agent such as a toxin, including, for example, a maytansinoid or calicheamicin, an antibiotic, a radioactive isotope, a nucleolytic enzyme, or the like. The antibodies and breast cancer polypeptide binding oligopeptides employed in the methods of the present invention may optionally be produced in CHO cells or bacterial cells.

Another embodiment is directed to a method of therapeutically treating a mammal having cancerous cells that express a breast cancer polypeptide, wherein the method comprises administering to the mammal a therapeutically effective amount of an antibody, an oligopeptide or a small organic molecule that binds to the breast cancer polypeptide, thereby resulting in the effective therapeutic treatment of the tumor.

Another embodiment is directed to a method for treating or preventing a breast cancer associated with altered, preferably increased, expression or activity of a breast cancer polypeptide, the method comprising administering to a subject in need of such treatment an effective amount of an antagonist of a breast cancer polypeptide. Preferably, the antagonist of the breast cancer polypeptide is an anti-breast cancer polypeptide antibody, breast cancer polypeptide binding oligopeptide, breast cancer polypeptide binding organic molecule or antisense oligonucleotide. Effective treatment or prevention of the cancer may be a result of direct killing or growth inhibition of cells that express a breast cancer polypeptide or by antagonizing the cell growth potentiating activity of a breast cancer polypeptide.

Other embodiments of the present invention are directed to the use of (a) a breast cancer polypeptide, (b) a nucleic acid encoding a breast cancer polypeptide or a vector or host cell comprising that nucleic acid, (c) a breast cancer polypeptide antibody, (d) a breast cancer polypeptide-binding oligopeptide, or (e) a breast cancer polypeptide-binding small organic molecule in the preparation of a medicament useful for (i) the therapeutic treatment or diagnostic detection of a breast cancer or tumor, or (ii) the therapeutic treatment or prevention of a breast cancer.

Another embodiment of the present invention is directed to a method for inhibiting the growth of a cancer cell, wherein the growth of said cancer cell is at least in part dependent upon the growth potentiating effect(s) of a breast cancer polypeptide (wherein the breast cancer polypeptide may be expressed either by the cancer cell itself or a cell that produces polypeptide(s) that have a growth potentiating effect on cancer cells), wherein the method comprises contacting the breast cancer polypeptide with an antibody, an oligopeptide or a small organic molecule that binds to the breast cancer polypeptide, thereby antagonizing the growth-potentiating activity of the breast cancer polypeptide and, in turn, inhibiting the growth of the cancer cell. Preferably the growth of the cancer cell is completely inhibited. Even more preferably, binding of the antibody, oligopeptide or small organic molecule to the breast cancer polypeptide induces the death of the cancer cell. Optionally, the antibody is a monoclonal antibody, antibody fragment, chimeric antibody, humanized antibody, or single-chain antibody. Antibodies, breast cancer polypeptide binding oligopeptides and breast cancer polypeptide binding organic molecules employed in the methods of the present invention may optionally be conjugated to a growth inhibitory agent or cytotoxic agent such as a toxin, including, for example, a maytansinoid or calicheamicin, an antibiotic, a radioactive isotope, a nucleolytic enzyme, or the like. The antibodies and breast cancer polypeptide binding oligopeptides employed in the methods of the present invention may optionally be produced in CHO cells or bacterial cells.

### (E) Pharmaceutical Compositions

The present invention further provides compositions comprising the breast cancer markers (polynucleotides, polypeptides, antibodies specific thereto), binding oligopeptides, and binding organic molecules. For in vivo use, a composition comprising polynucleotides, polypeptides, antibodies specific thereto, breast cancer polypeptide binding oligopeptides, and binding organic molecules as described herein is generally incorporated into a pharmaceutical composition prior to administration. A pharmaceutical composition comprises one or more polynucleotides, polypeptides, antibodies specific thereto, breast cancer polypeptide binding oligopeptides, or binding organic molecules as described herein in combination with a physiologically acceptable carrier. To prepare a pharmaceutical composition, an effective amount of one or more polynucleotides, polypeptides, antibodies specific thereto, breast cancer polypeptide binding oligopeptides, or binding organic molecules as described herein is mixed with any pharmaceutical carrier(s) known to those skilled in the art to be suitable for the particular mode of administration. A pharmaceutical carrier may be liquid, semi-liquid or solid. Solutions or suspensions used for parenteral, intradermal, subcutaneous or topical application may include, for example, a sterile diluent (such as water), saline solution, fixed oil, polyethylene glycol, glycerine, propylene glycol or other synthetic solvent; antimicrobial agents (such as benzyl alcohol and methyl parabens); antioxidants (such as ascorbic acid and sodium bisulfite) and chelating agents (such as ethylenediaminetetraacetic acid (EDTA)); buffers (such as acetates, citrates and phosphates). If administered intravenously, suitable carriers include physiological saline or phosphate buffered saline (PBS), and solutions containing thickening and solubilizing agents, such as glucose, polyethylene glycol, polypropylene glycol and mixtures thereof. In addition, other pharmaceutically active ingredients (including other anti-cancer agents) and/or suitable excipients such as salts, buffers and stabilizers may, but need not, be present within the composition.

Polynucleotides, polypeptides, antibodies specific thereto, breast cancer polypeptide binding oligopeptides, and binding organic molecules as described herein of the present invention may be prepared with carriers that protect it against rapid elimination from the body, such as time release formulations or coatings. Such carriers include controlled release formulations, such as, but not limited to, implants and microencapsulated delivery systems, and biodegradable, biocompatible polymers, such as ethylene vinyl acetate, polyanhydrides, polyglycolic acid, polyorthoesters, polylactic acid and others known to those of ordinary skill in the art.

Routes of Administration

Administration may be achieved by a variety of different routes, including oral, parenteral, nasal, intravenous, intradermal, subcutaneous or topical. Preferred modes of administration depend upon the nature of the condition to be treated or prevented. An amount that, following administration, inhibits, prevents or reduces breast cancer is considered effective. The precise dosage and duration of treatment is a function of the cancer being treated and may be determined empirically using known testing protocols or by testing the compositions in model systems known in the art and extrapolating therefrom. Controlled clinical trials may also be performed. Dosages may also vary with the severity of the condition to be alleviated. A pharmaceutical composition is generally formulated and administered to exert a therapeutically useful effect while minimizing undesirable side effects. The composition may be administered one time, or may be divided into a number of smaller doses to be administered at intervals of time. For any particular subject, specific dosage regimens may be adjusted over time according to the individual need.

In certain embodiments, a polynucleotide encoding a breast cancer polypeptide may be administered. Such a polynucleotide may be present in a pharmaceutical composition within any of a variety of delivery systems known to those of ordinary skill in the art, including nucleic acid, bacterial and viral expression systems, and colloidal dispersion systems such as liposomes.

The practice of the present invention will employ, unless indicated specifically to the contrary, conventional methods of virology, immunology, microbiology, molecular biology and recombinant DNA techniques within the skill of the art, many of which are described below for the purpose of illustration. Such techniques are explained fully in the literature. See, e.g., Ausubel et al. (2007 Current Protocols in Molecular Biology, Greene Publ. Assoc. Inc. & John Wiley & Sons, Inc., NY, N.Y.); Sambrook et al. (1989 Molecular Cloning, Second Ed., Cold Spring Harbor Laboratory, Plainview, N.Y.); Maniatis et al. (1982 Molecular Cloning, Cold Spring Harbor Laboratory, Plainview, N.Y.); DNA Cloning: A Practical Approach, vol. I & II (D. Glover, ed.); Oligonucleotide Synthesis (N. Gait, ed., 1984); Nucleic Acid Hybridization (B. Hames et al., eds., 1985); Transcription and Translation (B. Hames et al., eds., 1984); Animal Cell Culture (R. Freshney, ed., 1986); Perbal, A Practical Guide to Molecular Cloning (1984), and elsewhere.

### EXAMPLES

The invention is further described in the following examples, which do not limit the scope of the invention described in the claims.

### Example 1

### Identification of Breast Cancer Biomarkers from Blood

This example describes the identification of breast cancer biomarkers identified from blood samples from breast cancer patients.

Blood samples were collected from 261 patients. The classification of the patients is summarized in Table 1. RNAs were extracted from whole blood samples (minus erythrocytes) using PAXgene™ blood RNA Kits (PreAnalytiX, a Qiagen-BD joint venture company, Franklin Lakes, N.J.) and analyzed by Affymetrix Human Genome U133 Plus 2.0 Array (Affymetrix, Santa Clara, Calif.).

According to the Human Genome U133 Plus 2.0 Array information data sheet, the sequences from which these probe sets were derived were selected from GenBank®, dbEST, and RefSeq. The sequence clusters were created from the UniGene database (Build 133, Apr. 20, 2001) and then refined by analysis and comparison with a number of other publicly available databases, including the Washington University EST trace repository and the University of California, Santa Cruz Golden-Path human genome database (April 2001 release).

In addition, the Human Genome U133 Plus 2.0 Array includes 9,921 new probe sets representing approximately 6,500 new genes. These gene sequences were selected from GenBank, dbEST, and RefSeq. Sequence clusters were created from the UniGene database (Build 159, Jan. 25, 2003) and refined by analysis and comparison with a number of other publicly available databases, including the Washington University EST trace repository and the NCBI human genome assembly (Build 31). (See Affymetrix Human Genome U133 Plus 2.0 Array Data Sheet, Part No. 701484, Rev. 4, 2003-2004).

The array data were collected on 35 separate days.

TABLE 1
Classification of Patients Included in Study

| Patient Classification | Number |
|---|---|
| Control | 102 |
| Control with previous atypical biopsy | 4 |
| Control with previous benign biopsy | 36 |
| Control with previous invasive disease | 17 |
| Invasive | 97 |
| Invasive with previous cancer history | 2 |
| Nominal invasive due to previous cancer history | 3 |
| Total | 261 |

Several different statistical analyses were performed to identify biomarkers as described in more detail below. Breast-cancer-specific biomarkers identified in this study are shown in Table 2A, Table 2B, and Table 2C (provided separately as an appendix, which is hereby incorporated by reference in its entirety), ranked in order of adjusted p-value. All genes in Table 2 have B (log-odds that the gene is differentially expressed)>=0. Therefore, the cutoff value is B=0 and all genes in the table are potential biomarkers. It should be specifically noted that some identified breast cancer markers showed an increase in expression as compared to normal samples (positive LogFC values) while some breast cancer markers showed a decrease in expression as compared to normal samples (negative values). Thus, those markers in Table 2 with negative LogFC numbers are positive for cancer below their corresponding Threshold number (see second column in Table 2B) while those markers in Table 2 with positive LogFC numbers are positive for cancer above their corresponding Threshold number. As would be recognized by the skilled artisan, the Threshold number (cut-off value) can be determined for each type of detection method (e.g., real-time PCR, ELISA, etc.) using methods known in the art and described elsewhere herein and this number will change depending on the specific detection method being used.

Table 2, provided as three separate parts as an appendix, is part of the application, and is incorporated by reference, provides the following information:

Table 2A: ID: Entrez Gene ID number; Gene: gene name; PN SEQ ID NO: polynucleotide sequence identifier numbers; AA SEQ ID NO: amino acid sequence identifier numbers; Description.

Table 2B: Gene: gene name; logFC: logarithm (base 2) of fold change between average expression in cancer patients and average expression in controls; AveExpr: average expression in all samples; t: t score, as in student t distribution, measuring expression difference between cancer patients and controls; P.Value: p value based on student t distribution; adj.P.Val: p value adjusted for multiple testing using Benjamini and Hochberg's method;

Table 2C:*Gene identified as a pseudogene; gene: gene name; B:log(B)-odds that the gene is differentially expressed; AreaROC; Accur.: accuracy; Sens.: Sensitivity; Spec.: Specificity; Cutoff: Cutoff (Threshold).

Clustering Analysis

Clustering analysis was performed to identify any date-dependent experimental artifacts. For this analysis, all array data were processed and normalized by MASS methods. Only probes present in all experiments were kept in the analysis. Further, all expression data were log-transformed and centered against mediums across genes and arrays. Two specific approaches were carried out in the analysis: hierarchical clustering analysis and k-mean clustering analysis. The program Cluster was used in both approaches.

In hierarchical clustering analysis, centered correlation and averaged linkage were selected. Using this analysis, no obvious date-dependent experimental artifacts were found.

In k-mean clustering analysis, all samples were forced to cluster into 35 groups, mimicking the 35 days in which the data were collected. Parameters selected in the analysis included: k-Means for Method, Euclidean distance for Similarity Metric and 100 iterations. Most samples analyzed on the same day were clustered into separate groups.

In the most significant case against randomness, 4 out of the 8 samples generated on Jan. 15, 2007 were clustered in one group. The corresponding p value was 1.45×10−3. Again, no obvious date-dependent experimental artifacts were found.

Identification of Individual Biomarker Candidates

LIMMA analysis was carried out to identify potential biomarkers (Smyth, G. K. (2004). Statistical Applications in Genetics and Molecular Biology 3, No. 1, Article 3). For this analysis, two types of cases were analyzed against each other: cancer versus control. Cancer cases included the 97 cases of “Invasive” as listed in Table 1. The control cases included the 102 cases of “Control” as listed in Table 1. Other cases were ignored in this analysis due to ambiguity in their disease status. The analysis was carried out with R, Bioconductor and PERL.

All array data were processed and normalized using the GCRMA methods (Z. Wu et al., 2004 Journal of the American Statistical Association 99:909-917). Instead of using Affymetrix default annotation, probes were annotated to ENTREZG genes. The LIMMA analysis was carried out using the R library “limma”. The Benjamini and Hochberg's method was selected to adjust p values in multiple testing. A total of 2045 genes were identified as discriminative with positive B values between cancer cases and control cases. These genes are listed in Table 2. PERL scripts were then written to evaluate the performance of these genes: area under the ROC curve (AUC), accuracy, sensitivity, specificity and the corresponding threshold value on log-transformed (base 2) intensity.

As would be recognized by the skilled artisan, receiver operating characteristic (ROC) curve is a graphical depiction of the relationship between the true positive ratio (sensitivity) and false positive ratio (1-specificity) as a function of the cutoff level of a disease (or condition) marker. ROC curves help to demonstrate how raising or lowering the cutoff point for defining a positive test result affects tradeoffs between correctly identifying people with a disease (true positives) and incorrectly labeling a person as positive who does not have the condition (false positives).

The best biomarker candidate identified by the analysis was ACAA2, acetyl-Coenzyme A acyltransferase 2 (mitochondrial 3-oxoacyl-Coenzyme A thiolase) (see Table 2; SEQ ID NOs:1 and 3006). On average, ACAA2 expression level in cancer cases was higher than in control cases. It had an adjusted p value of 4.81×10−14, an AUC value of 0.833, an accuracy of 0.749, a sensitivity of 0.763 and a specificity of 0.735. Although there was overlap in the probe intensity between cancer and control cases, the performance of ACAA2 was good in distinguishing cancer cases from control cases.

As shown in Table 2, the second best biomarker candidate identified by the analysis was SLC25A20, solute carrier family 25 (carnitine/acylcarnitine translocase), member 20. On average, SLC25A20 expression level in cancer cases was higher than that in control cases. It had an adjusted p value of 2.97×10−12, an AUC value of 0.832, an accuracy of 0.759, a sensitivity of 0.711 and a specificity of 0.804. Although its p value was higher than that of the best gene ACCA2, its accuracy was slightly better.

The third best biomarker candidate identified by the analysis was SREBF1, sterol regulatory element binding transcription factor 1 (see Table 2). On average, its expression level in cancer cases was lower than in control cases. It had an adjusted p value of 2.79×10−10, an AUC value of 0.792, an accuracy of 0.719, a sensitivity of 0.742 and a specificity of 0.696.

The last biomarker candidate identified by the analysis was MRPL40, mitochondrial ribosomal protein L40 (see Table 2). On average, MRPL40 expression level in cancer cases was higher than that in control cases. It had an adjusted p value of 1.87×10−3, an AUC value of 0.652, an accuracy of 0.638, a sensitivity of 0.577 and a specificity of 0.696.

It should be noted that while the specific markers identified and discussed hereinabove were identified as being the most powerful for distinguishing breast cancer from control cases, all of the biomarkers listed in Table 2 perform reasonably well in distinguishing cancer cases from control cases and are therefore useful for the detection of breast cancer, particularly when combined together, for example in a diagnostic panel.

Identification of Biomarkers Panels

Although the top genes identified by the LIMMA method demonstrated good performance in distinguishing cancer cases from control cases, their performance can be further improved by combining various different discriminative genes in biomarker panels. For this purpose, up to fifty biomarkers were selected, from among the 2045 discriminative markers identified by the LIMMA method, to construct multi-gene biomarker panels for the detection and diagnosis of breast cancer. Such panels can be validated independently by other experimental technologies such as quantitative polymerase chain reaction (qPCR).

Seventy five cancer cases and the same number of control cases were initially randomly selected as a training dataset, and the remaining twenty seven cancer cases and twenty two control cases served as the test dataset. A training dataset was then used to identify a biomarker panel of ten genes and then evaluate the performance of the panel against the test dataset. Three-fold cross validation (CV) and twenty bootstrap iterations were also applied to the training dataset. Thus, in every bootstrap iteration, the seventy five cancer cases and the seventy five control cases in the training dataset were randomly assigned to three groups, each group containing twenty five cancer cases and twenty five control cases. Cases in two of the three groups were then used to optimize a cancer versus control classifier and evaluate its performance by the accuracy of the classifier in correctly classifying cases in the third group. Each of the three groups served as the CV test dataset once. Therefore, there were a total of three optimization/evaluation events during each bootstrap iteration. A total of twenty bootstrap iterations were carried out for each gene panel. The performance of a gene panel was then determined by the averaged accuracy over the sixty CV and bootstrap events.

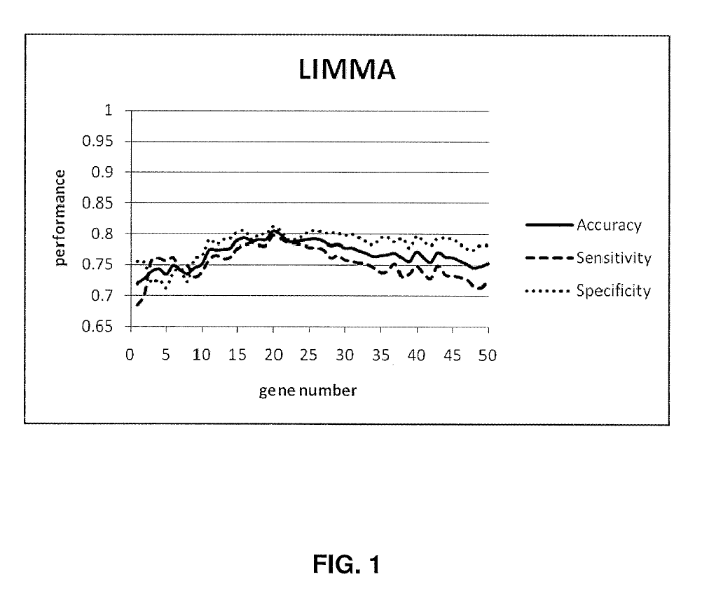

Three different approaches were applied to the selection of biomarker panels. In the first approach, a biomarker panel was constructed from the top fifty genes identified by LIMMA. Starting with the top gene ACAA2, the top fifty genes were added one by one to the biomarker panel and evaluated the corresponding performance. The top fifty genes as identified by LIMMA are listed in Table 3. In FIG. 1, the accuracy, the sensitivity and the specificity of the biomarker panel is plotted as a function of the number of genes in the panel. The performance of the panel was evaluated by averaging results from two different methods of multivariate analysis: linear discriminant analysis (LDA) and support vector machines (SVM) analysis.

As shown in FIG. 1, the accuracy of the biomarker panel first increased from 0.720 (when the panel consisted of only ACAA2) to 0.804 (when the panel consisted of the top twenty genes), then decreased to 0.753 (when the panel consisted of all the top fifty genes). Similar performance was observed in sensitivity and specificity.

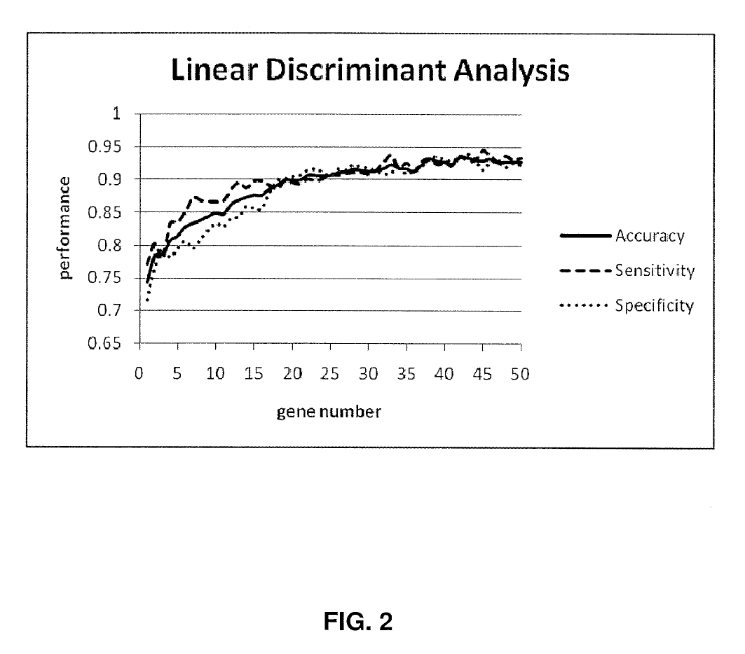

In a second approach, LDA was applied to select the fifty best genes from among the 2045 discriminative genes identified by LIMMA to construct a biomarker panel. Since it is impractical to evaluate the performance of all fifty-gene combinations among the 2045 genes, the following approach was used to identify a fifty-gene biomarker panel for breast cancer: The gene of the best accuracy (PTCD2) was first identified from the 2045 genes and selected as the initial biomarker panel. The gene among the unselected genes that most improved the performance of the existing biomarker panel was then identified and added to the panel. This step was repeated until the number of genes in the biomarker panel reached fifty. The top fifty genes as identified by LDA are listed in Table 3. In FIG. 2, the accuracy, the sensitivity and the specificity of the biomarker panel was plotted as a function of the number of genes in the panel.

As shown in FIG. 2, the accuracy of the biomarker panel first increased from 0.744 (when the panel consisted of only PTCD2) to 0.935 (when the panel consisted of the top forty two genes) then diseased slightly to 0.928 (when the panel consisted of all the top fifty genes). Similar performance was observed in sensitivity and specificity. Clearly the performance of the biomarker panel identified by LDA was much better than the performance of the panel identified by LIMMA or the performance of any individual genes.

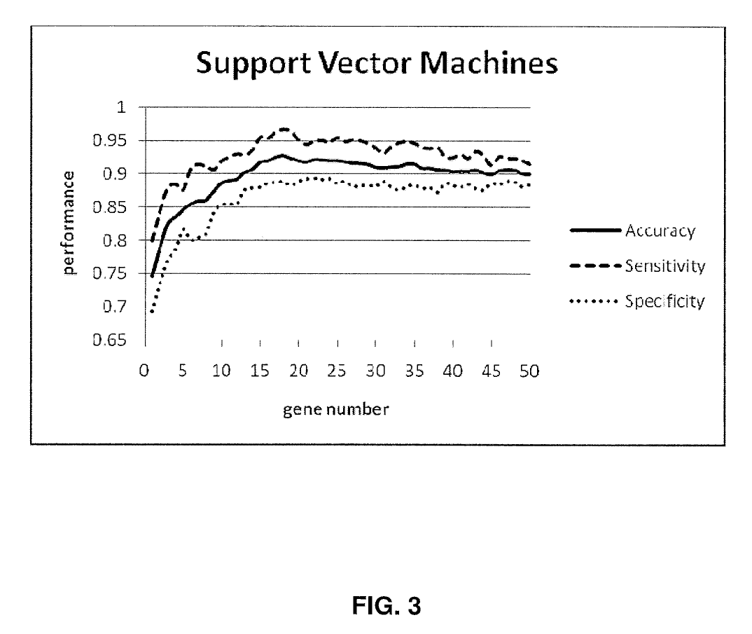

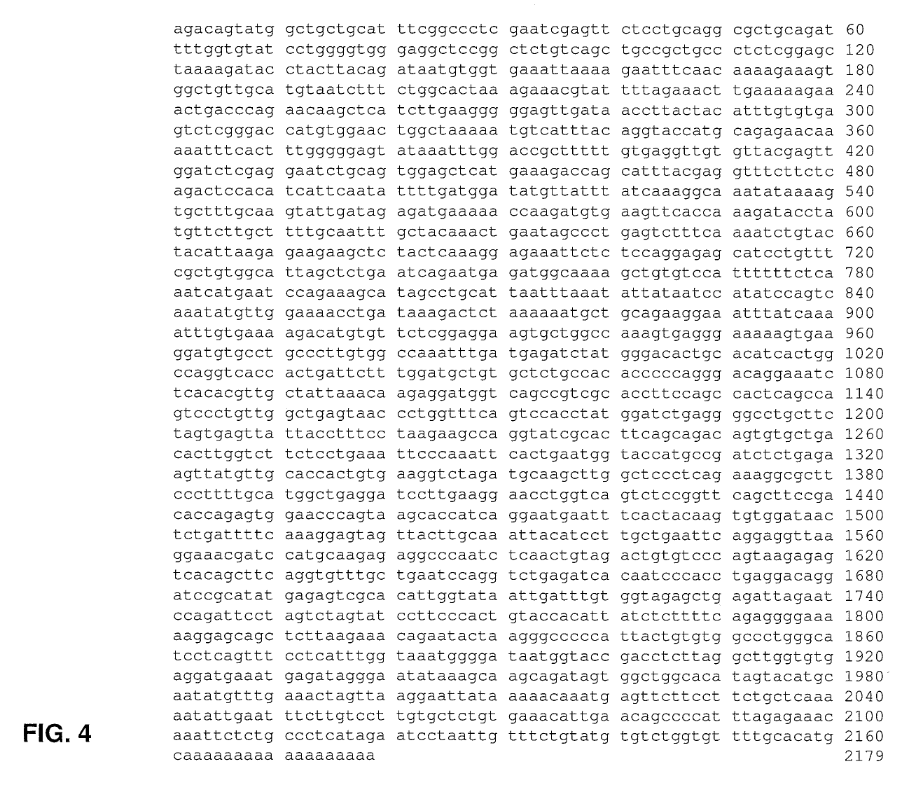

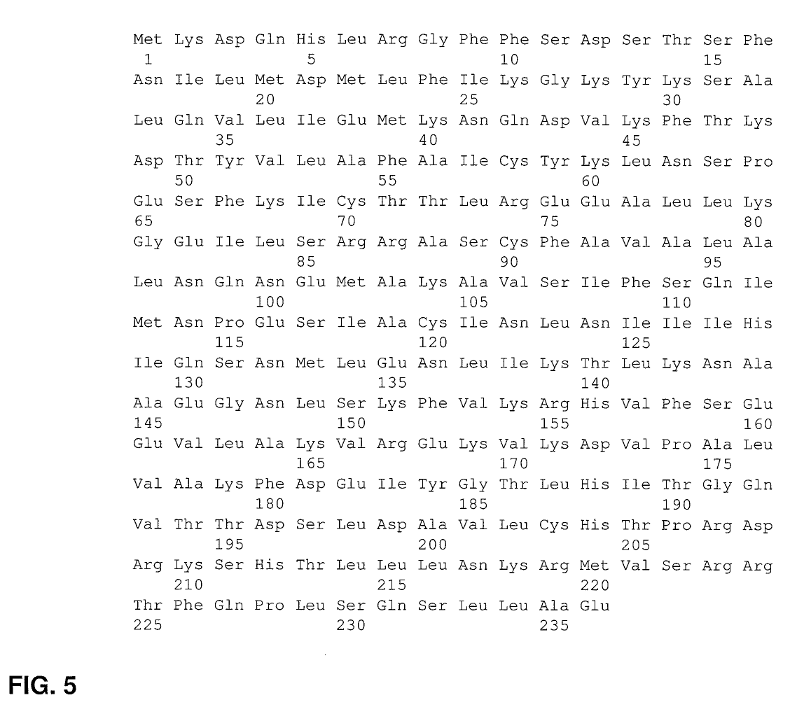

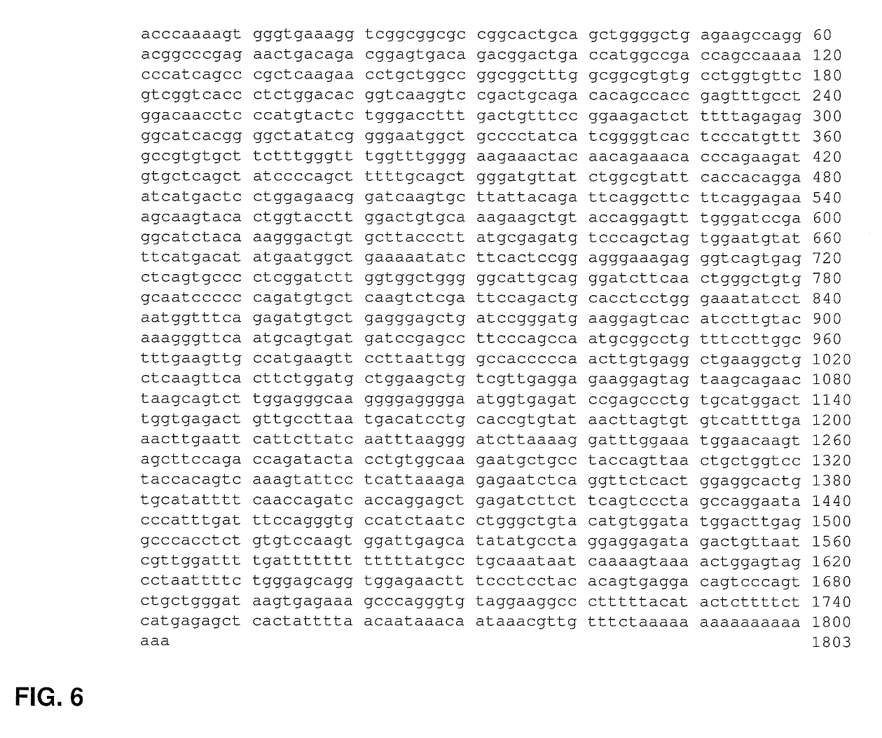

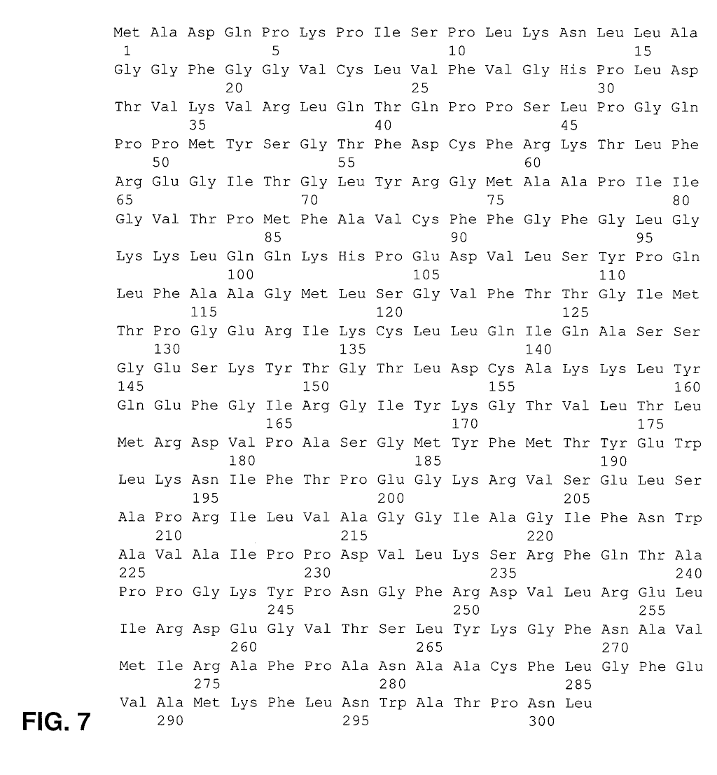

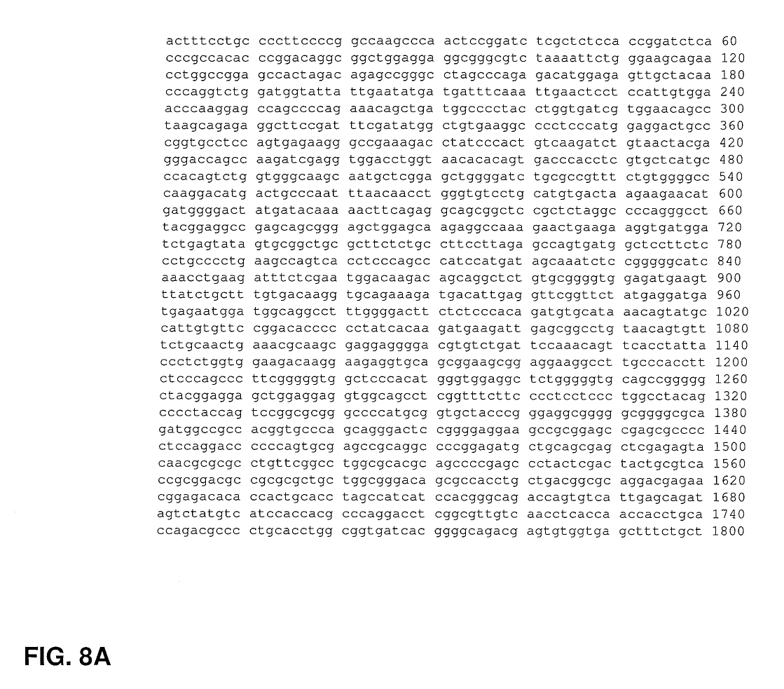

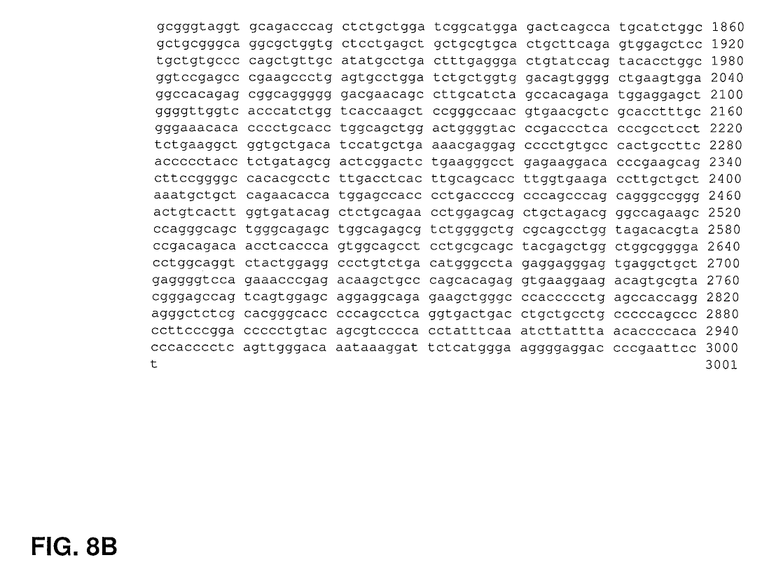

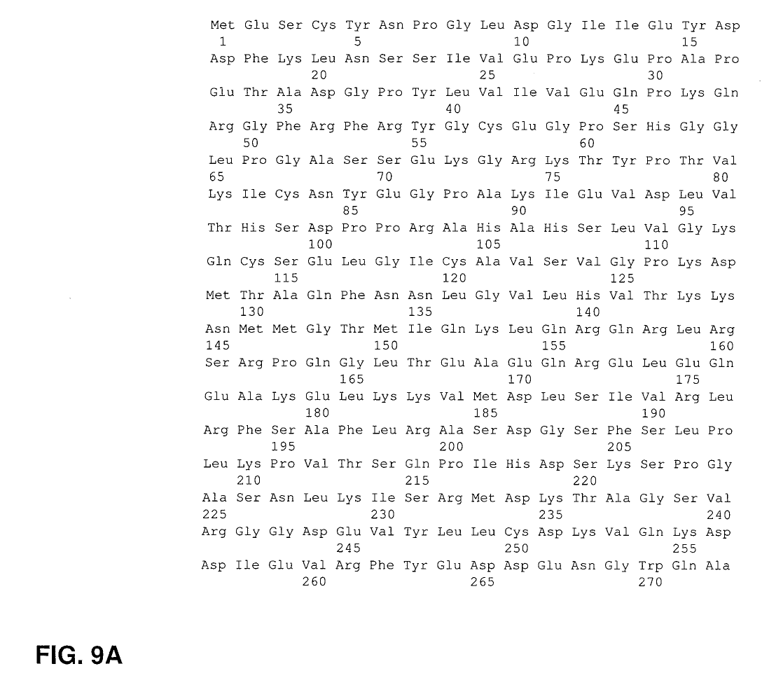

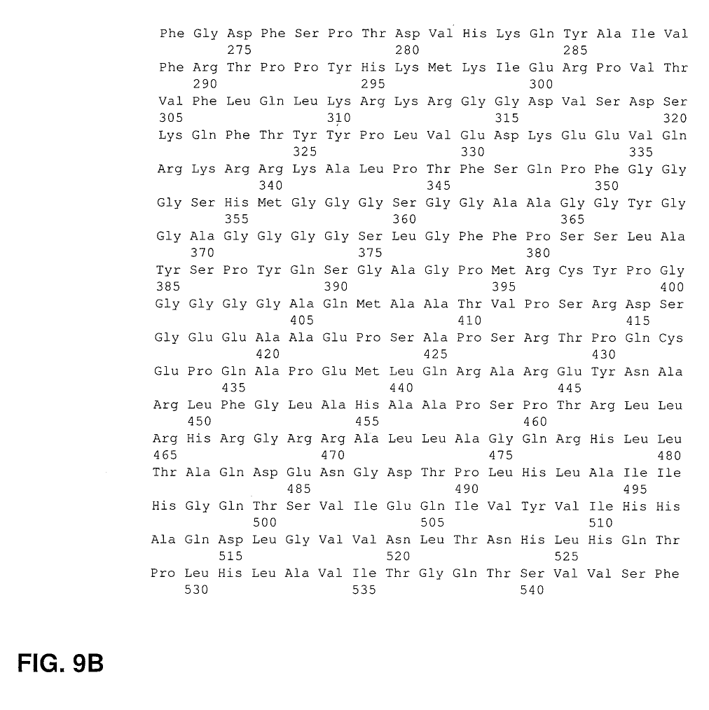

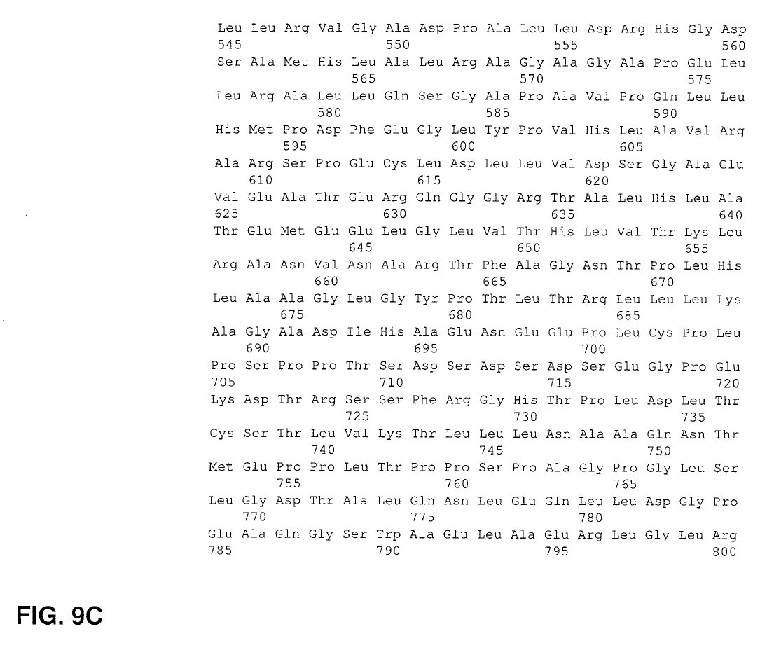

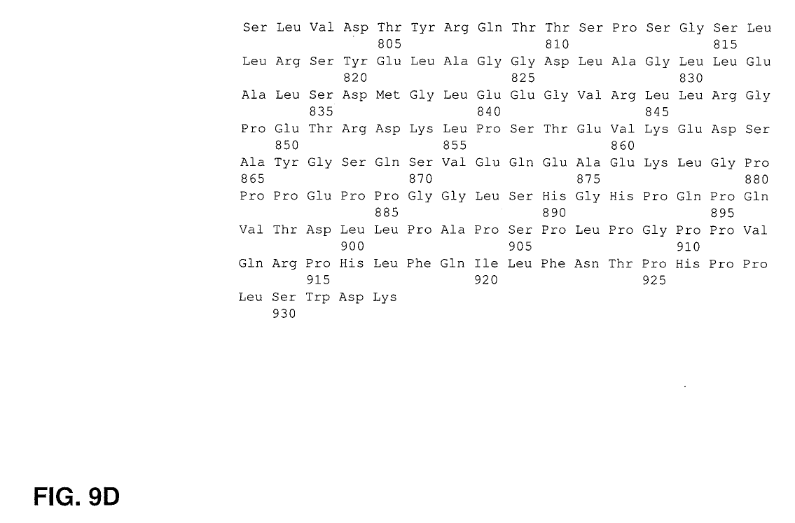

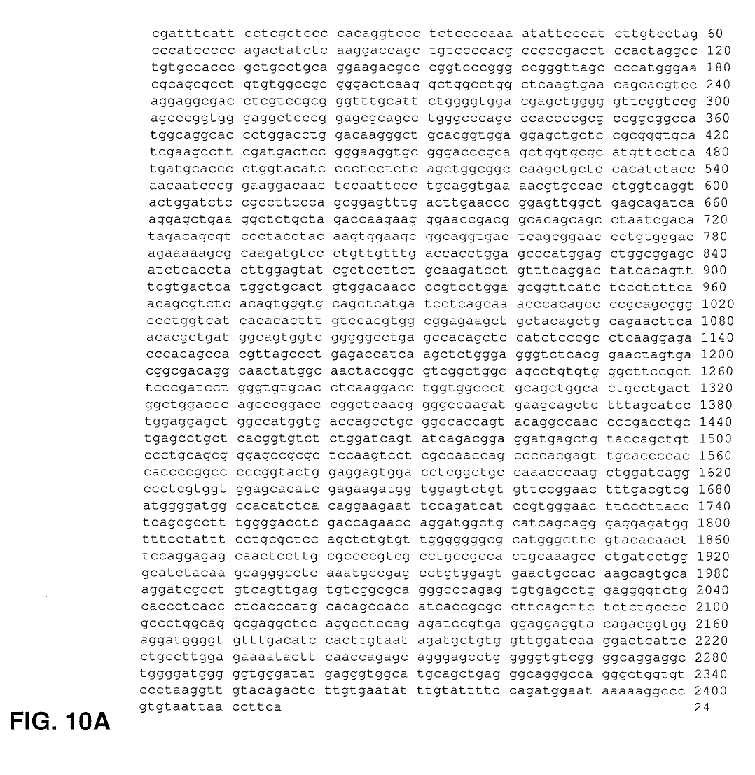

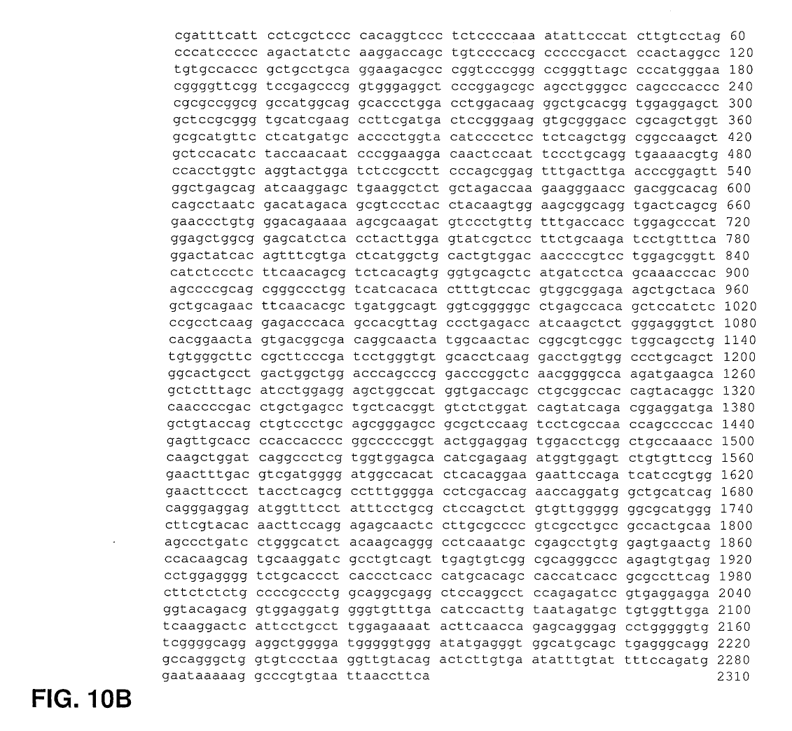

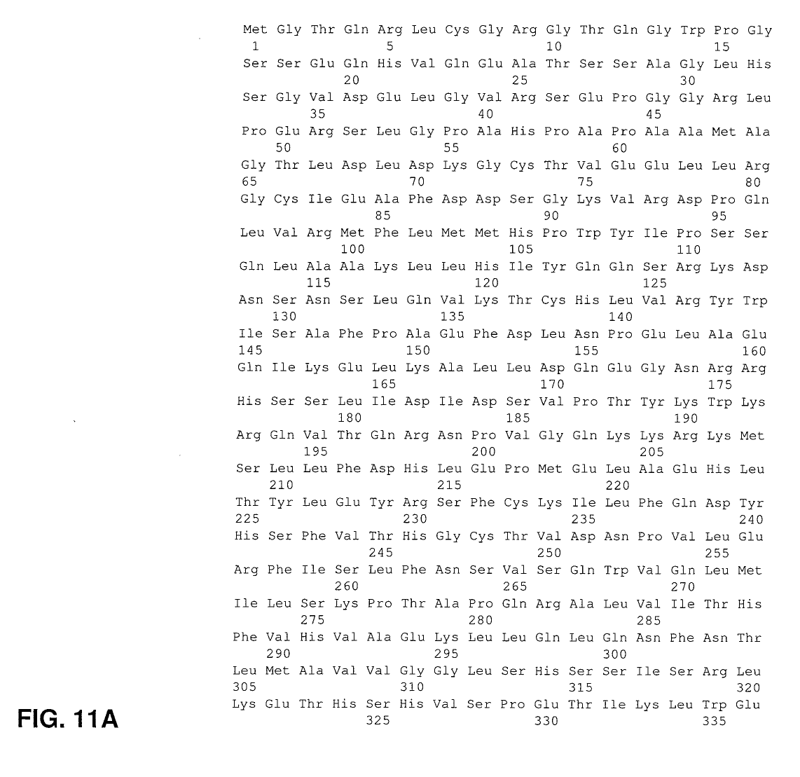

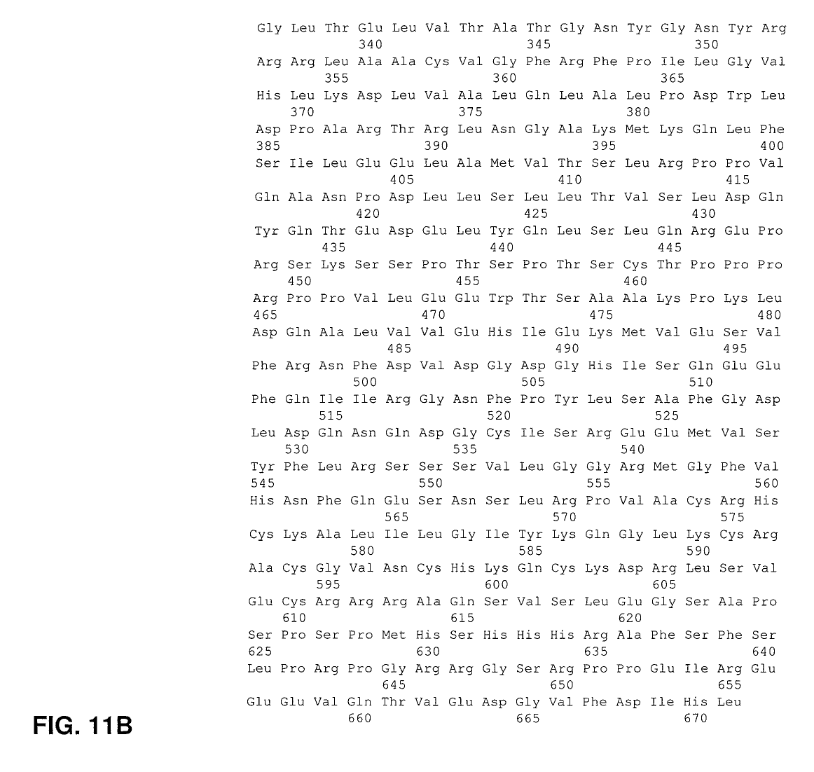

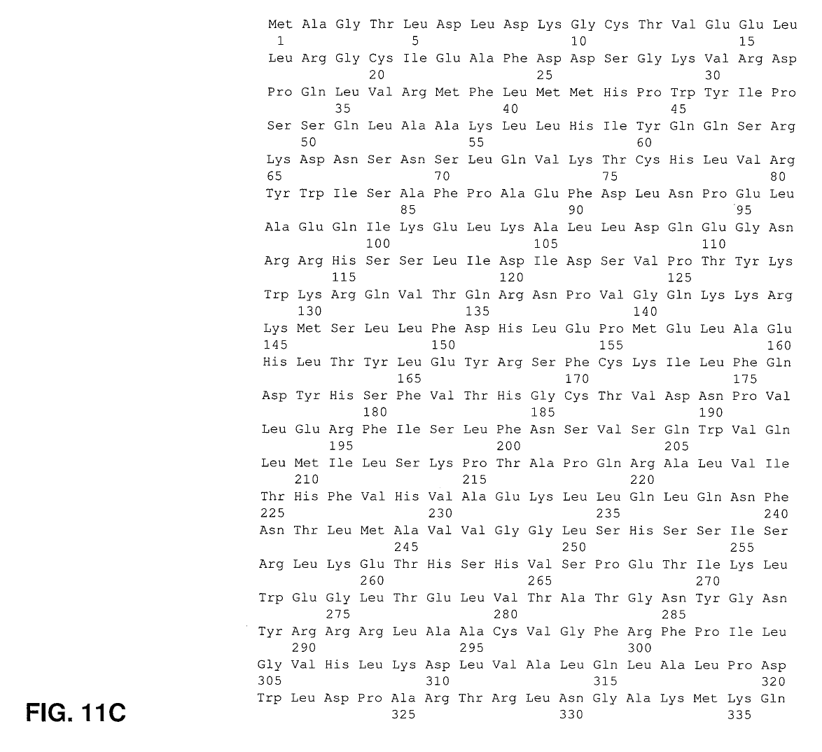

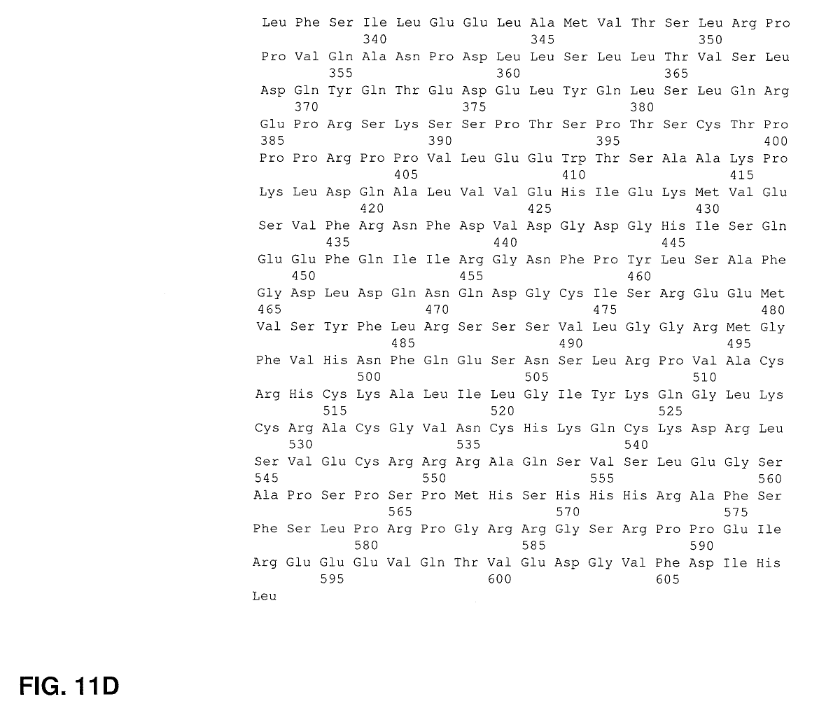

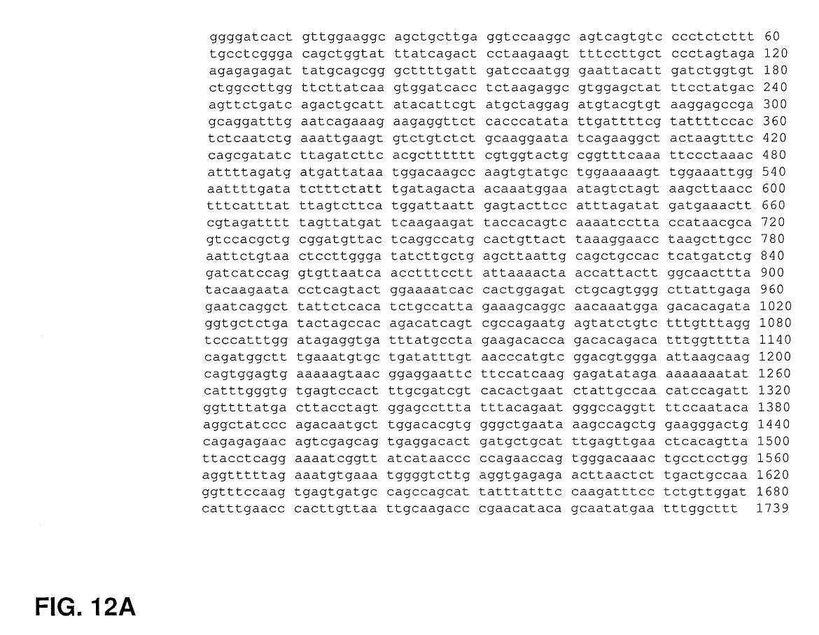

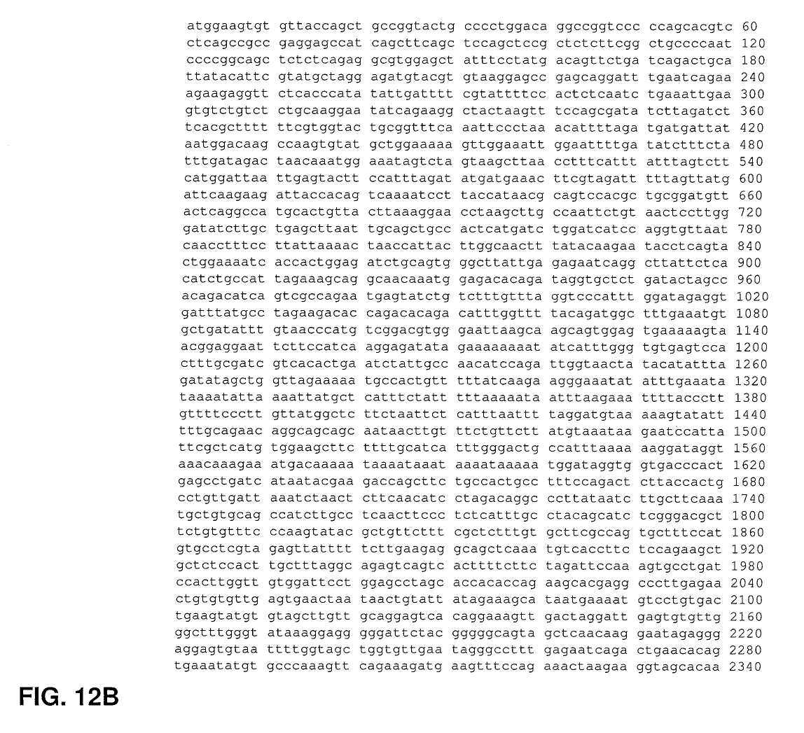

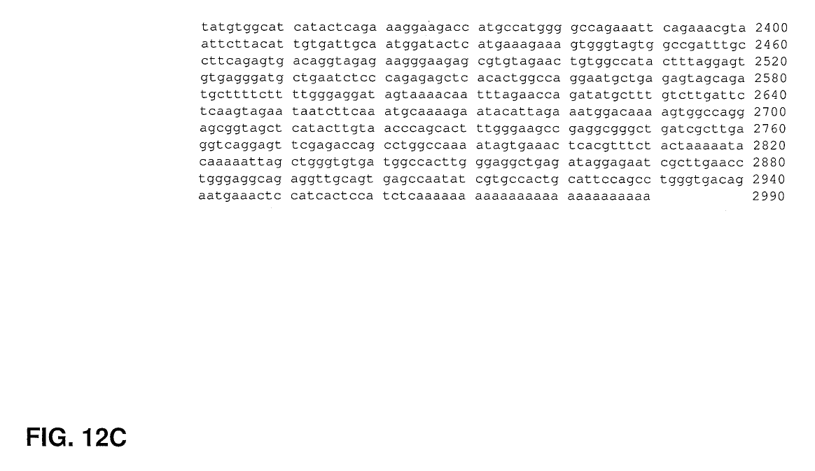

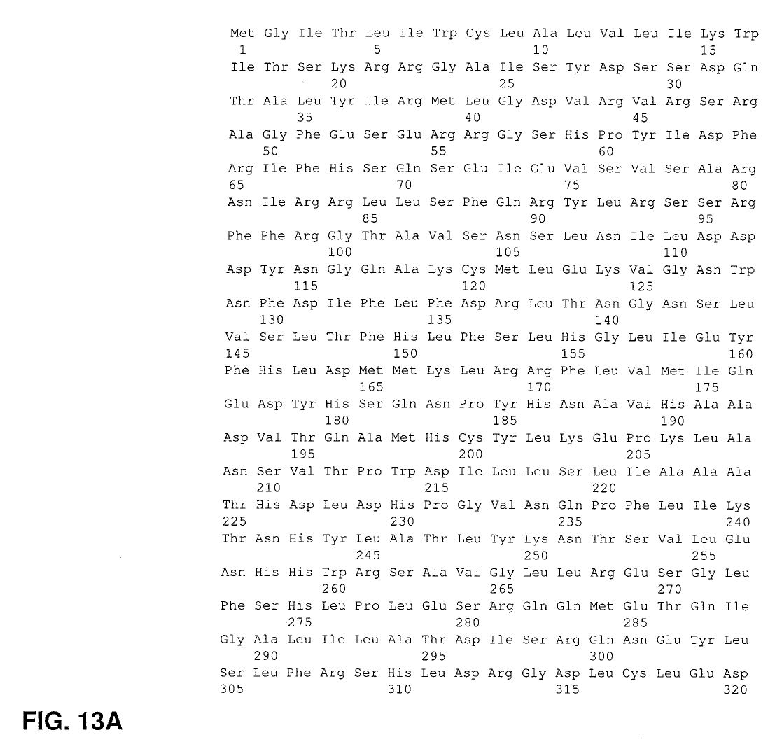

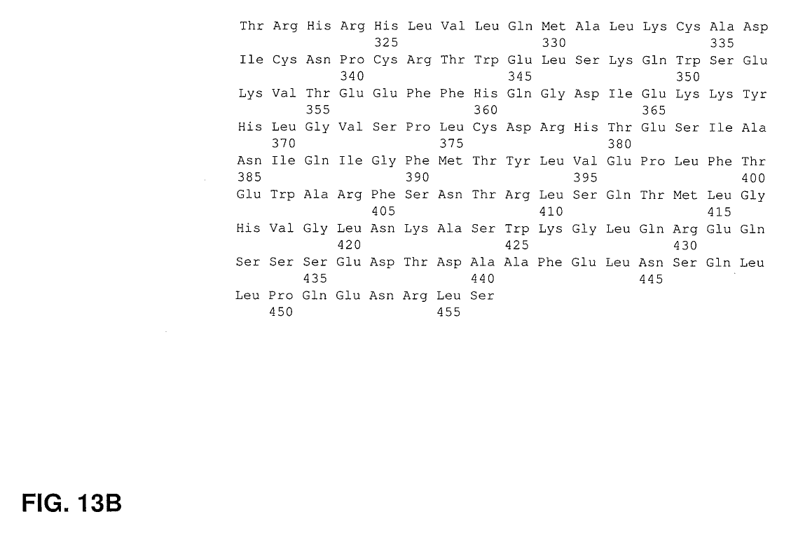

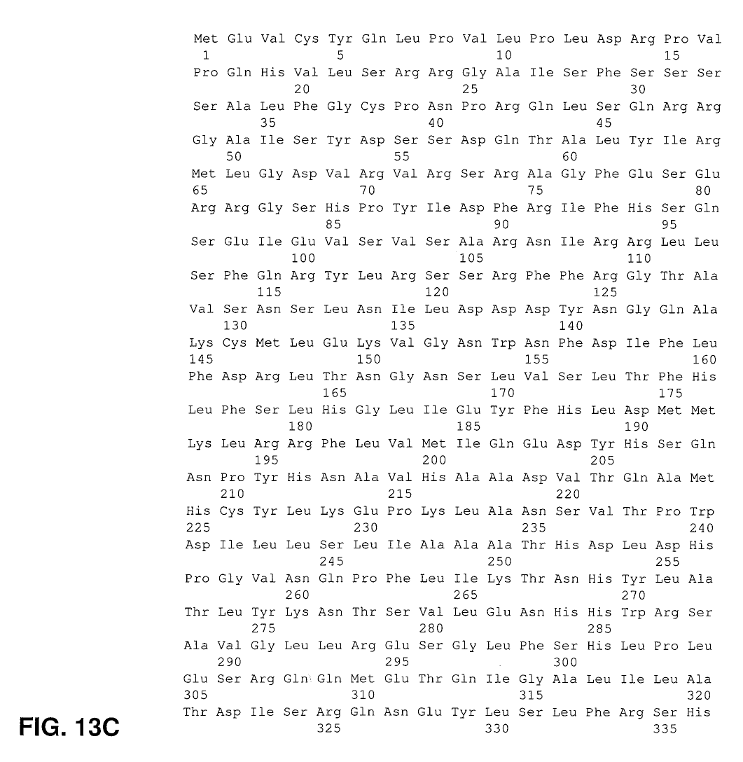

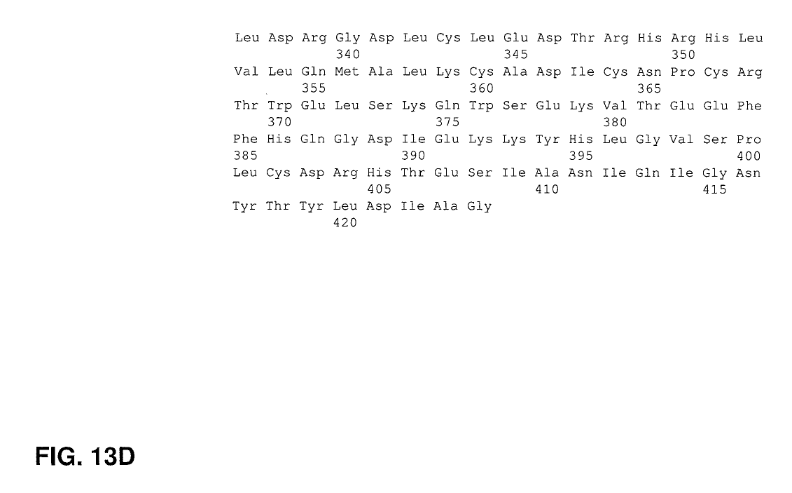

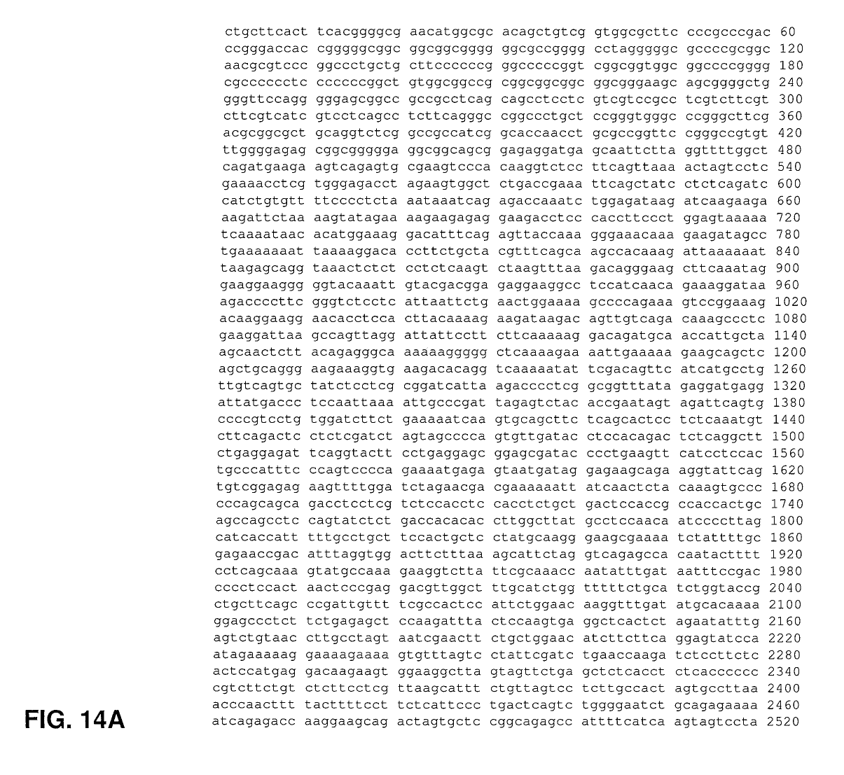

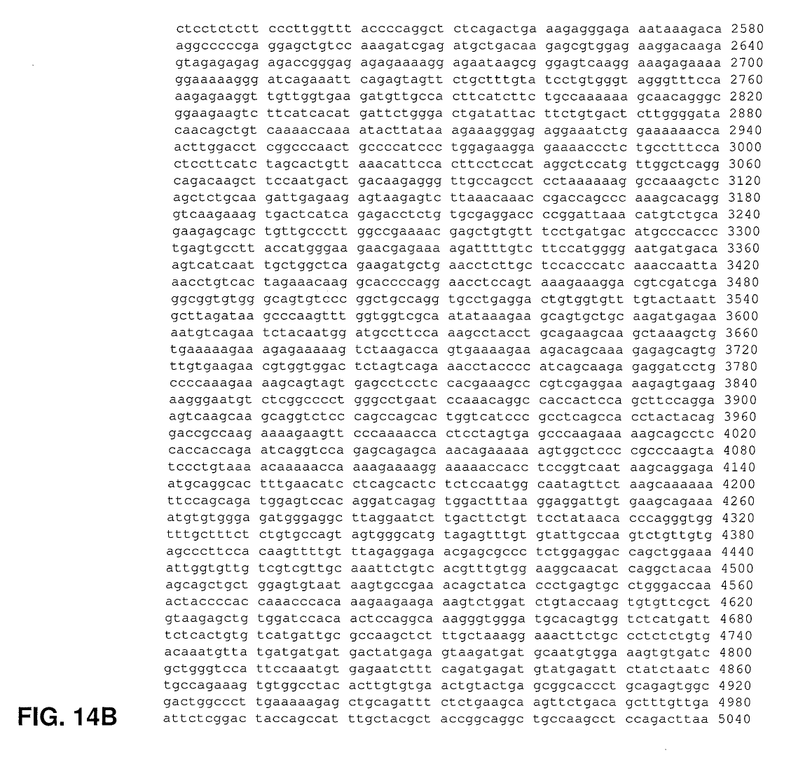

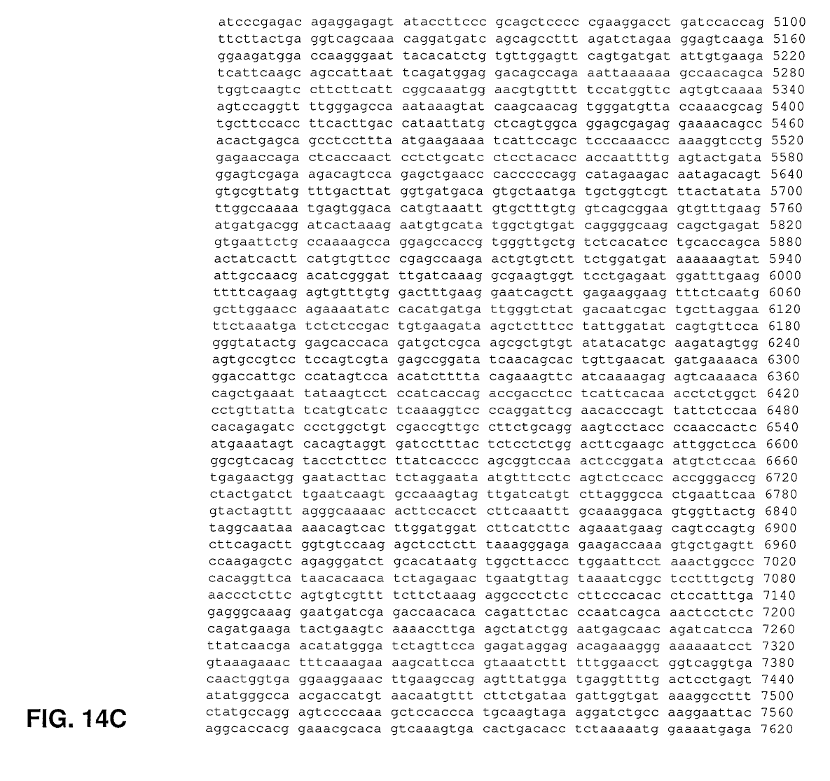

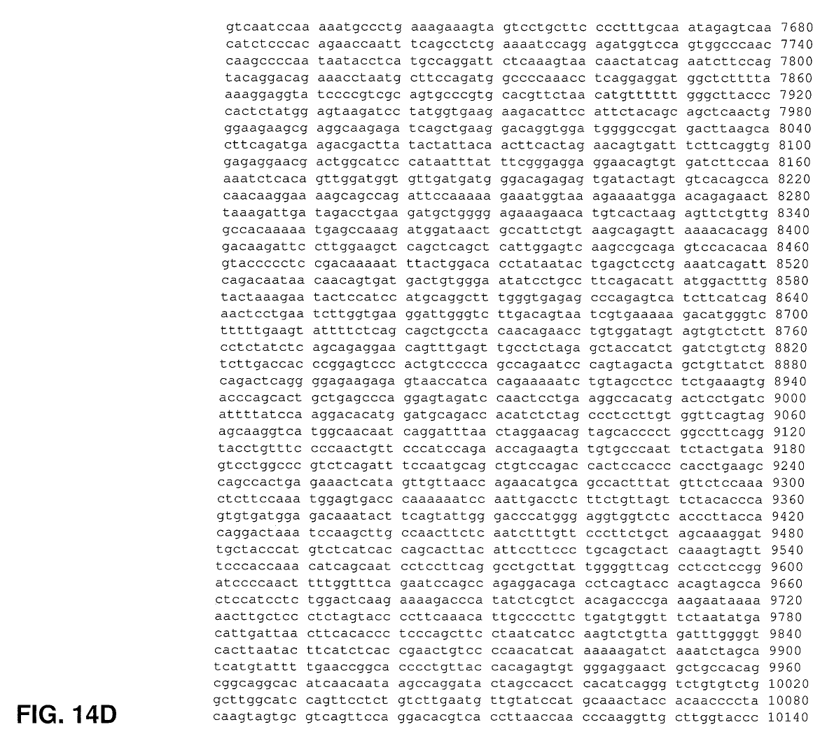

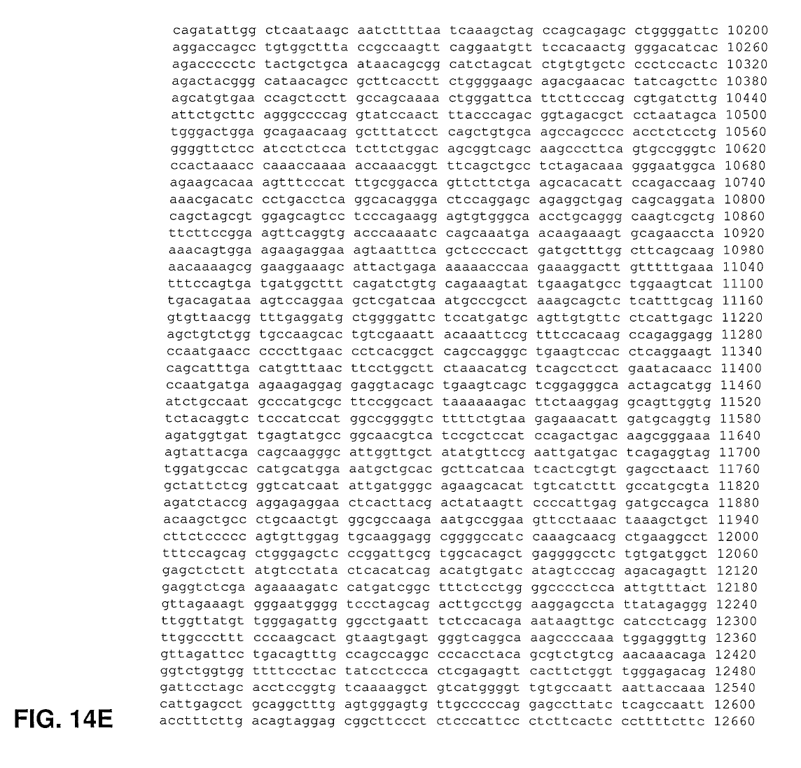

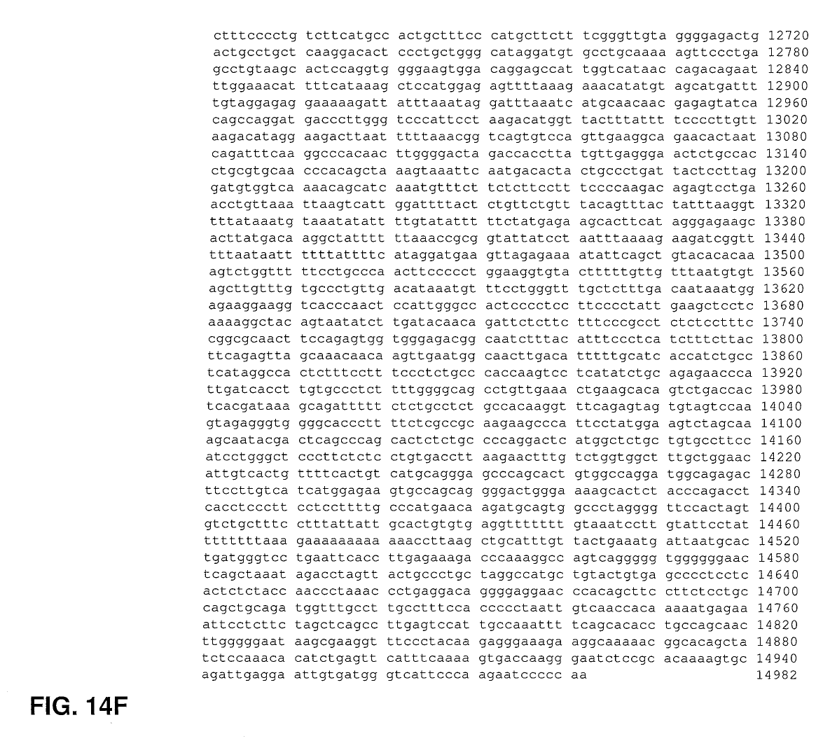

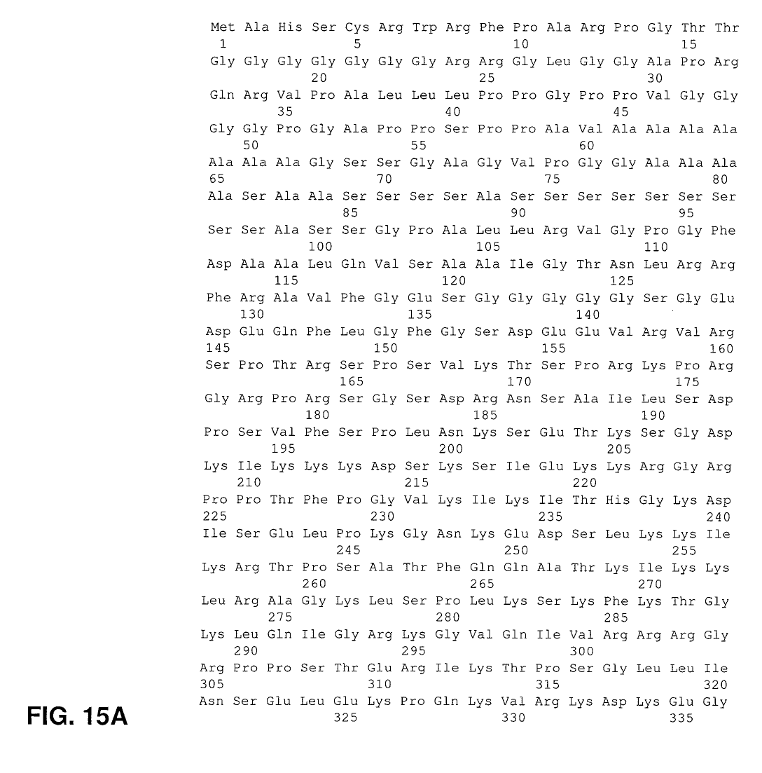

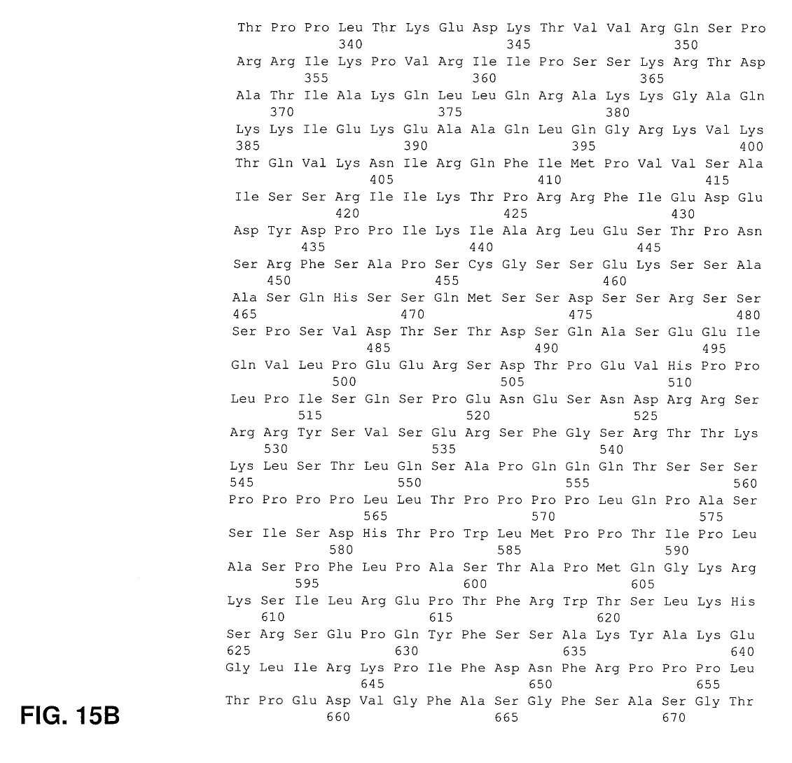

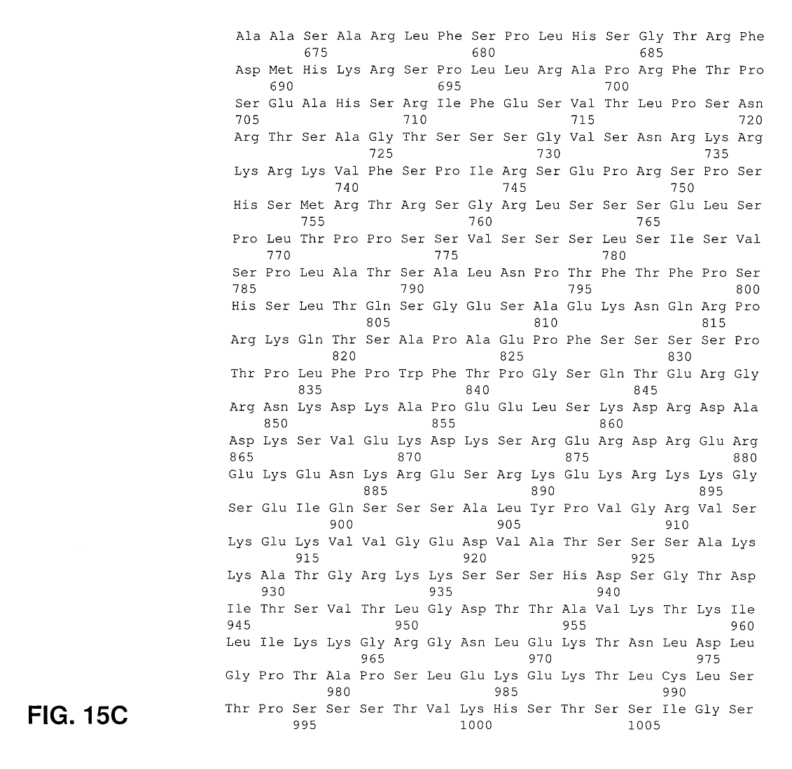

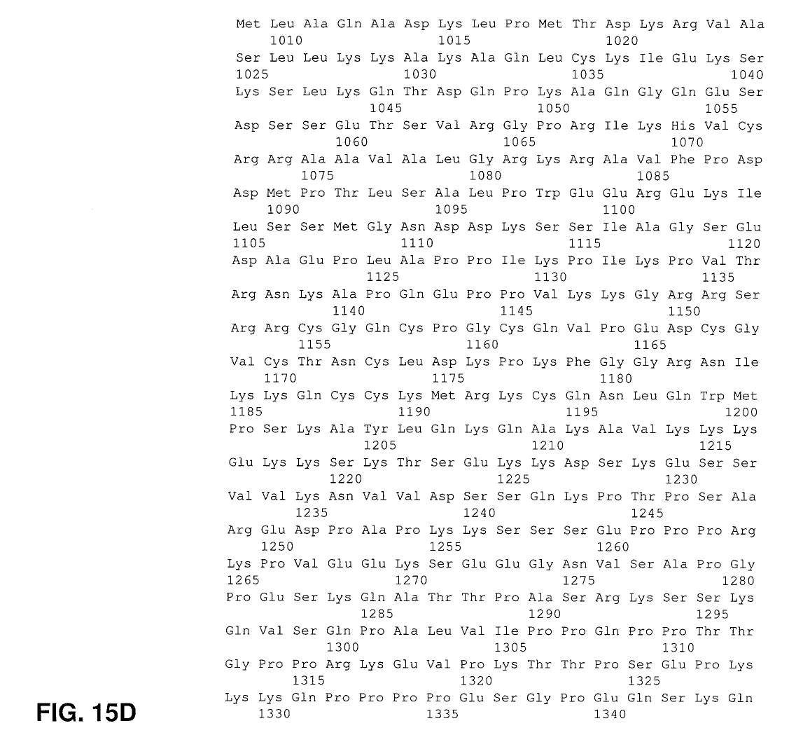

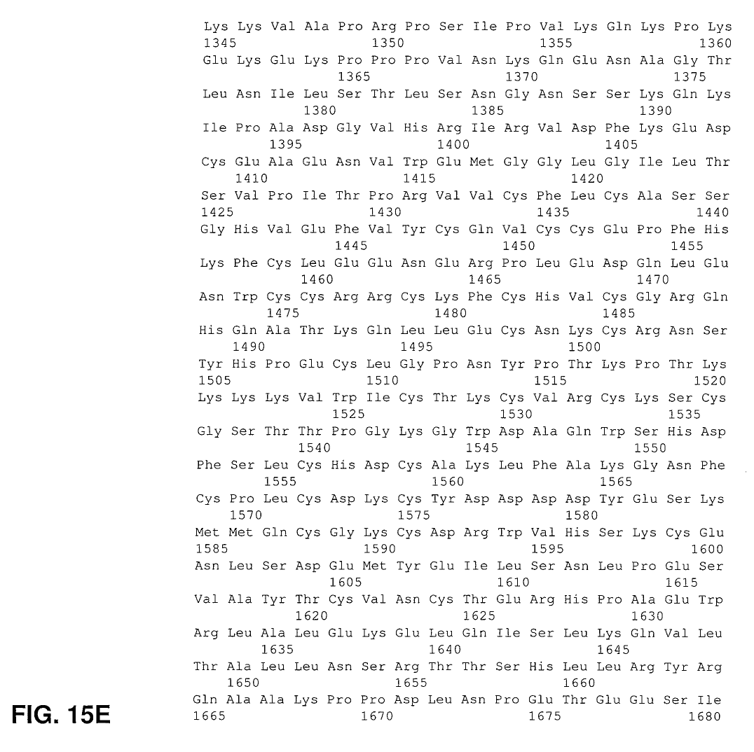

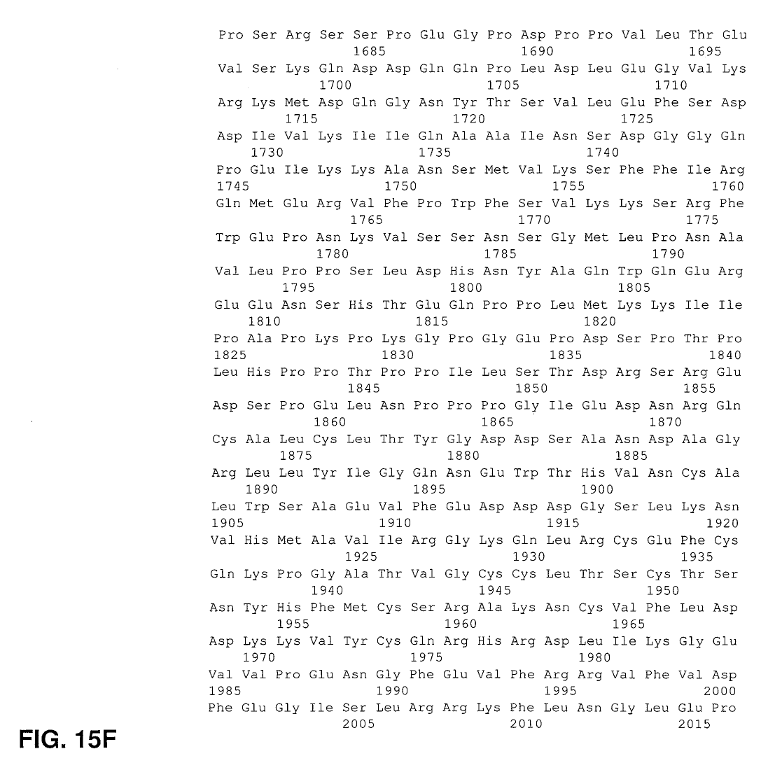

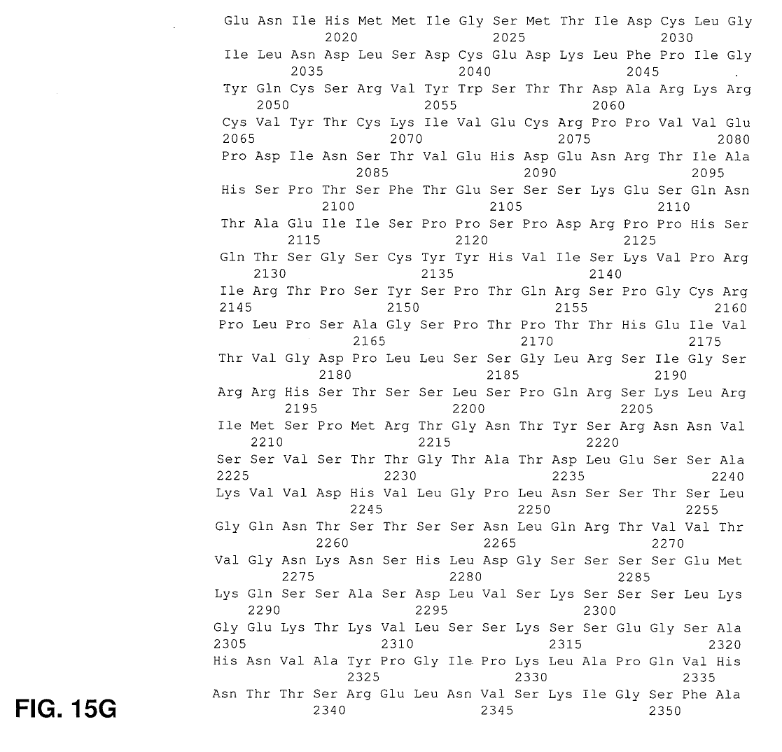

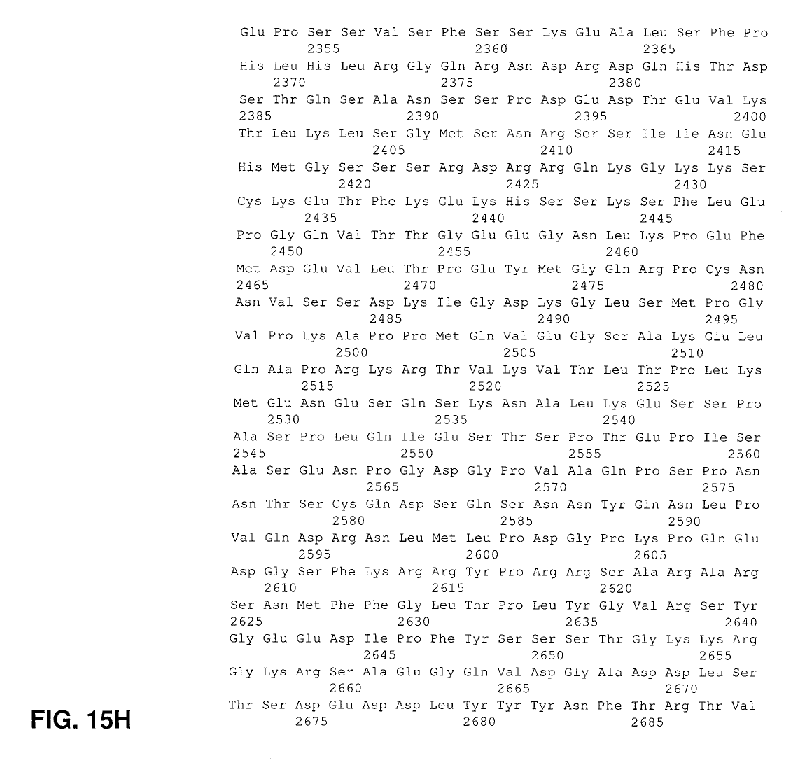

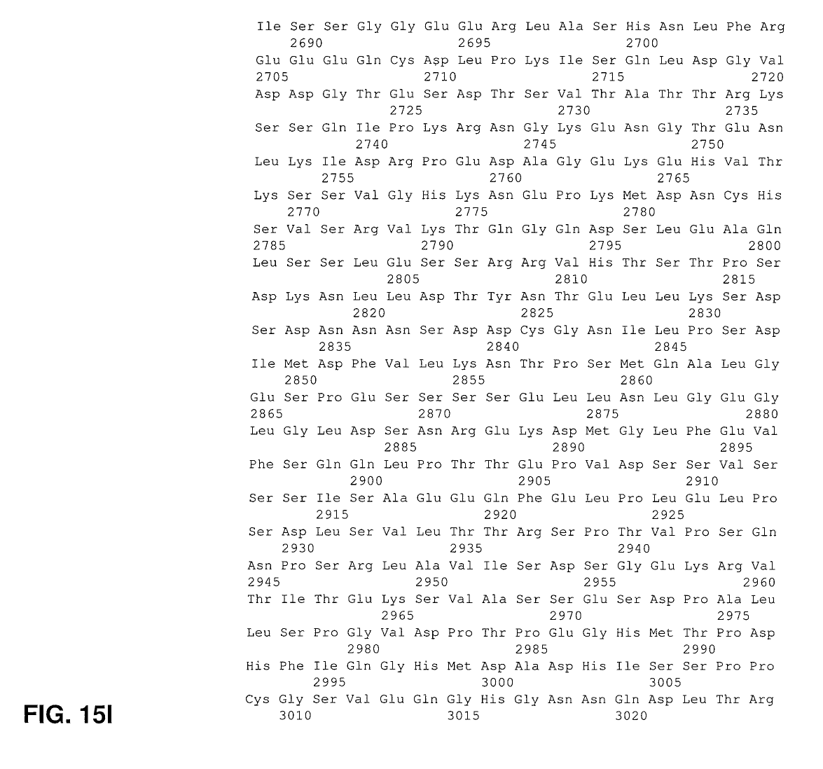

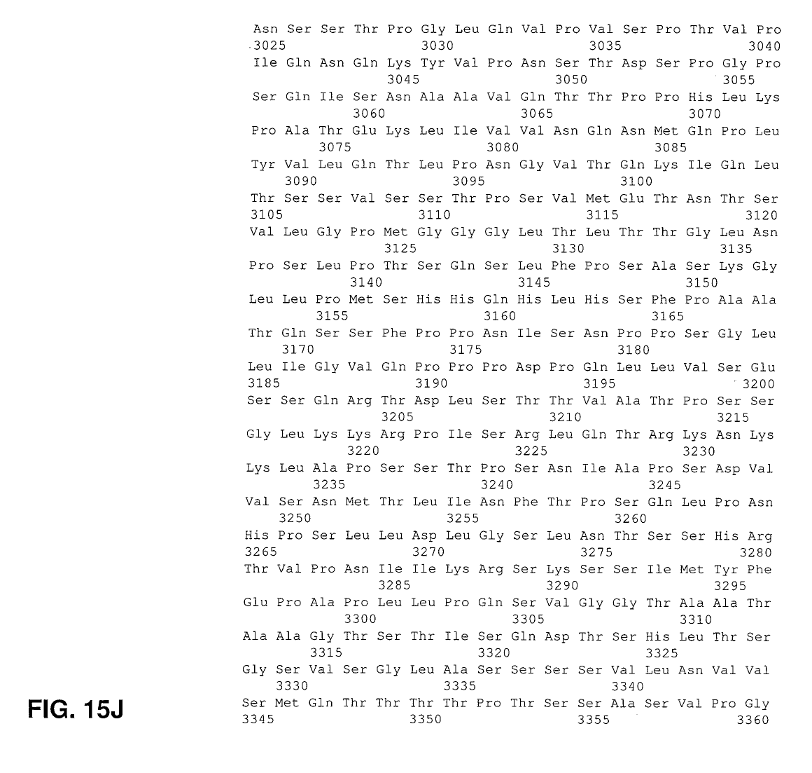

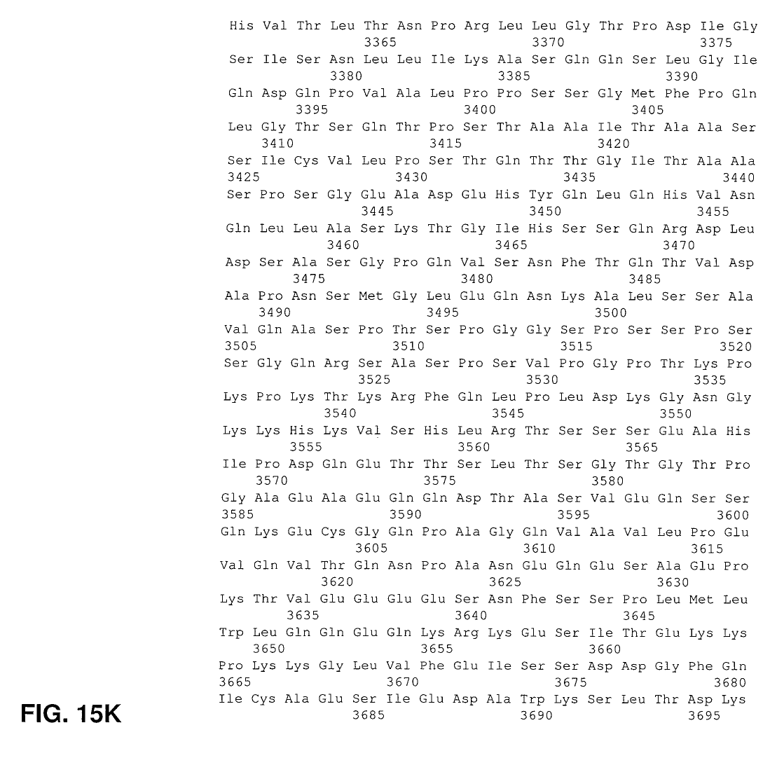

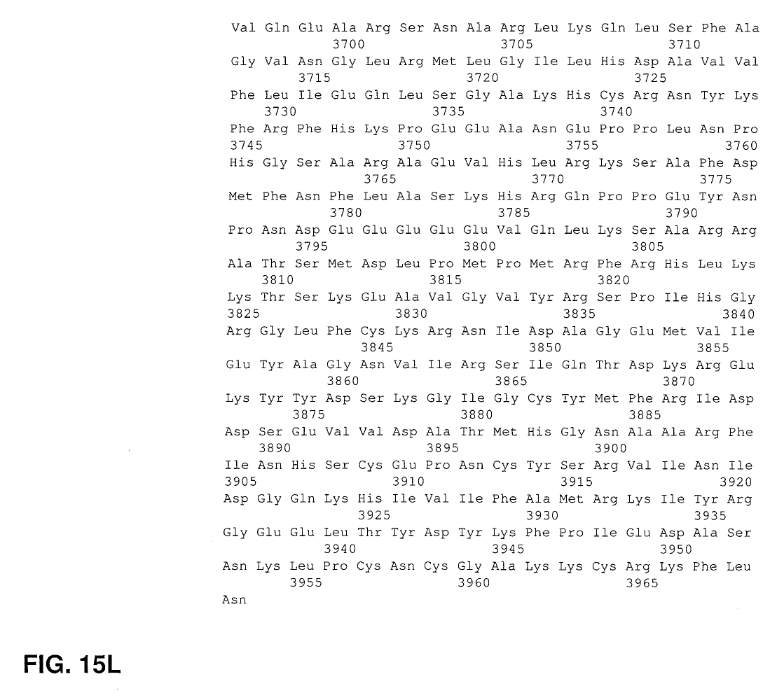

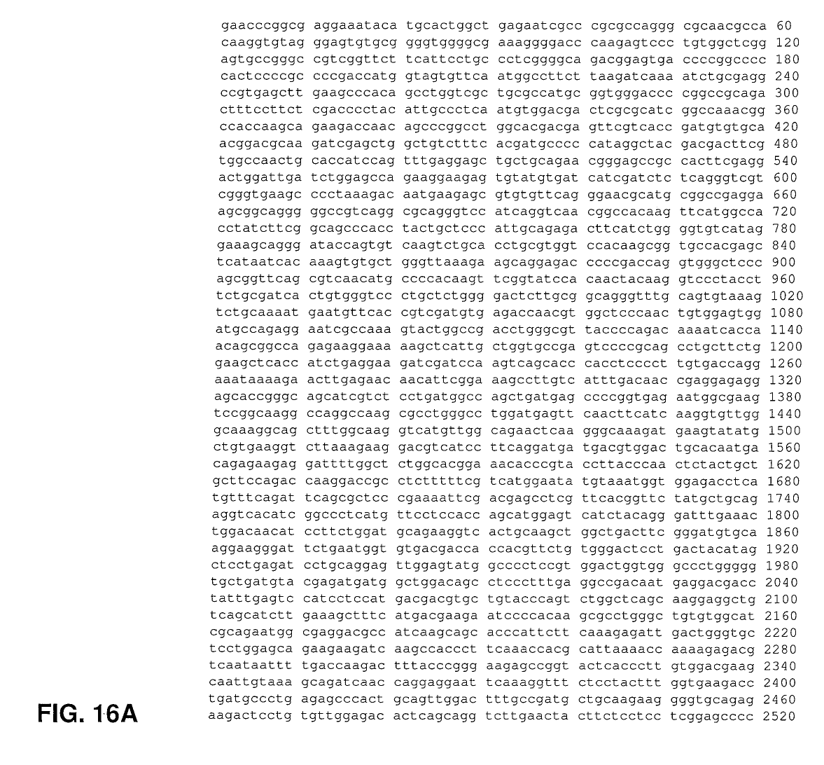

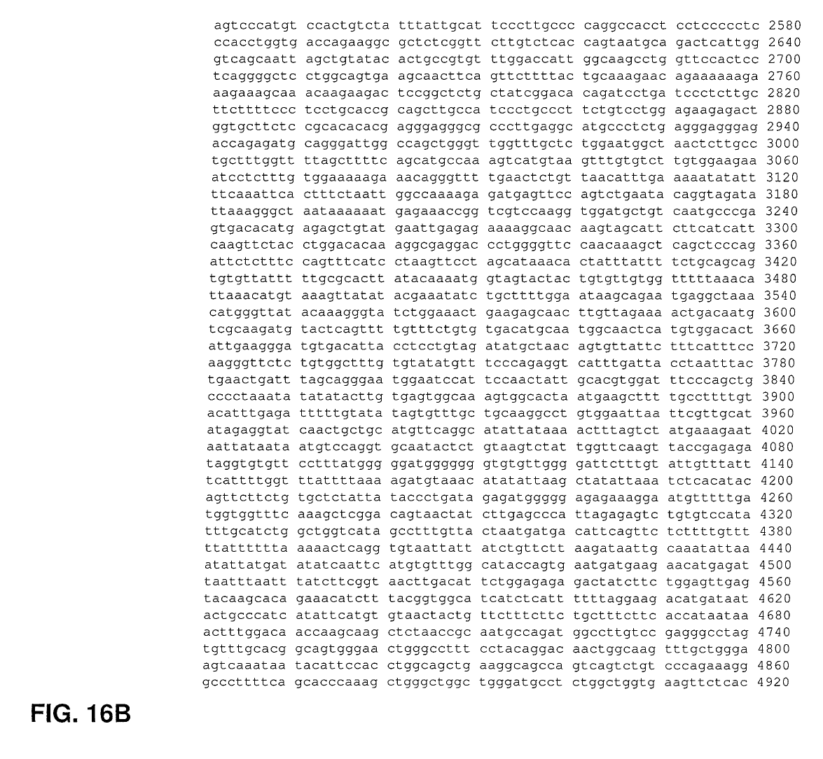

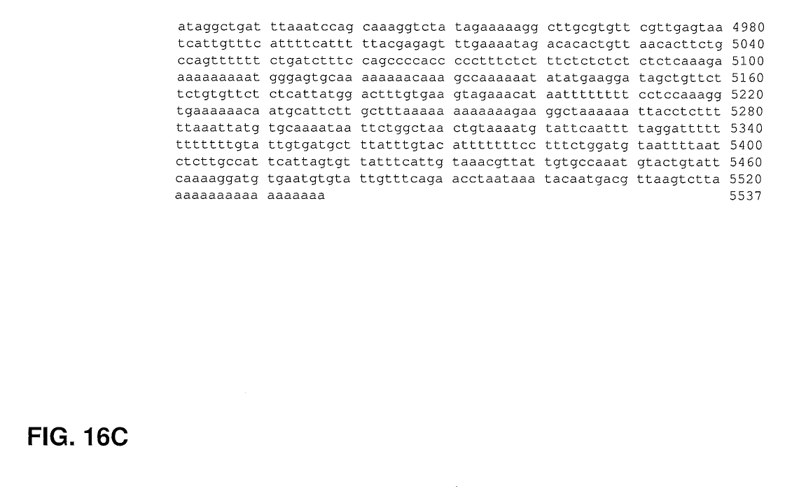

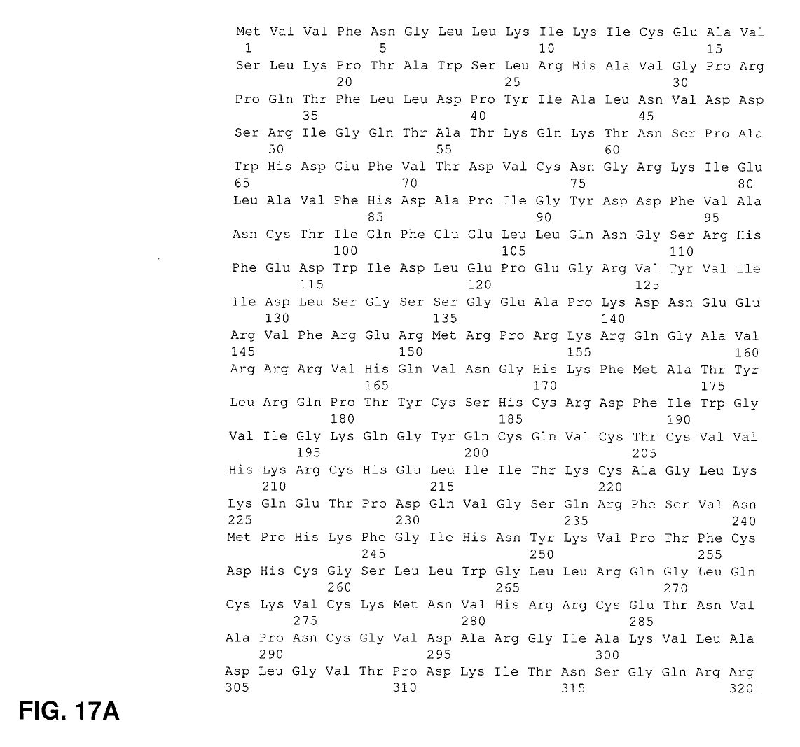

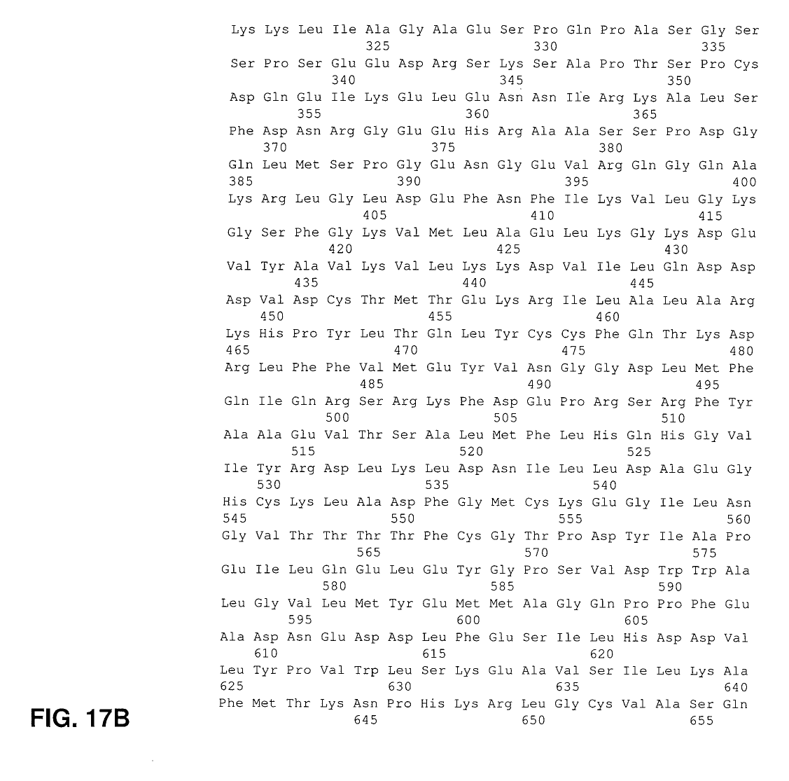

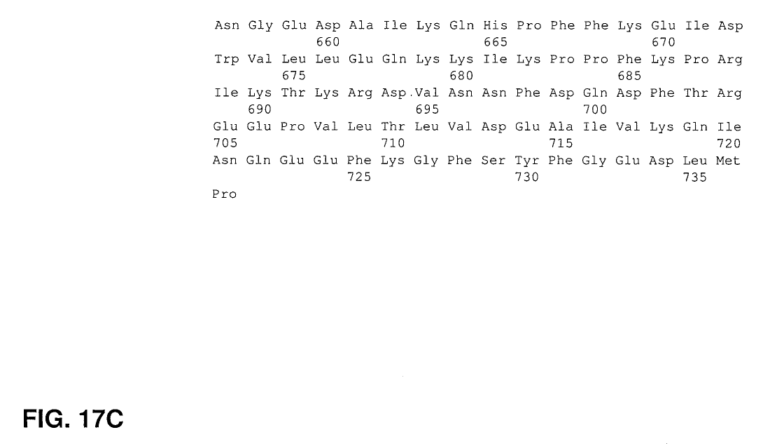

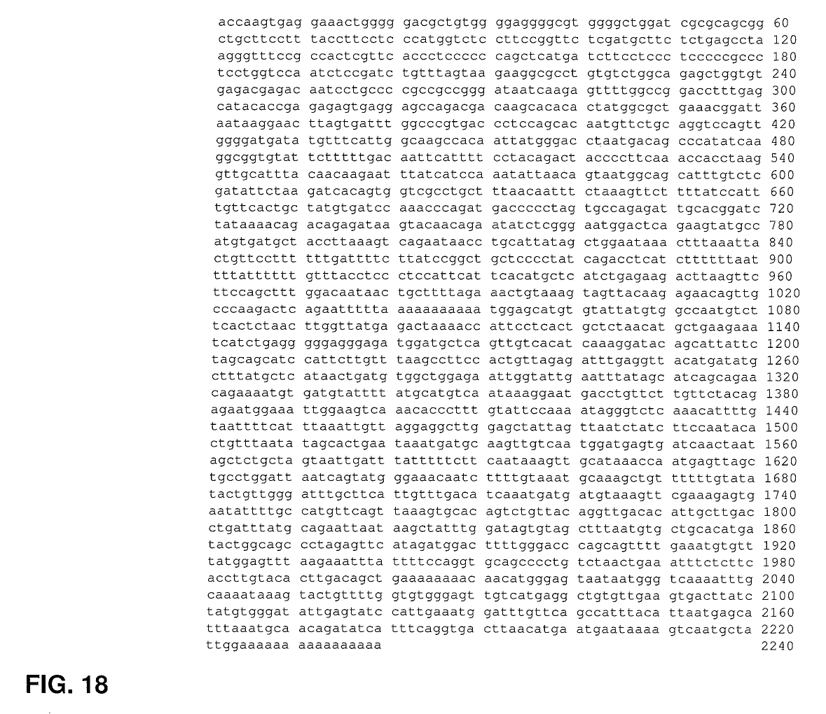

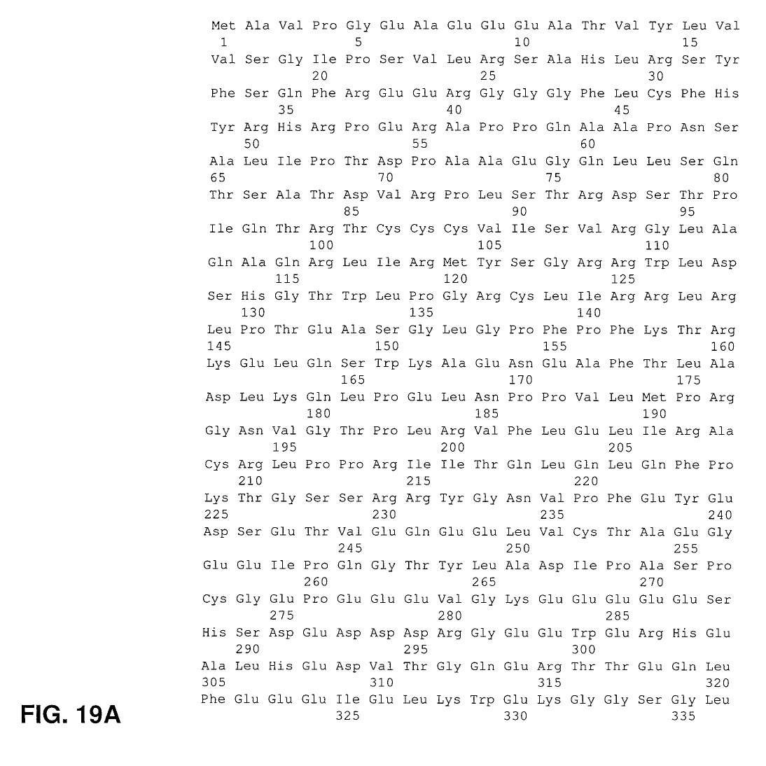

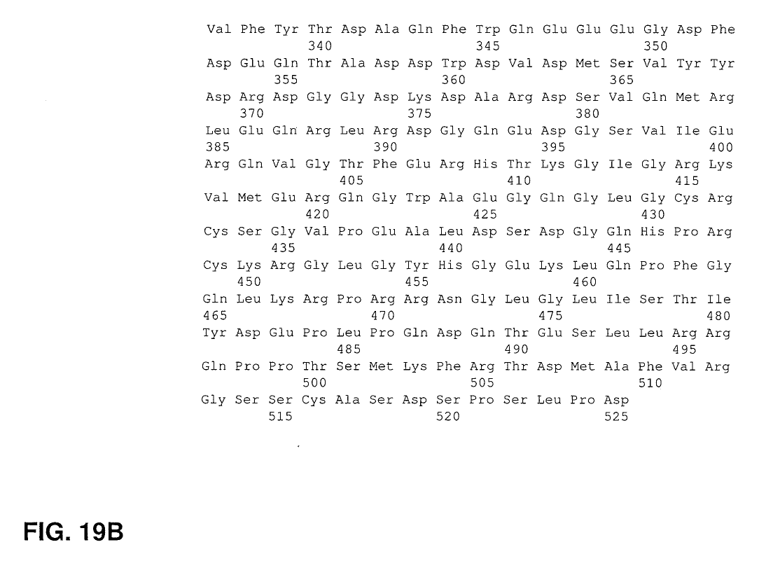

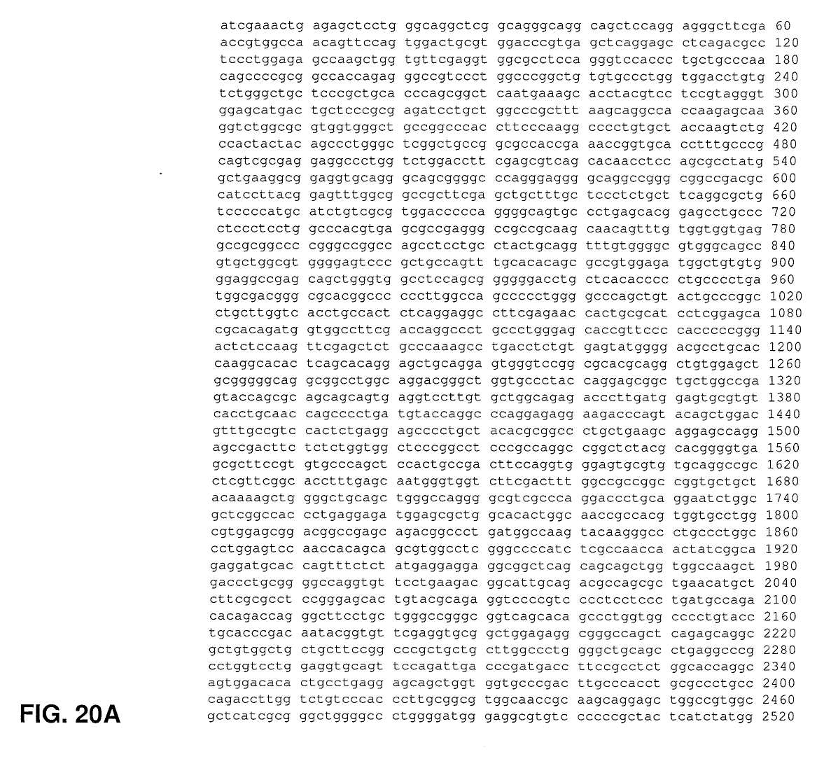

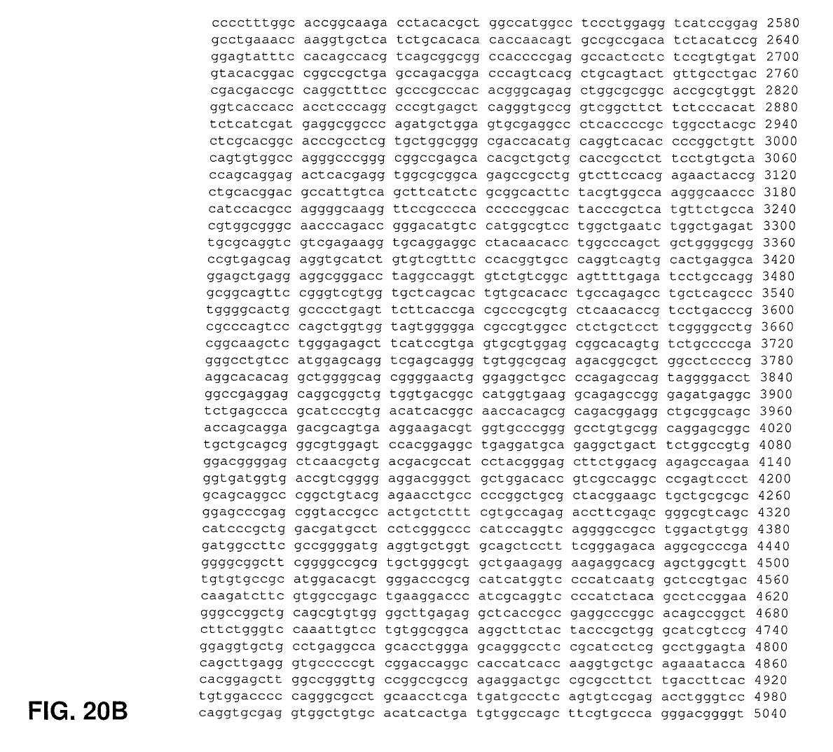

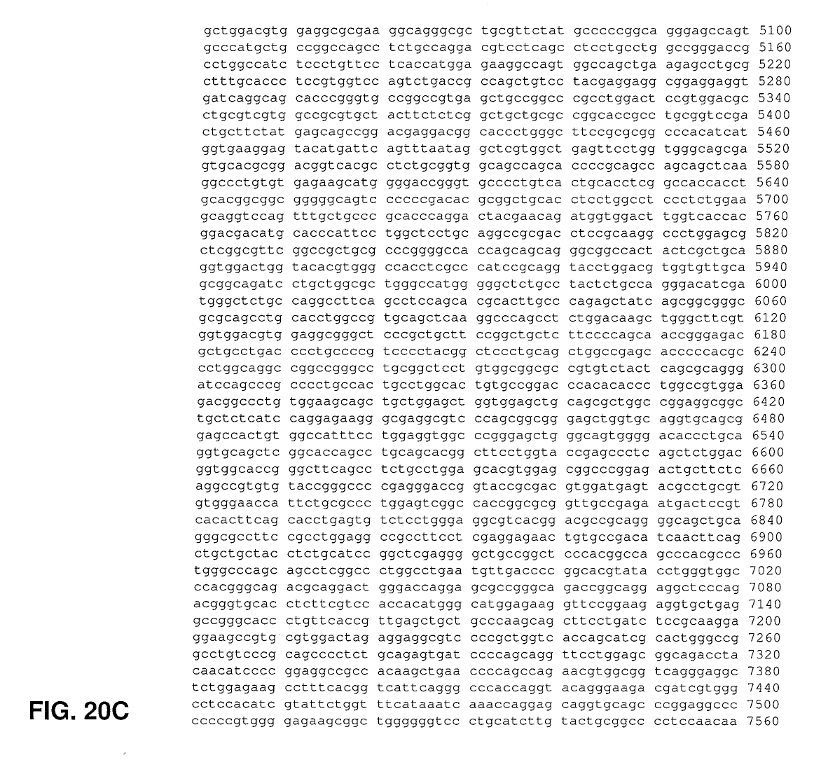

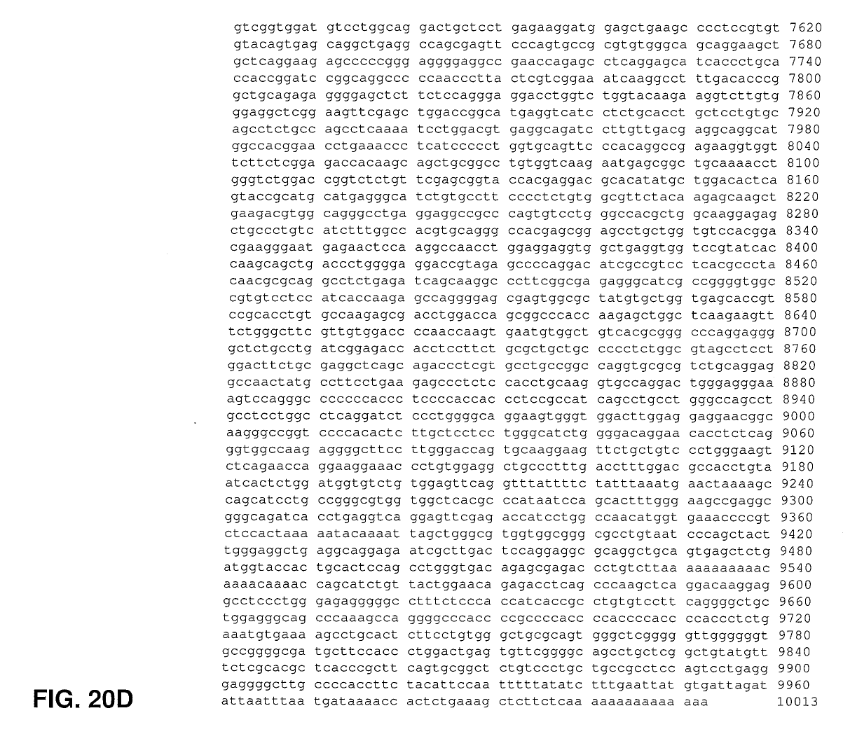

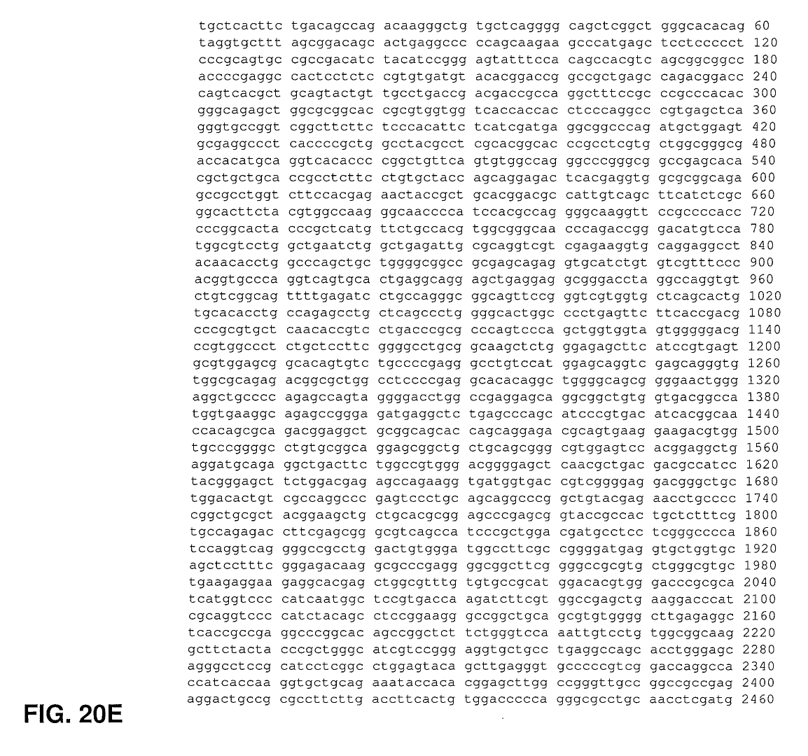

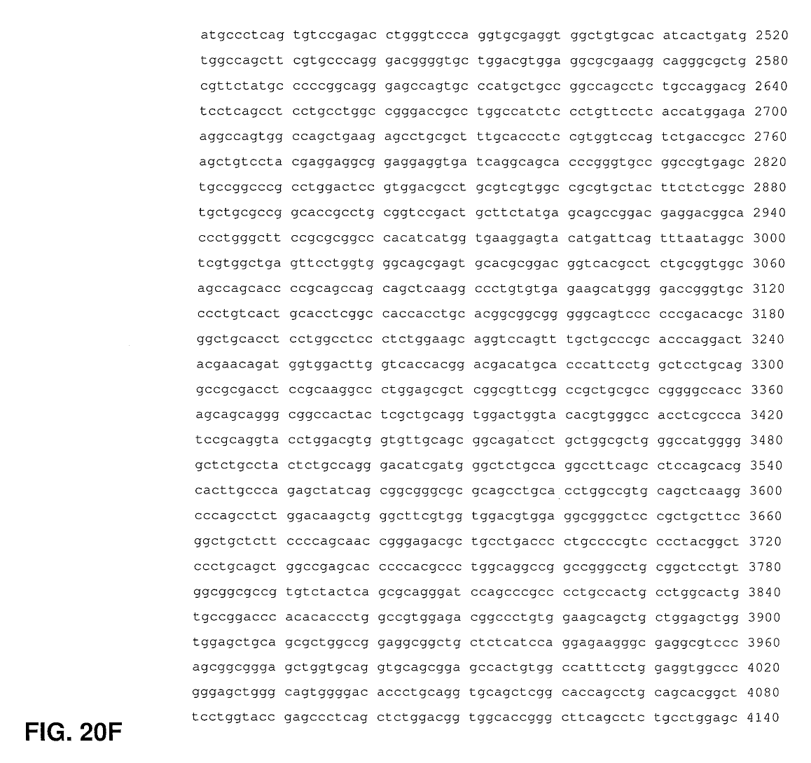

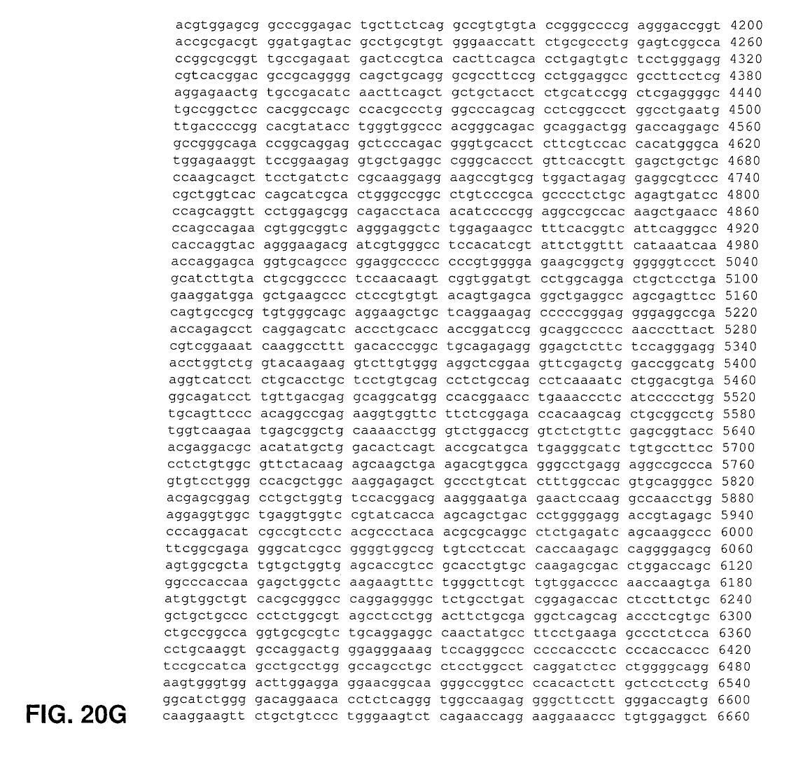

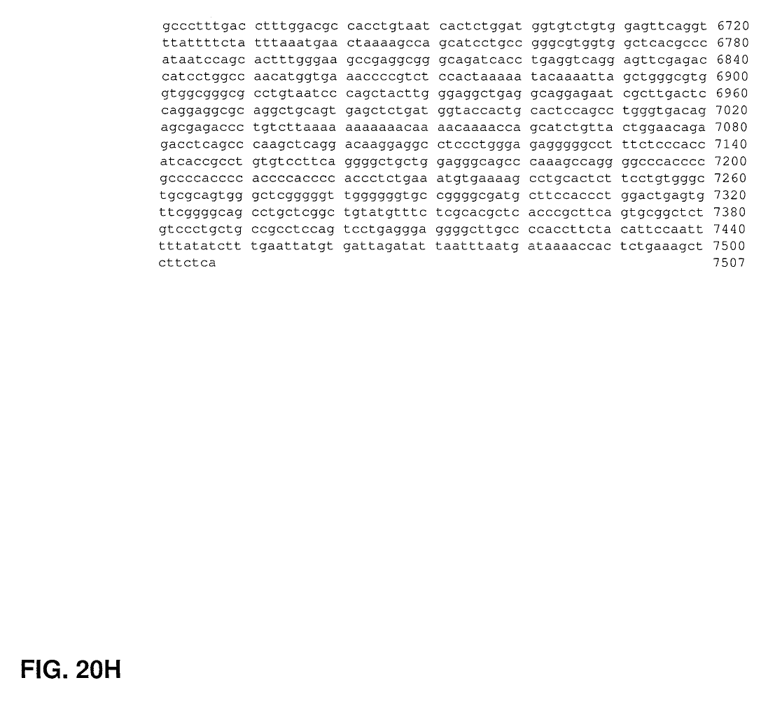

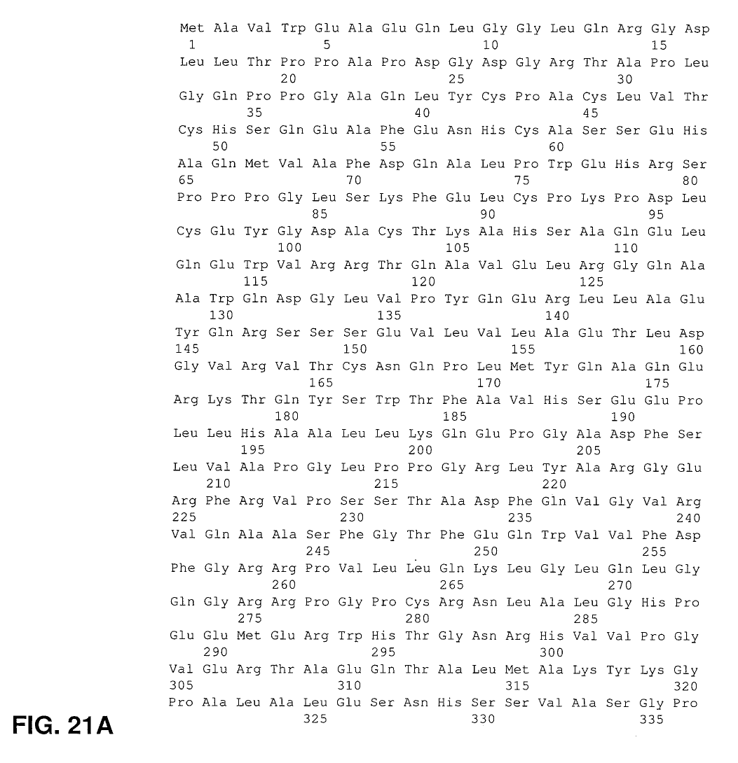

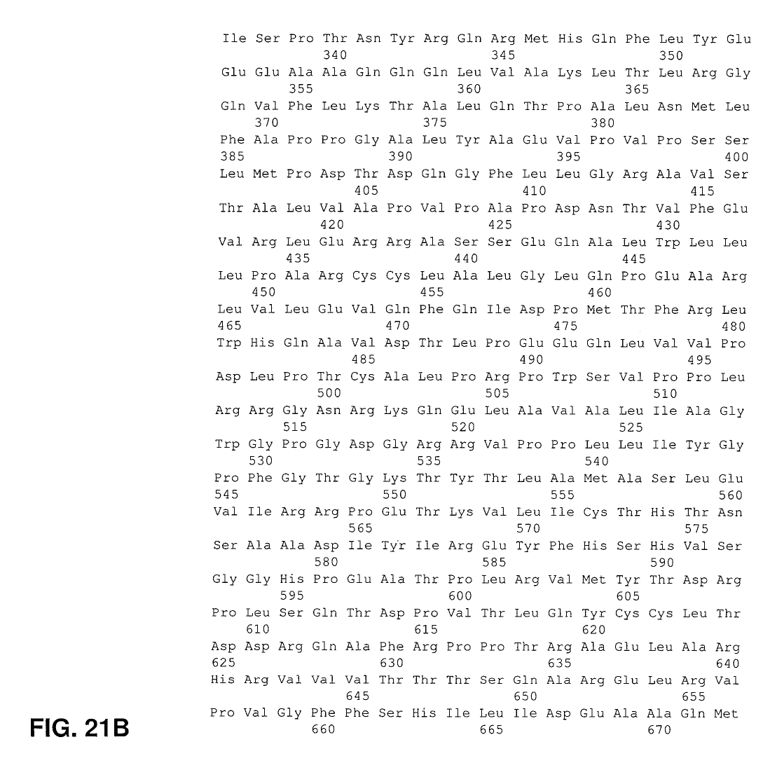

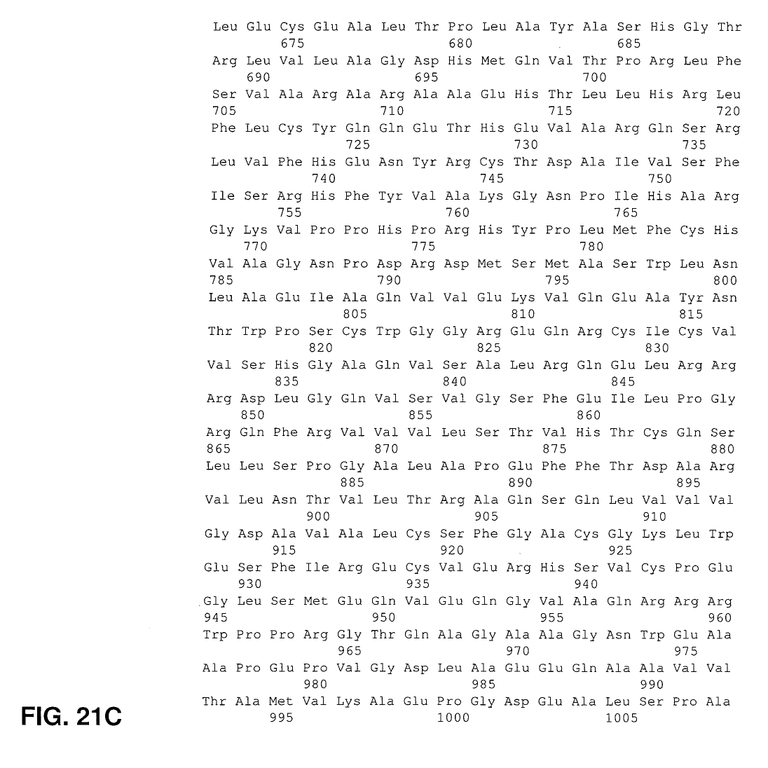

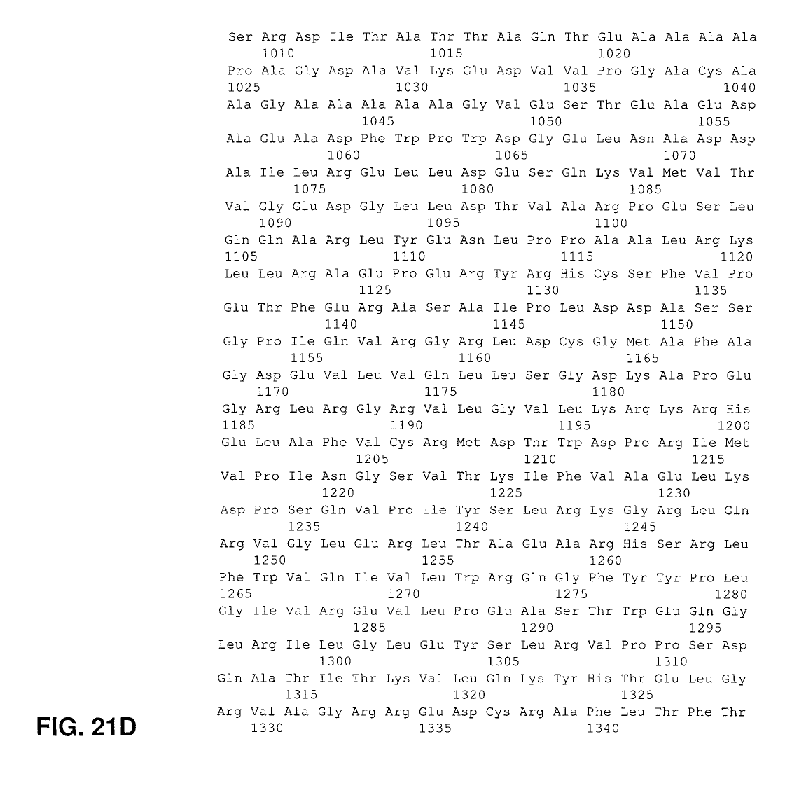

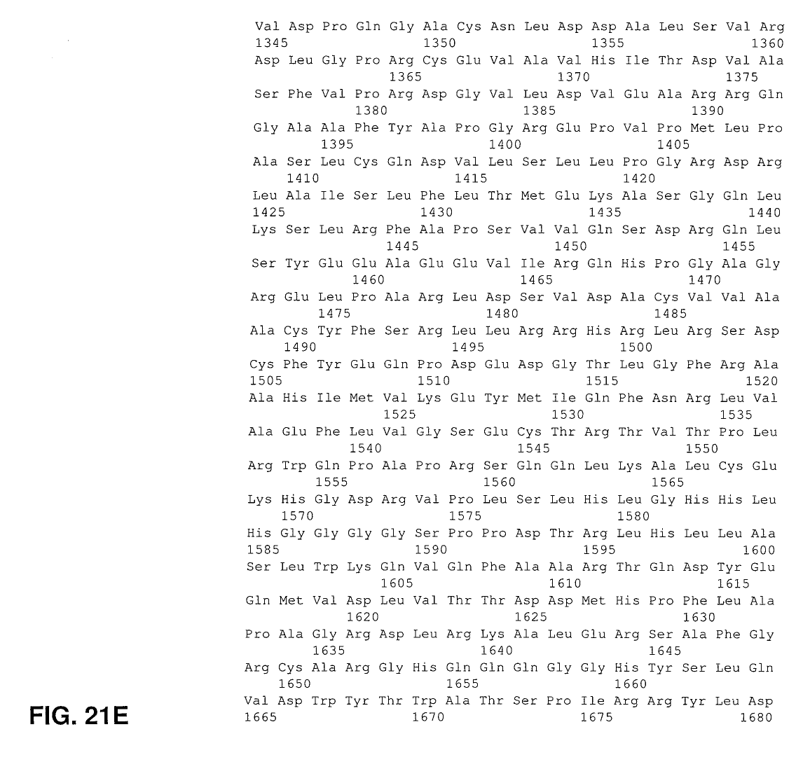

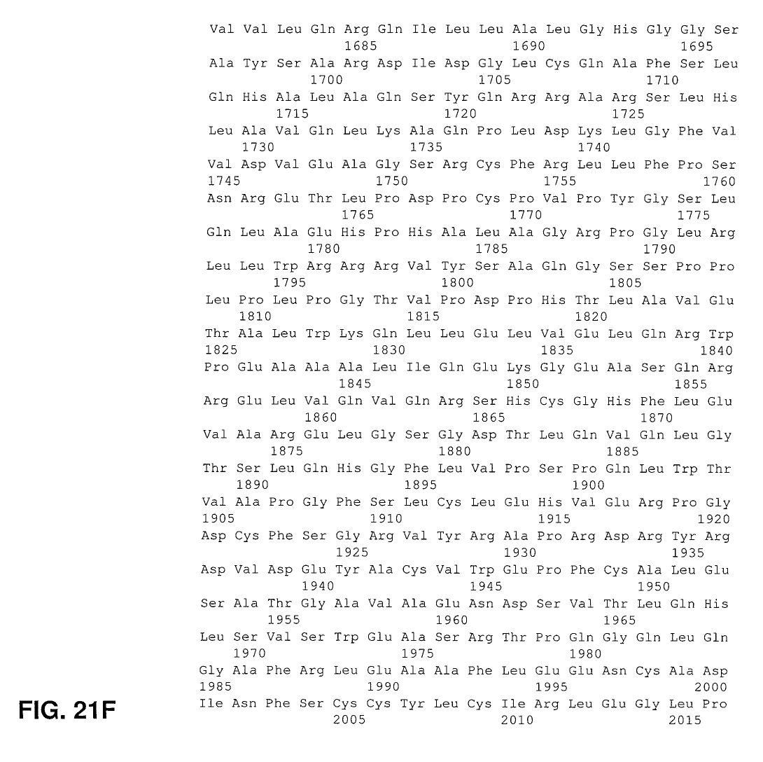

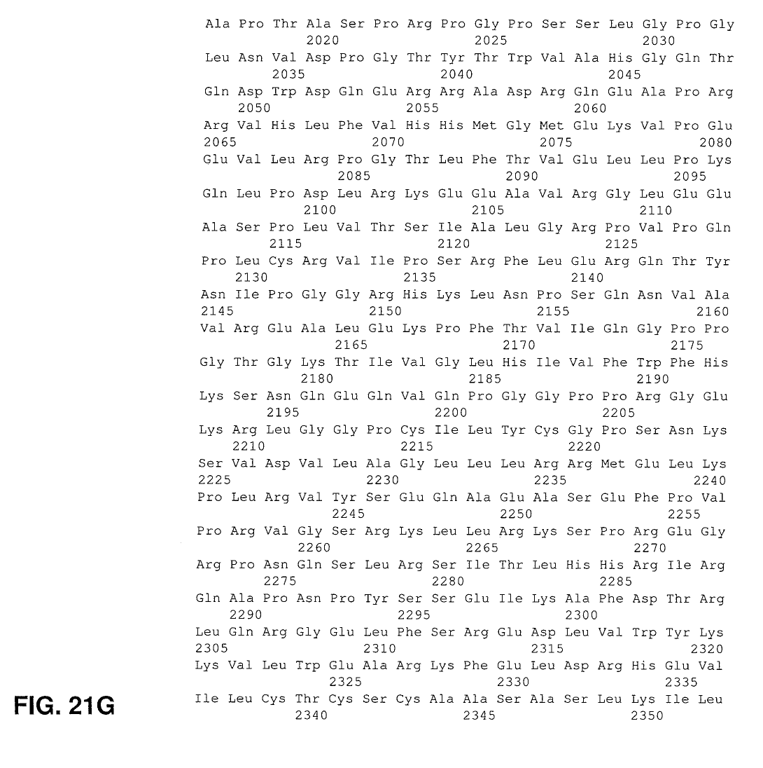

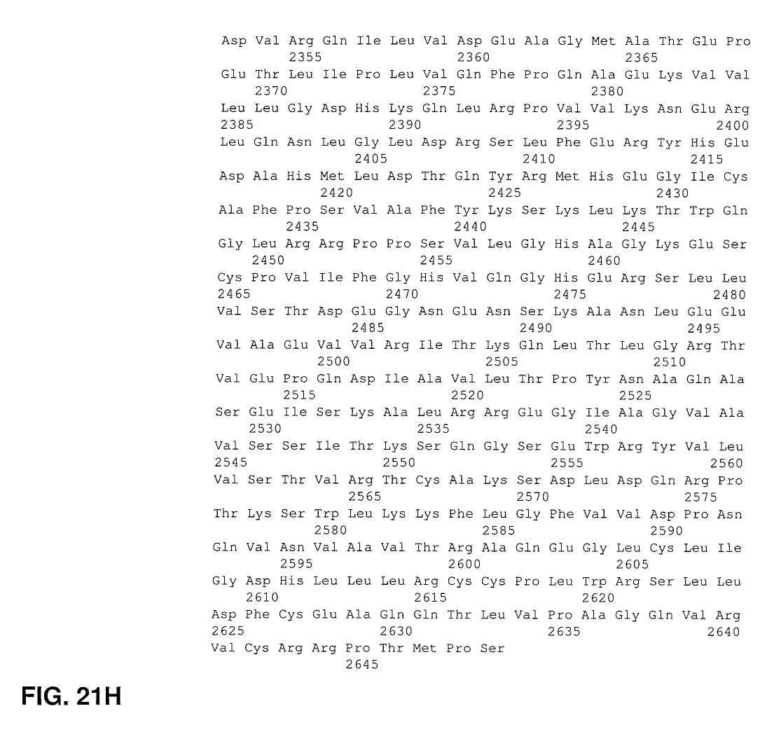

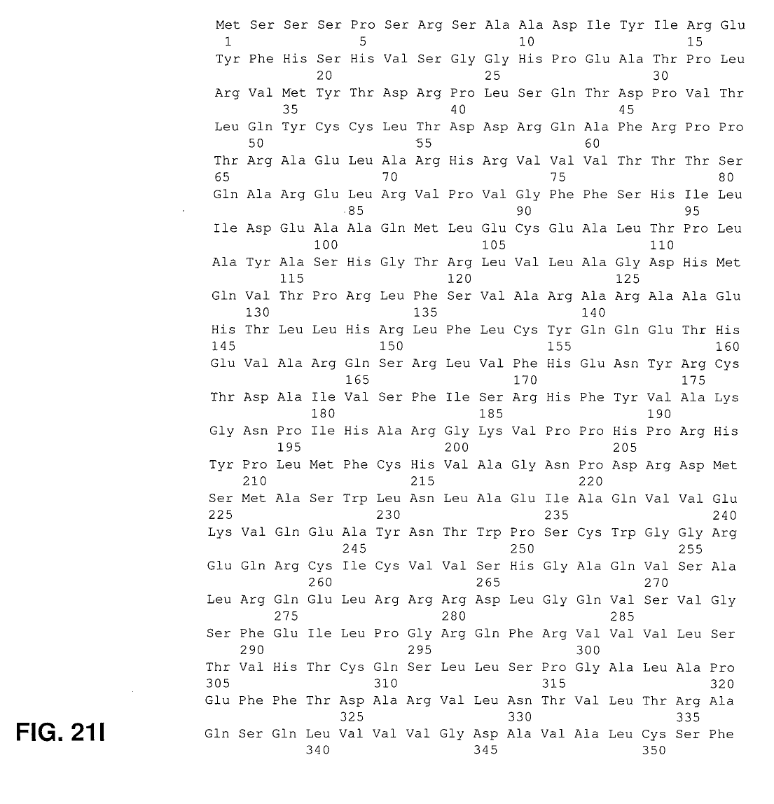

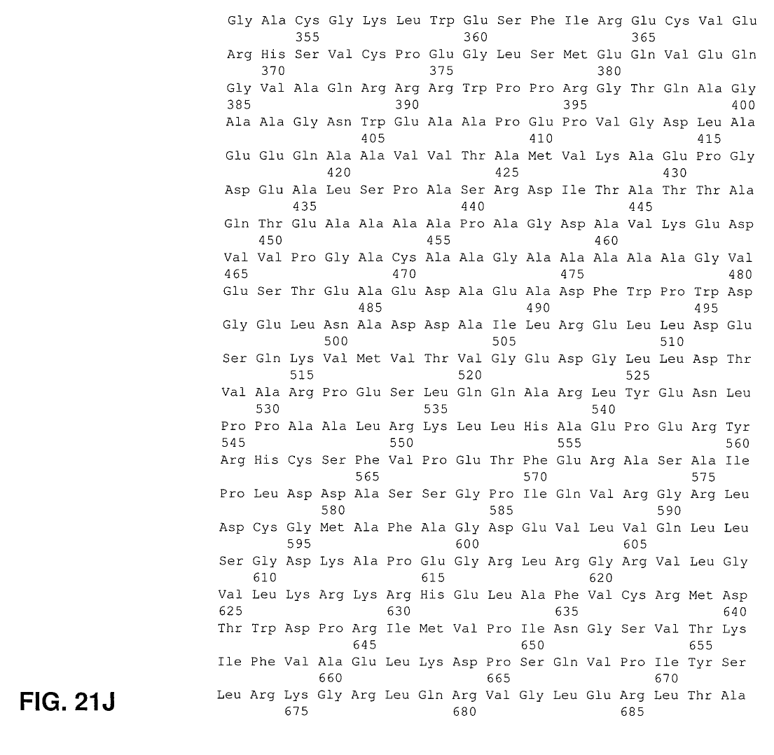

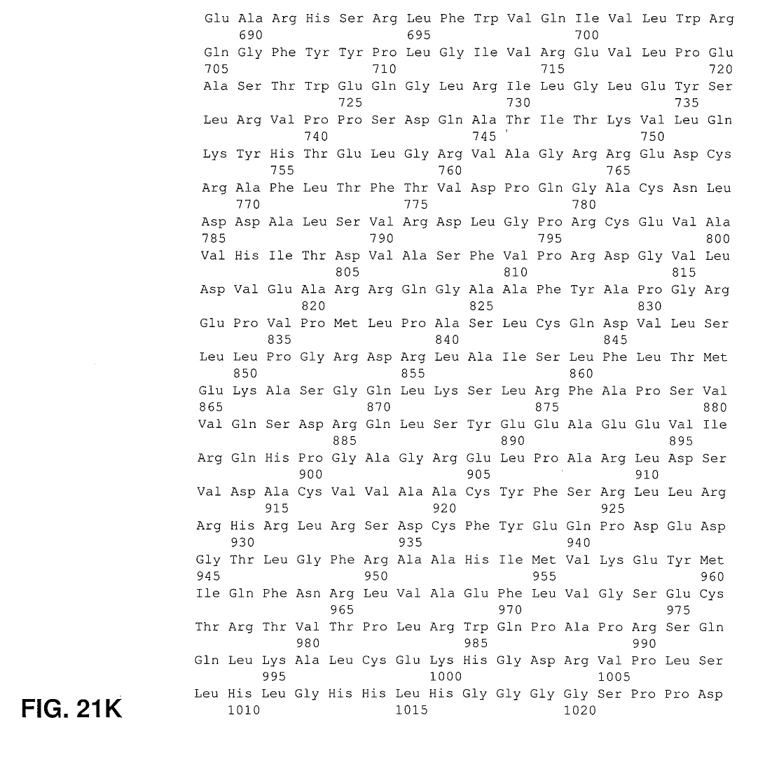

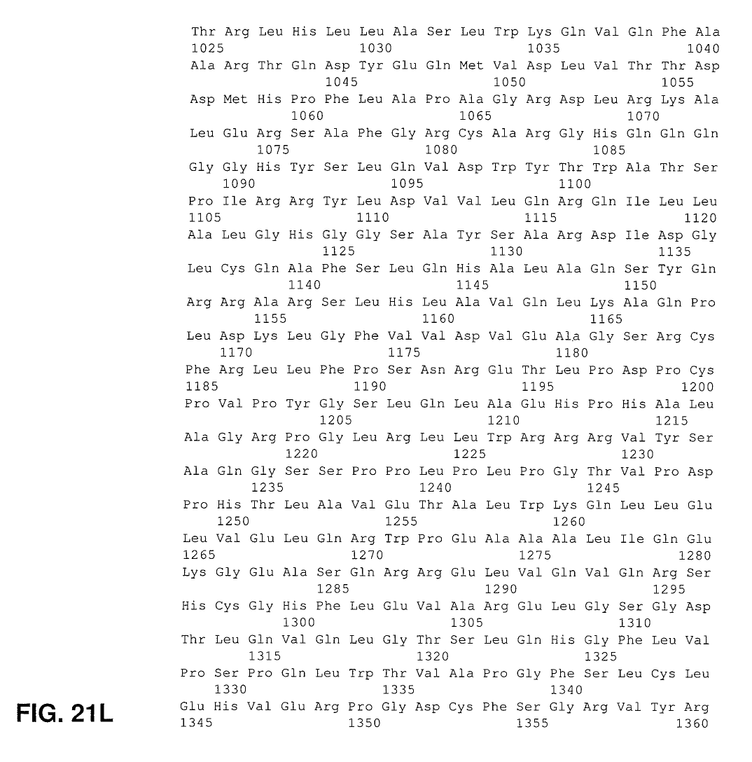

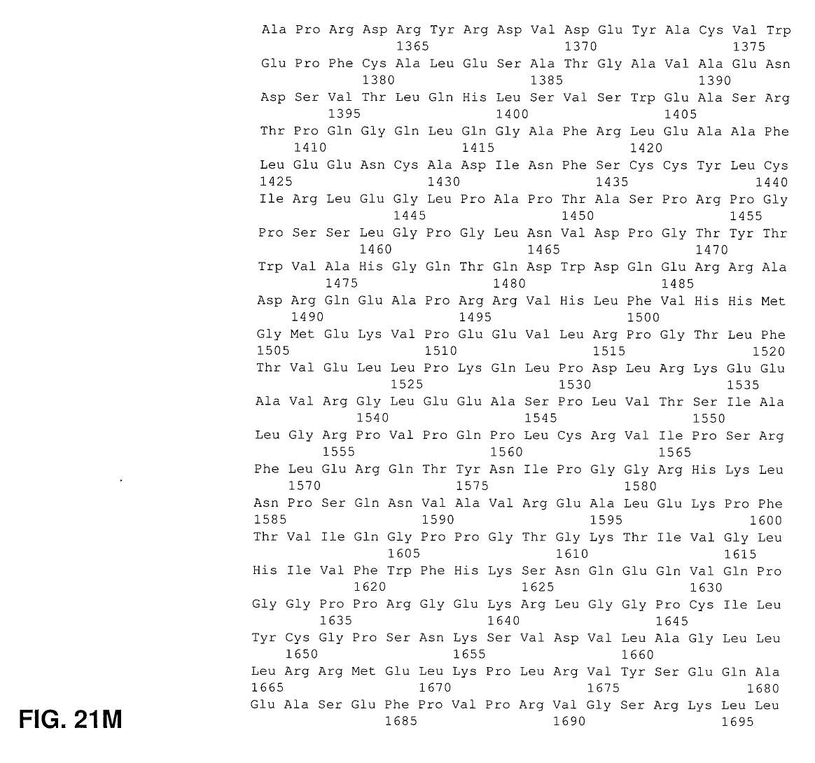

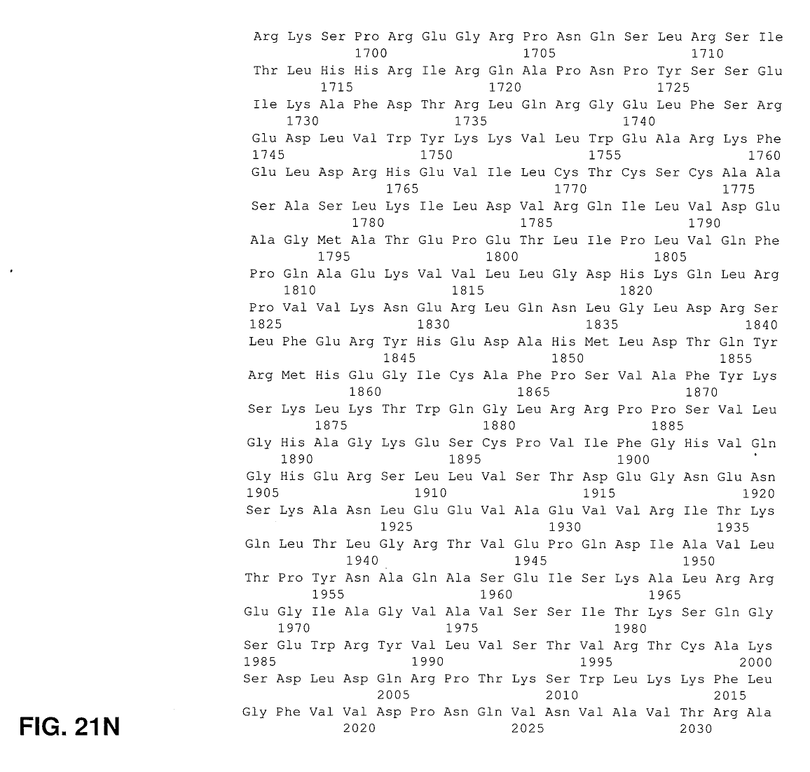

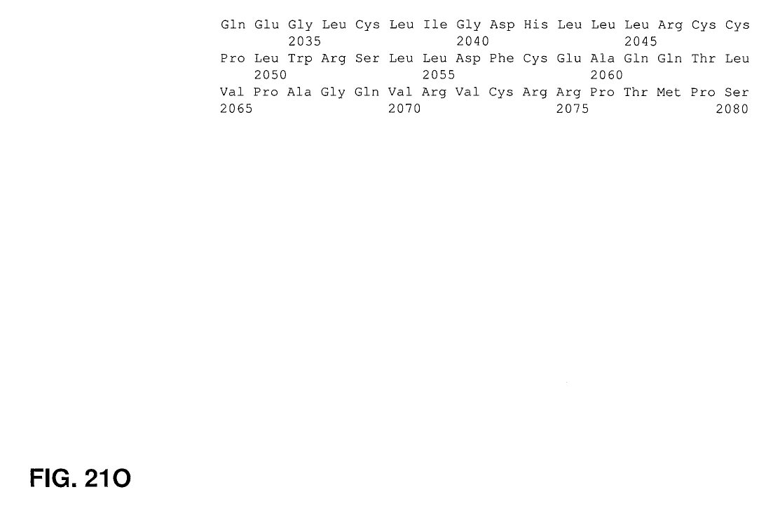

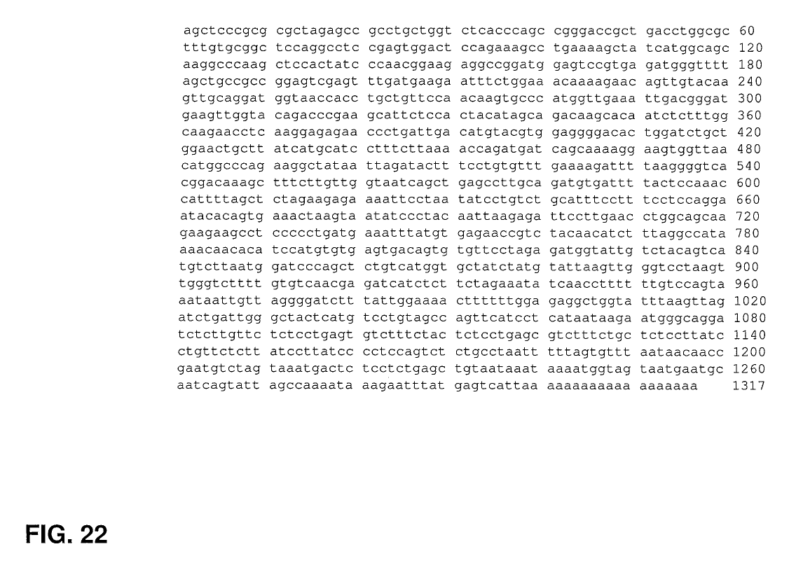

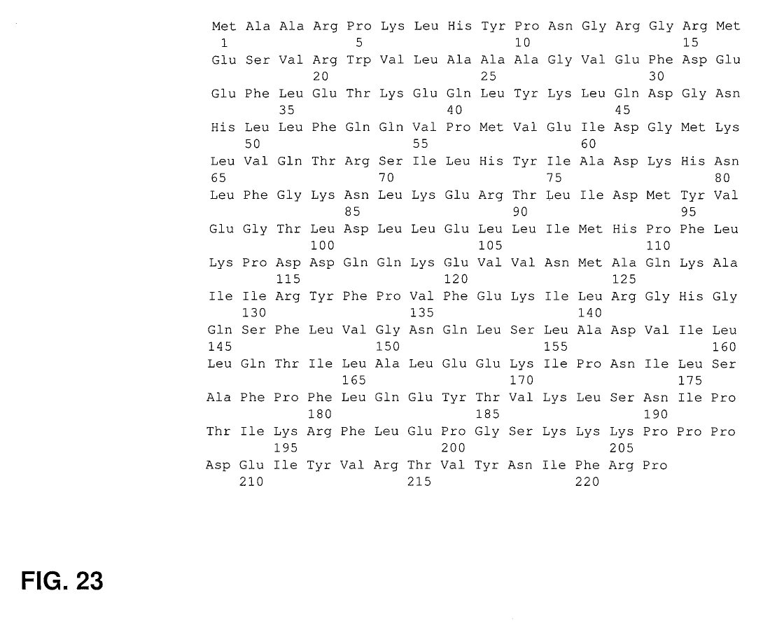

A third approach, similar to the second approach with the exception that SVM instead of LDA, was also applied to allow selection of the best fifty genes for a biomarker panel. Consistent with the first and second approach, PTCD2 was identified by SVM as the gene of the best accuracy from among the 2045 discriminative genes identified by LIMMA. The top fifty genes as identified by SVM are listed in Table 3. In FIG. 3, the accuracy, sensitivity and specificity of the biomarker panel was plotted as a function of the number of genes in the panel.

As shown in FIG. 3, the accuracy of the biomarker panel first increased from 0.746 (when the panel consisted of only PTCD2) to 0.928 (when the panel consisted of the top 18 genes) and then decreased to 0.900 (when the panel consisted of all the top fifty genes). Similar performance was observed in sensitivity and specificity. Thus, the performance of the biomarker panel identified by SVM was comparable to the performance of the panel identified by LDA, but much better than the performance of the panel identified by LIMMA or the performance of any individual genes.

TABLE 3
Top fifty genes identified by various methods.

| LIMMA | | LDA | | SVM | |
|---|---|---|---|---|---|
| Gene | Rank | Gene | Rank | Gene | Rank |
| ACAA2 | 1 | PTCD2 | 40 | PTCD2 | 40 |
| SLC25A20 | 2 | SYVN1 | 235 | FLJ40432 | 1335 |
| SREBF1 | 3 | MIPEP | 1435 | STX5A | 910 |
| TMEM63A | 4 | PRKCE | 1052 | PDE7A | 15 |
| ARL16 | 5 | LOC284184 | 1448 | PRKCE | 1052 |
| PRO1580 | 6 | ANKRD16 | 1680 | MTMR11 | 681 |
| RASGRP2 | 7 | C8orf16 | 1453 | TNPO1 | 2003 |
| C19orf6 | 8 | ATF7IP2 | 1660 | MGC3731 | 1358 |
| STX16 | 9 | PRIC285 | 1418 | FKBP5 | 680 |
| MLLT6 | 10 | MGA | 221 | C3orf62 | 1331 |
| C1orf71 | 11 | SLC25A20 | 2 | IRS2 | 472 |
| ENTPD4 | 12 | FN3KRP | 822 | GPATC3 | 1871 |
| DGKA | 13 | HPS4 | 1946 | SUSD1 | 926 |
| PPP6C | 14 | HIST1H1D | 1419 | CCM2 | 1220 |
| PDE7A | 15 | CREM | 1974 | ZBTB7A | 1968 |
| RUTBC1 | 16 | CPSF4 | 477 | RAB11A | 893 |
| PRPF3 | 17 | GPATC3 | 1871 | GSDML | 1389 |
| MBTD1 | 18 | FLJ23235 | 695 | MAPK9 | 1657 |
| SPG7 | 19 | STX6 | 1287 | MGC35402 | 173 |
| TNFRSF25 | 20 | SCCPDH | 912 | DRG2 | 1348 |
| PDK4 | 21 | GSTA4 | 317 | TMEM80 | 309 |
| MS4A4A | 22 | MRPL4 | 1175 | PDZD8 | 668 |
| TBC1D10C | 23 | LRCH1 | 1192 | LOC339804 | 1495 |
| MGC10471 | 24 | NFKB2 | 28 | PPARD | 561 |
| FAM73B | 25 | UBXD4 | 1551 | DDIT3 | 942 |
| SF1 | 26 | USP40 | 374 | FAM113A | 443 |
| MTA1 | 27 | CCT5 | 1652 | RHBDD3 | 1614 |
| NFKB2 | 28 | ANKRD44 | 647 | TIMM44 | 708 |
| FLAD1 | 29 | FBF1 | 1517 | ATP6AP2 | 1243 |
| COPS7B | 30 | MRPL40 | 2045 | ME2 | 901 |
| CSTA | 31 | TNFAIP2 | 1947 | ATHL1 | 379 |
| MGC42174 | 32 | CLCN7 | 1750 | PRIC285 | 1418 |
| ARRDC2 | 33 | HSP90AB1 | 1537 | TNFSF14 | 754 |
| VAMP1 | 34 | RASGRP2 | 7 | ABCA2 | 906 |
| C16orf58 | 35 | REEP5 | 386 | EML2 | 1894 |
| TMEM55B | 36 | LOC643641 | 536 | Magmas | 1021 |
| NAT9 | 37 | KLRD1 | 1115 | EVI2A | 1394 |
| LIMD1 | 38 | PFDN2 | 1986 | USP37 | 1017 |
| TNFRSF10A | 39 | UFC1 | 1390 | GATAD1 | 1083 |
| PTCD2 | 40 | C9orf6 | 1481 | CHN2 | 913 |
| ZDHHC8 | 41 | TOP3A | 1789 | PSCD4 | 447 |
| STX12 | 42 | AUP1 | 165 | ZNF669 | 74 |
| RXRB | 43 | DDX11 | 1610 | PRSS23 | 301 |
| MLL | 44 | COX7A2 | 1282 | CHTF18 | 1877 |
| WDR39 | 45 | C18orf22 | 350 | GSTA4 | 317 |
| ZC3H12A | 46 | ZNF236 | 1588 | SFRS8 | 689 |
| FLJ21106 | 47 | CALML4 | 481 | DICER1 | 385 |
| KLHDC3 | 48 | DEF6 | 771 | PIAS1 | 1492 |
| NOL9 | 49 | SLC25A19 | 1473 | SNRP70 | 67 |
| WDR73 | 50 | PLCB2 | 1183 | MLL | 44 |

The ranks shown are based on LIMMA method.

As shown in Table 3, the fifty markers selected by each of the three approaches were quite different. Only PTCD2 was selected by all three approaches. Four genes (PTCD2, SLC25A20, NFKB2 and RASGRP2) were selected by both LIMMA and LDA, three (PTCD2, PDE7A and MLL) by LIMMA and SVM, and five (PTCD2, PRKCE, GPATC3, PRIC285 and GSTA4) by LDA and SVM. All other genes were unique to each individual approach. This observation suggests that the selection of individual markers to a marker panel is quite sensitive to the approach used in the selection process. It also indicates that different marker combinations may give similar performance in the discrimination of cancer cases from control cases. As such, a variety of combinations of biomarkers present in Table 2 are useful for the detection and diagnosis of breast cancer.

Thus, this Example shows the identification of individual biomarkers that can be used for the detection of breast cancer and further identifies panels comprising combinations of these biomarkers that result in high specificity and sensitivity for breast cancer diagnostics. This example also demonstrates that a variety of combinations of biomarkers present in Table 2, other than the combinations identified in Table 3, are useful for the detection and diagnosis of breast cancer.

All of the U.S. patents, U.S. patent application publications, U.S. patent applications, foreign patents, foreign patent applications and non-patent publications referred to in this specification and/or listed in the Application Data Sheet, are incorporated herein by reference, in their entirety.

From the foregoing it will be appreciated that, although specific embodiments of the invention have been described herein for purposes of illustration, various modifications may be made without deviating from the spirit and scope of the invention. Accordingly, the invention is not limited except as by the appended claims.

### Other Embodiments

It is to be understood that while the invention has been described in conjunction with the detailed description thereof, the foregoing description is intended to illustrate and not limit the scope of the invention, which is defined by the scope of the appended claims. Other aspects, advantages, and modifications are within the scope of the following claims.

What is claimed is:

1. A plurality of polynucleotides, wherein the plurality consists of polynucleotides that bind specifically to nucleic acids encoding no more than 100 breast cancer markers, wherein the breast cancer markers comprise PTCD2, SLC25A20, NFKB2 and RASGRP2.

2. A plurality of polynucleotides, wherein the plurality consists of polynucleotides that bind specifically to nucleic acids encoding no more than 100 breast cancer markers, wherein the breast cancer markers comprise PTCD2, PDE7A and MLL.

3. A plurality of polynucleotides, wherein the plurality consists of polynucleotides that bind specifically to nucleic acids encoding no more than 100 breast cancer markers, wherein the breast cancer markers comprise PTCD2, PRKCE, GPATC3, PRIC285 and GSTA4.

4. A plurality of isolated antibodies, wherein the plurality comprises antibodies that bind specifically to PTCD2, SLC25A20, NFKB2 and RASGRP2 polypeptides.

5. A plurality of isolated antibodies, wherein the plurality comprises antibodies that bind specifically to PTCD2, PDE7A and MLL polypeptides.

6. A plurality of isolated antibodies, wherein the plurality comprises antibodies that bind specifically to PTCD2, PRKCE, GPATC3, PRIC285 and GSTA4 polypeptides.

7. A plurality of isolated breast cancer marker polypeptides, wherein the plurality comprises PTCD2, SLC25A20, NFKB2 and RASGRP2 polypeptides, or antigenic fragments thereof.

8. A plurality of isolated breast cancer marker polypeptides, wherein the plurality comprises PTCD2, PDE7A and MLL polypeptides, or antigenic fragments thereof.

9. A plurality of isolated breast cancer marker polypeptides, wherein the plurality comprises a PTCD2, PRKCE, GPATC3, PRIC285 and GSTA4 polypeptides, or antigenic fragments thereof.

10. A plurality of polynucleotides, wherein the plurality consists of polynucleotides that bind specifically to nucleic acids encoding no more than 100 breast cancer markers, wherein the breast cancer markers comprise SLC25A20, NFKB2 and RASGRP2.

11. The plurality of polynucleotides of claim 10, wherein the breast cancer markers comprise MIPEP, PLCB2, SLC25A19, DEF6, ZNF236, C18orf22, COX7A2, DDX11, TOP3A, C9orf6, UFC1, PFDN2, KLRD1, LOC643641, HSP90AB1, CLCN7, TNFAIP2, PRKCE, MRPL40, FBF1, ANKRD44, CCT5, USP40, UBXD4, LRCH1, MRPL4, SCCPDH, STX6, LOC284184, FLJ23235, GPATC3, CPSF4, CREM, HIST1H1D, HPS4, FN3KRP, ANKRD16, C8 orf16, ATF71P2, and PRIC285.

12. A plurality of isolated antibodies, wherein the plurality comprises antibodies that bind specifically to SLC25A20, NFKB2 and RASGRP2 polypeptides.

13. A plurality of isolated breast cancer marker polypeptides, wherein the plurality comprises SLC25A20, NFKB2 and RASGRP2 polypeptides, or antigenic fragments thereof.

14. A plurality of polynucleotides, wherein the plurality consists of polynucleotides that bind specifically to nucleic acids encoding no more than 100 breast cancer markers, wherein the breast cancer markers comprise PDE7A, MLL, and PTCD2.

15. The plurality of polynucleotides of claim 14, wherein the breast cancer markers comprise ZNF669, SNRP70, MGC35402, GSTA4, ATHL1, PRSS23, and TMEM80.

16. The plurality of polynucleotides of claim 14, wherein the breast cancer markers comprise FLJ40432 STX5A, PRKCE, MTMR11, TNPO1, MGC3731, FKBP5, C3orf62, IRS2, GPATC3, SUSD1, CCM2, ZBTB7A, RAB11A, GSDML, MAPK9, DRG2, PDZD8, LOC339804, PPARD, DDIT3, FAM113A, RHBDD3, TIMM44, ATP6AP2, ME2, PRIC285, TNFSF14, ABCA2, EML2, Magmas, EVI2A, USP37, GATAD1, CHN2, PSCD4, CHTF18, SFRS8, DICER1, and PIAS1.

17. A plurality of isolated antibodies, wherein the plurality comprises antibodies that bind specifically to PDE7A, MLL, and PTCD2 polypeptides.

18. A plurality of isolated breast cancer marker polypeptides, wherein the plurality comprises PDE7A, MLL, and PTCD2 polypeptides, or antigenic fragments thereof.

19. The plurality of breast cancer marker polypeptides of claim 18, wherein the plurality comprises ZNF669, SNRP70, MGC35402, GSTA4, ATHL1, PRSS23, and TMEM80, or antigenic fragments thereof.

20. The plurality of breast cancer marker polypeptides of claim 19, wherein the plurality comprises FLJ40432 STX5A, PRKCE, MTMR11, TNPO1, MGC3731, FKBP5, C3orf62, IRS2, GPATC3, SUSD1, CCM2, ZBTB7A, RAB11A, GSDML, MAPK9, DRG2, PDZD8, LOC339804, PPARD, DDIT3, FAM113A, RHBDD3, TIMM44, ATP6AP2, ME2, PRIC285, TNFSF14, ABCA2, EML2, Magmas, EVI2A, USP37, GATAD1, CHN2, PSCD4, CHTF18, SFRS8, DICER1, and PIAS1, or antigenic fragments thereof.

21. A diagnostic panel consisting of one or more polynucleotides and optionally at least one non-polynucleotide component, wherein the polynucleotides bind specifically to a nucleic acid encoding a breast cancer marker selected from the group consisting of ACAA2, SLC25A20, SREBF1, and MRPL40, and to no more than 100 breast cancer markers.

22. A diagnostic panel comprising at least one antibody, wherein the antibody binds specifically to a breast cancer marker selected from the group consisting of ACAA2, SLC25A20, SREBF1, and MRPL40, or a combination thereof.

23. A diagnostic panel comprising at least one breast cancer marker polypeptide selected from the group consisting of ACAA2, SLC25A20, SREBF1, and MRPL40.

24. A method for detecting the presence of breast cancer in a patient, the method comprising:
(a) obtaining a biological sample from the patient; and
(b) detecting the level of expression of breast cancer markers in the biological sample using the plurality of polynucleotides of claim 1, wherein a modulated level of expression as compared to a predetermined cut-off value for each breast cancer marker indicates the presence of breast cancer in the patient.

25. A method for detecting the presence of breast cancer in a patient, the method comprising:
(a) obtaining a biological sample from the patient; and
(b) detecting the level of protein expression of breast cancer markers in the biological sample using the plurality of antibodies of claim 4, wherein a modulated level of protein expression as compared to a predetermined cut-off value for each breast cancer marker indicates the presence of breast cancer in the patient.

26. A method for detecting the presence of breast cancer in a patient, the method comprising:
(a) obtaining a biological sample from the patient; and
(b) detecting the level of antibodies directed against breast cancer markers in the biological sample using the plurality of polypeptides of claim 7, wherein a modulated level of antibodies as compared to a predetermined cut-off value for each breast cancer marker indicates the presence of breast cancer in the patient.
